(19) United States
(12) Patent Application Publication
(10) Pub. No.: US 2026/0045006 A1
(43) Pub. Date: Feb. 12, 2026

(54) Automated Building Floor Plan Generation Using Transformer-Based Analysis Of Visual Data Of Building Images

(71) Applicant: MFTB Holdco, Inc., Seattle, WA (US)

(72) Inventor: Yuguang Li, Seattle, WA (US)

(21) Appl. No.: 19/295,544

(22) Filed: Aug. 8, 2025

Related U.S. Application Data
(60) Provisional application No. 63/681,746, filed on Aug. 9, 2024.

(51) Int. Cl. G06T 11/20; G06T 7/73

(52) U.S. Cl. CPC G06T 11/203; G06T 7/73; G06T 2207/20081; G06T 2207/30244

(57) ABSTRACT

Techniques are described for automated operations to analyze visual data from images acquired in multiple rooms of a building to generate building information that may include a floor plan for the building, such as by analyzing visual overlap between those images to determine information that includes image pose data for the images and wall location data for walls of the rooms that are visible in the images, and by using the generated building information in further automated manners. In some situations, the described techniques include using a trained transformer machine learning model to encode and compare information from some or all pixel columns of the images to map pixel columns to particular walls, and to use that data along with floor-wall boundaries in the pixel columns to generate a resulting floor plan for the building.

### CROSS REFERENCE TO RELATED APPLICATIONS

This application claims the benefit of U.S. Provisional Patent Application No. 63/681,746, filed Aug. 9, 2024 and entitled “Automated Building Floor Plan Generation From Building Images Using Combined Diffusion Models And Bundle Adjustment”, which is hereby incorporated by reference in its entirety.

### TECHNICAL FIELD

The following disclosure relates generally to techniques for generating and using a floor plan of a building based on analysis of visual data of multiple images acquired for the building, such as using a transformer machine learning model to determine image pose data for the multiple images and wall location data for walls visible in the images for use in generating a resulting floor plan for the building, and for subsequently using the generated floor plan in one or more manners such as to improve navigation of the building.

### BACKGROUND

In various fields and circumstances, such as architectural analysis, property inspection, real estate acquisition and development, remodeling and improvement services, general contracting, automated navigation and other circumstances, it may be desirable to view information about the interior of a house, office, or other building without having to physically travel to and enter the building, including to determine actual as-built information about the building rather than design information from before the building is constructed. However, it can be difficult to effectively capture, represent and use such building interior information, including to display visual information captured within building interiors to users at remote locations (e.g., to enable a user to fully understand the layout and other details of the interior, including to control the display in a user-selected manner). In addition, while a floor plan of a building may provide some information about layout and other details of a building interior, such use of floor plans has some drawbacks in certain situations, including that floor plans can be difficult to construct and maintain, to accurately scale and populate with information about room interiors, to visualize and otherwise use, etc.

### BRIEF DESCRIPTION OF THE DRAWINGS

FIG. 1 is a diagram depicting an exemplary building interior environment and computing system(s) for use in generating and presenting information representing areas of the building.

FIGS. 2A-2D illustrate examples of images acquired in multiple rooms of a building.

FIGS. 2E-2J illustrate data and process flow examples for a Diffusion-Bundle Adjustment Mapping Information Generation Manager (DBAMIGM) system in accordance with the present disclosure.

FIGS. 2K-2T illustrate data and process flow examples for a DBAMIGM Building Data Input Encoder (BDIE) system in accordance with the present disclosure.

FIGS. 2U-2Y illustrate examples of automated operations for analyzing visual data of images acquired in multiple rooms of a building, such as based at least in part on analyzing visual data of images with at least partial visual overlap, and combining data from the analysis of multiple image pairs for use in generating and providing information about a floor plan for the building.

FIG. 3 is a block diagram illustrating computing systems suitable for executing one or more example systems that perform at least some of the techniques described in the present disclosure.

FIG. 4 illustrates an example flow diagram for an Image Capture and Analysis (ICA) system routine in accordance with the present disclosure.

FIGS. 5A-5D illustrate an example flow diagram for a Diffusion-Bundle Adjustment Mapping Information Generation Manager (“DBAMIGM”) system routine in accordance with the present disclosure.

FIG. 6 illustrates an example flow diagram for a DBAMIGM Building Data Input Encoder (BDIE) system routine in accordance with the present disclosure.

FIG. 7 illustrates an example flow diagram for a Building Information Access system routine in accordance with the present disclosure.

### DETAILED DESCRIPTION

The present disclosure describes techniques for using computing devices to perform automated operations related to analyzing visual data from images acquired in multiple rooms of a building to generate multiple types of building information including a building floor plan with interconnected polygonal room shapes, and for subsequently using the generated building information (referred to herein at times as “mapping information”) in one or more further automated manners. The images may, for example, include panorama images (e.g., in an equirectangular projection format) and/or other types of images (e.g., non-panorama images in a rectilinear perspective or orthographic format) that are acquired at acquisition locations in or around a multi-room building (e.g., a house, office, etc.)-in addition, in at least some such situations, the automated building information generation is further performed without having or using information from any depth sensors or other distance-measuring devices about distances from a captured image's acquisition location to walls or other objects in the surrounding building (e.g., by instead using only visual data of the images, such as RGB, or red-green-blue, pixel data). The generated floor plan for a building (including determined polygonal room shapes or other structural layouts of individual rooms within the building that are positioned relative to each other) and/or other types of generated building information may be further used in various manners in various situations, including for controlling navigation of mobile devices (e.g., autonomous vehicles), for assisting navigation via display or other presentation over one or more computer networks on one or more client devices in corresponding GUIs (graphical user interfaces), etc. Additional details are included below regarding the automated analysis of visual data from images acquired in multiple rooms of a building to generate and use building floor plans and optionally other types of building information, and some or all of the techniques described herein may be performed via automated operations of a Diffusion-Bundle Adjustment Mapping Information Generation Manager (“DBAMIGM”) system in at least some situations, as discussed further below.

As noted above, automated operations of the DBAMIGM system may include analyzing visual data from multiple target images acquired at a multi-room building to generate a building floor plan and optionally other types of mapping information for the building. In at least some situations, the automated operations of the DBAMIGM system include using a combination of a trained diffusion transformer machine learning model and a bundle adjustment optimizer model to determine global inter-image pose and wall location data (e.g., locations of wall segments and inter-wall borders, such as part of polygonal room shapes) in a single common coordinate system and to use that data to generate a resulting floor plan for the building-by combining the diffusion transformer machine learning model and a bundle adjustment optimizer model, a precise floor plan reconstruction and precise camera extrinsic (e.g., acquisition poses of the camera(s) at the time of acquisition of the multiple target images) may be achieved in the single common coordinate system from only sparsely captured images (e.g., panorama images, including in situations having only limited visual overlap between pairs of the images, such as 5%, 10%, 15%, 20%, 25%, etc., or even 0% if the images each have associated approximate pose data, and including in situations in which the aggregate visual data of the images lacks visual coverage of all structural elements of the building), enabling floor plan geometry (e.g., borders between walls, floors and/or ceiling, locations of doorways and windows and other structural elements, 3D positions of other objects, etc.) to be projected into the images and precisely align with the corresponding visual date of the images. In some situations, wall positions of polygonal room shapes are specified as a sequence of corners or otherwise as a closed sequence of wall segments that begin and end at the same point (including in some further situations to determine and use mappings of image pixel columns across the target images to each wall, and per-column determinations of one or more pixel rows corresponding to the floor-wall boundary for that column), optionally with structural elements such as doorways, non-doorway wall openings, etc. further identified in the walls or otherwise in the polygonal room shapes (e.g., as bounding boxes), as discussed in greater detail elsewhere herein. The use of the diffusion transformer machine learning model may provide capabilities that include, as non-exclusive examples, using geometric priors (e.g., wall-to-wall positioning relationships, room shape priors, geometric relationships among walls and windows and doors, etc.) from training data and images from a building to generate accurate polygonal room shapes for the building's rooms, optionally along with various other types of input data in accordance with the training of the model (e.g., performed without supervision using a collection of pairs of input data and resulting output data that includes a generated floor plan), and including to inpaint or otherwise fill in missing structural elements (e.g., floor-wall border locations, inter-wall border locations, etc.) from the aggregate visual data of the input images by using surrounding visual data while overcoming noise data in the inputs (e.g., using a denoising diffusion architecture) and optionally using input guidance conditions to constrain the model output results. The use of the bundle adjustment optimization techniques may provide capabilities that include, as non-exclusive examples, providing highly accurate positioning of walls relative to each other (including to account for intervening wall widths) and of the images' camera poses (locations and orientations) using non-linear optimization, including to iteratively improve the global data that it produces using one or more defined cost functions and other defined constraints. Additional details related to one non-exclusive example of a diffusion transformer machine learning model architecture that may be used by the DBAMIGM system are included in “HouseDiffusion: Vector Floorplan Generation Via A Diffusion Model With Discrete And Continuous Denoising” by Shabani et al., available Nov. 23, 2022 at https://arxiv.org/pdf/2211.13287, which is included herein by reference in its entirety, and which generally predicts 2D xy positions of each corner. In at least some situations, the DBAMIGM system imposes further constraints on shape representation, to provide better accuracy by eliminating half of the predicted parameters, such as to only predict one of the xy values for a wall or for a wall border with one or more of another wall, floor or ceiling (e.g., if the angle of wall is known).

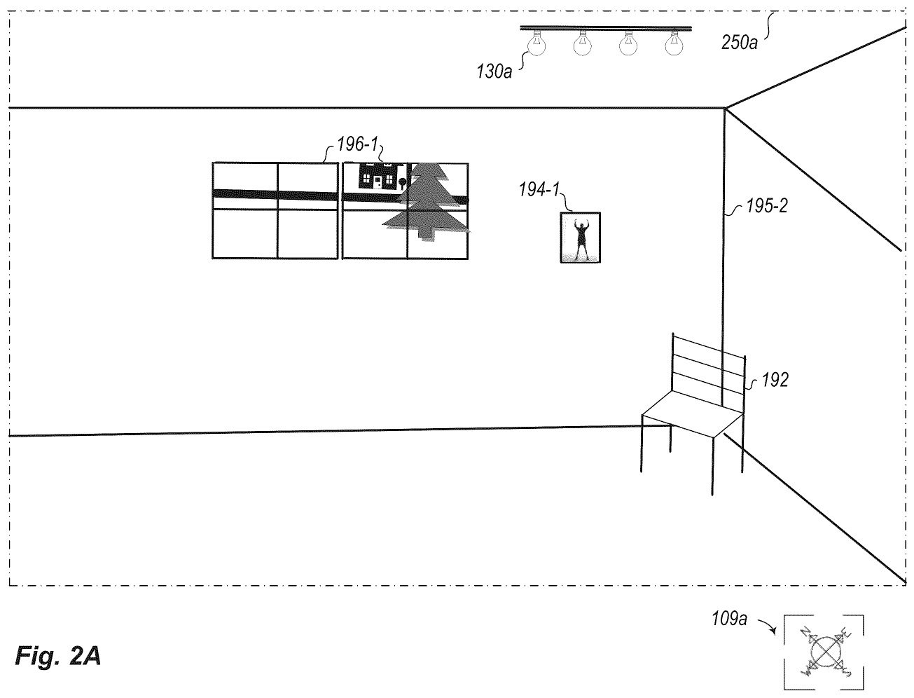

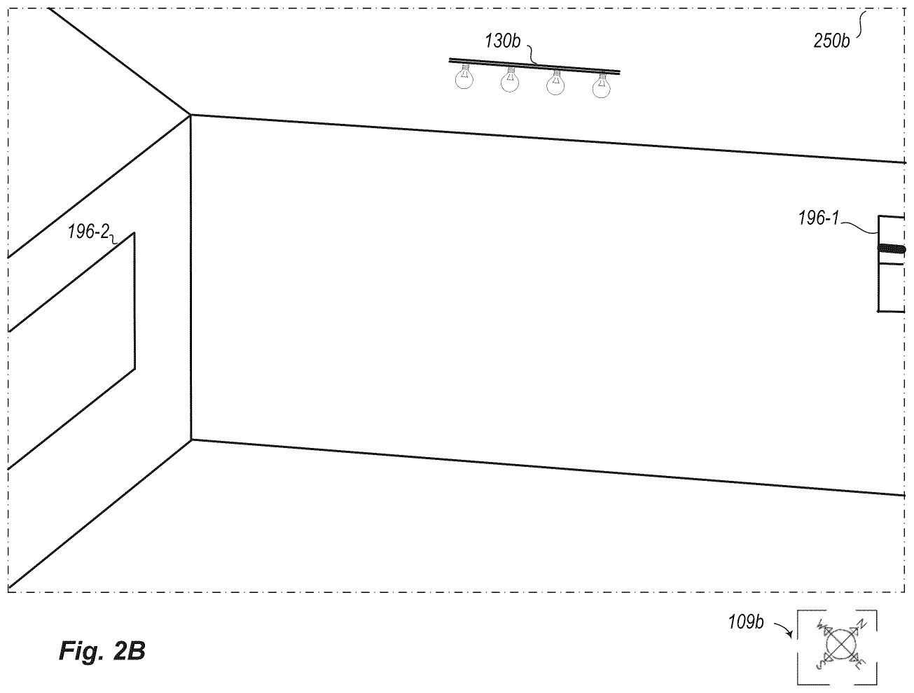

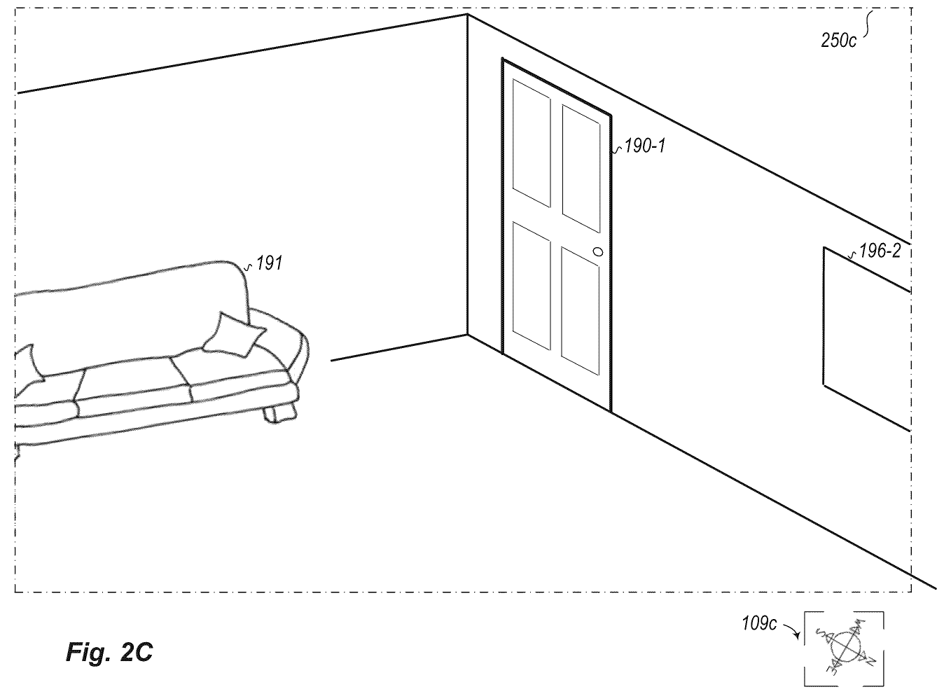

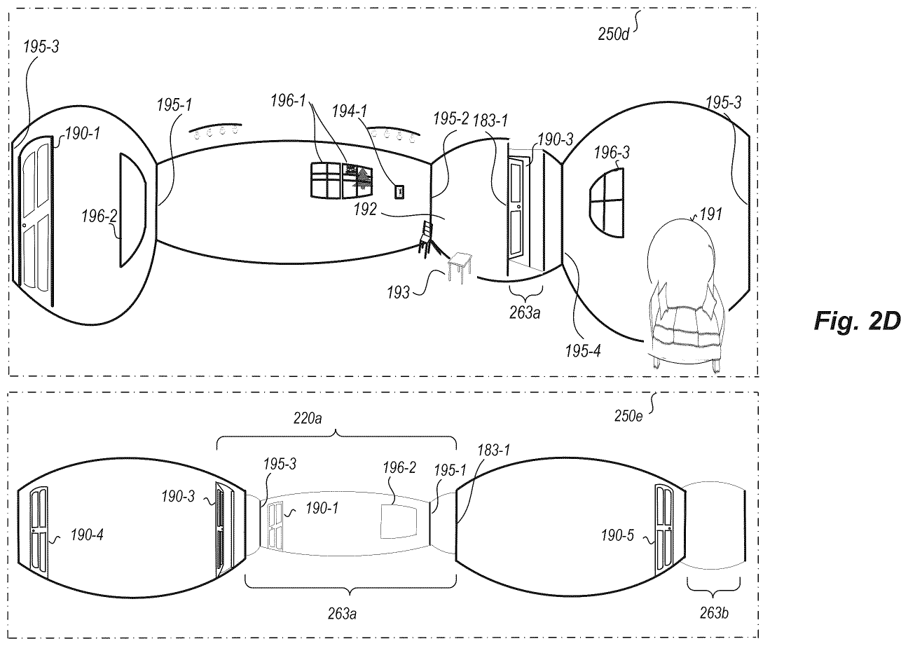

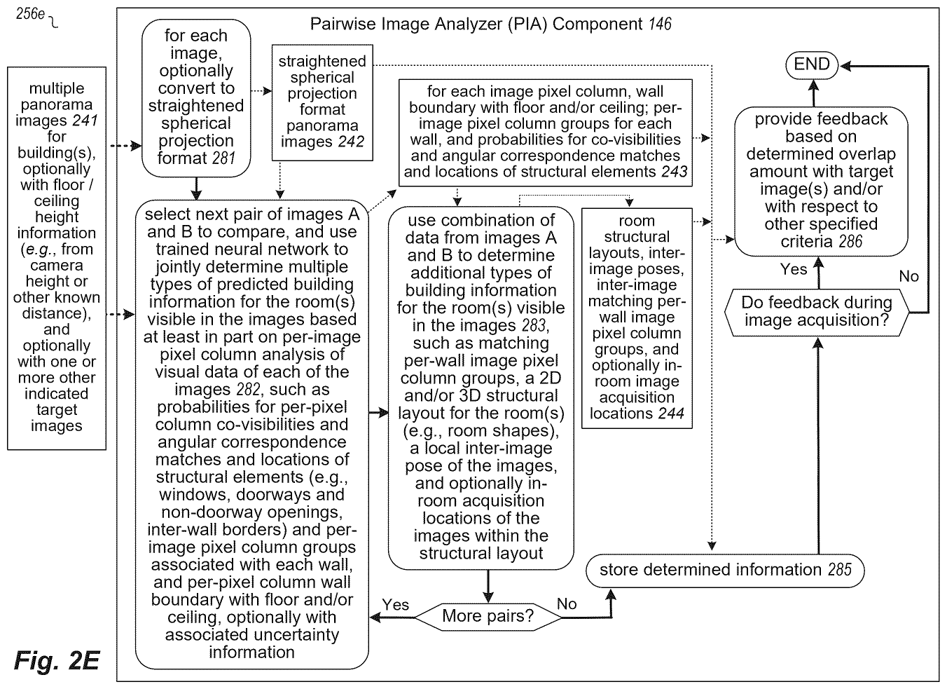

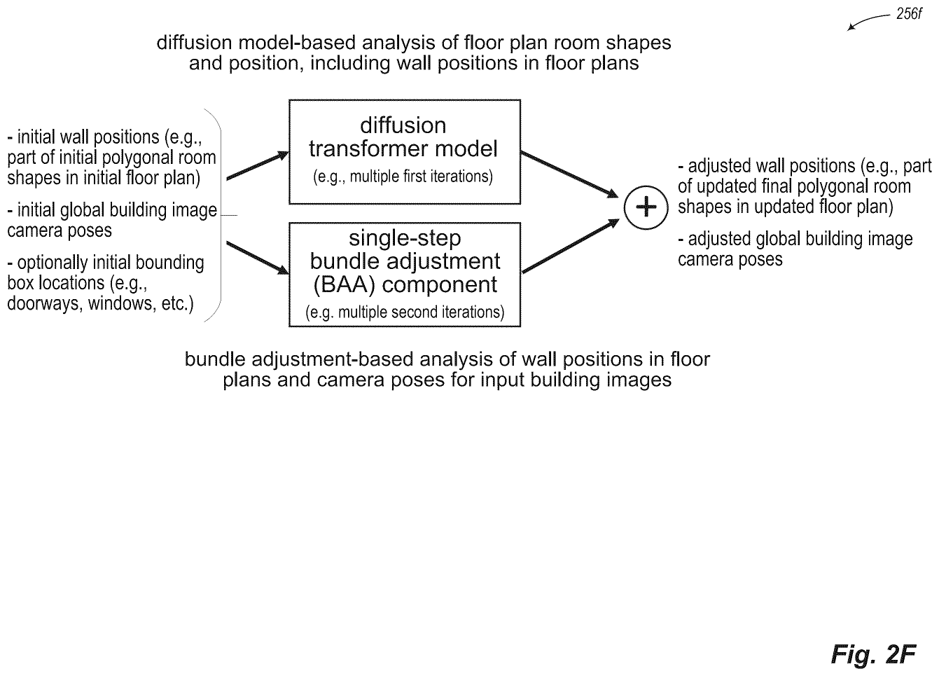

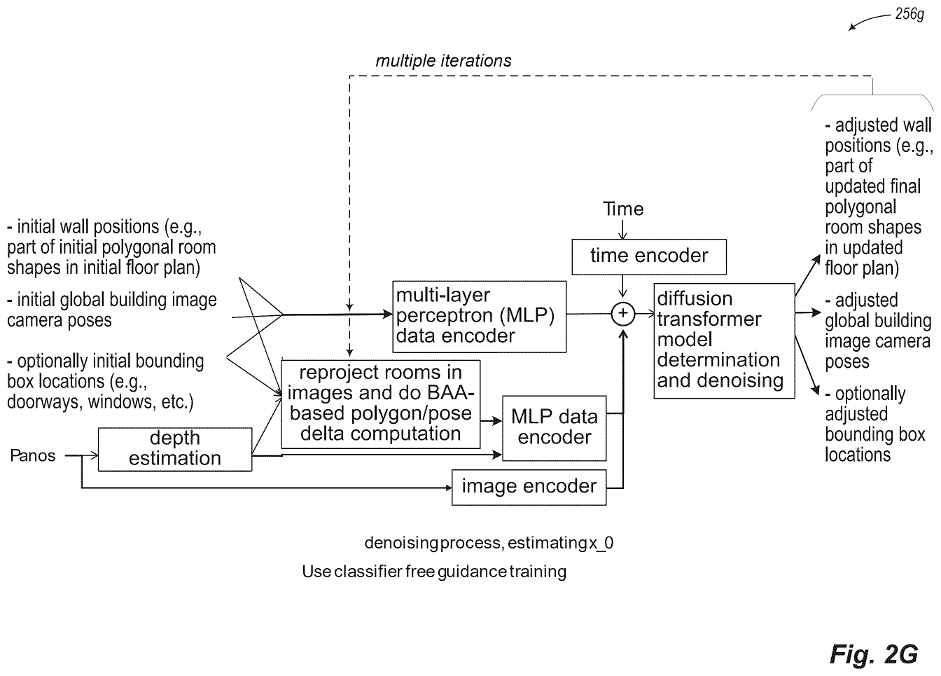

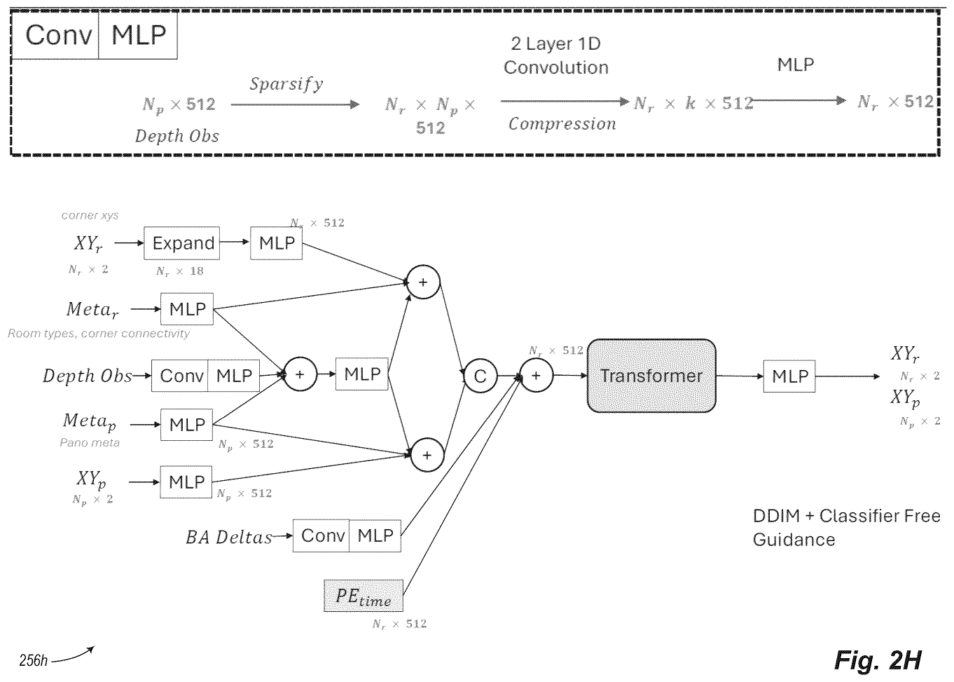

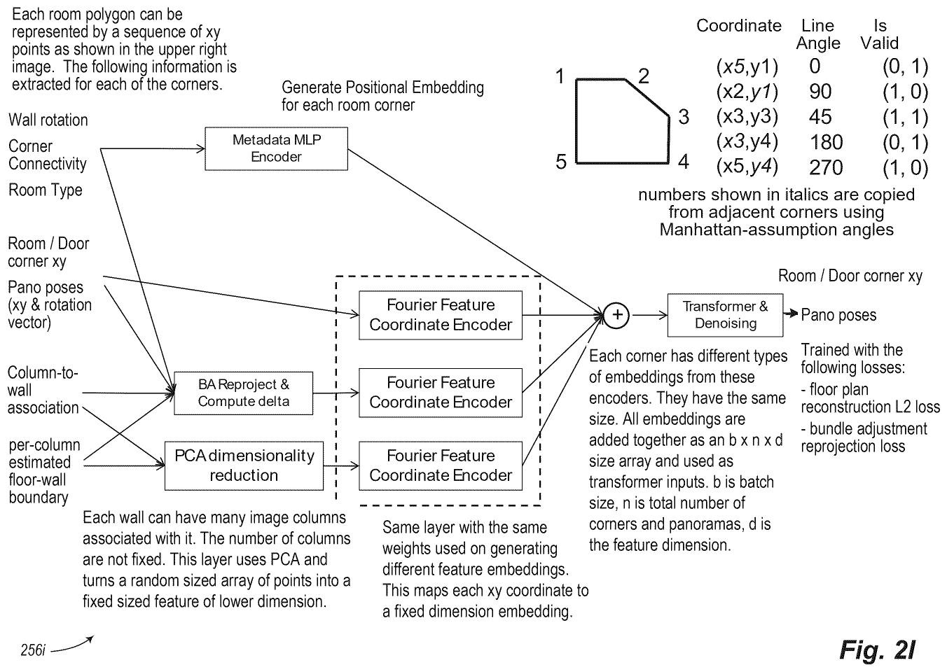

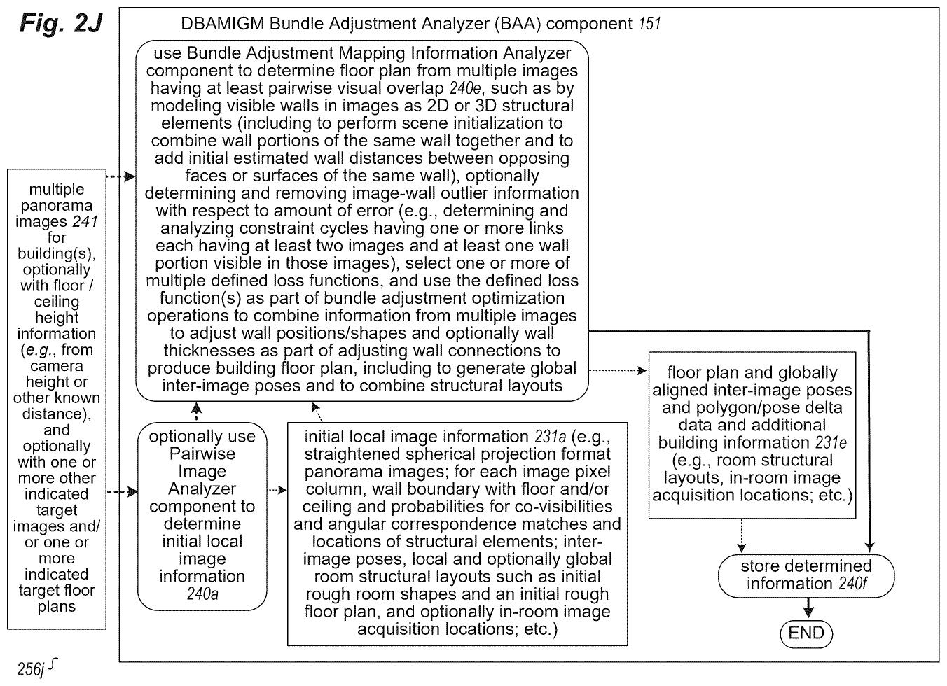

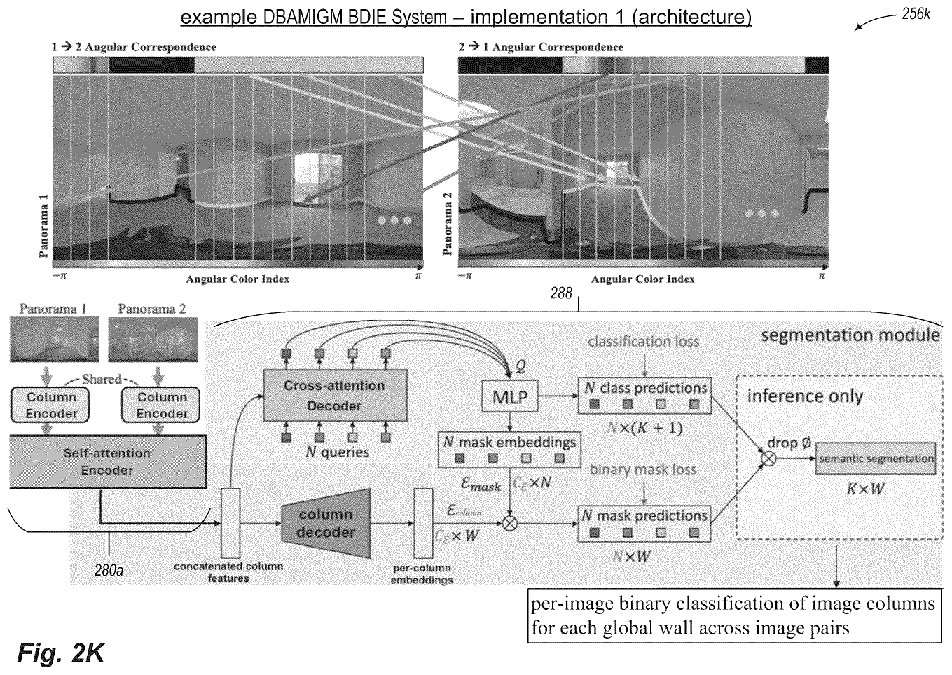

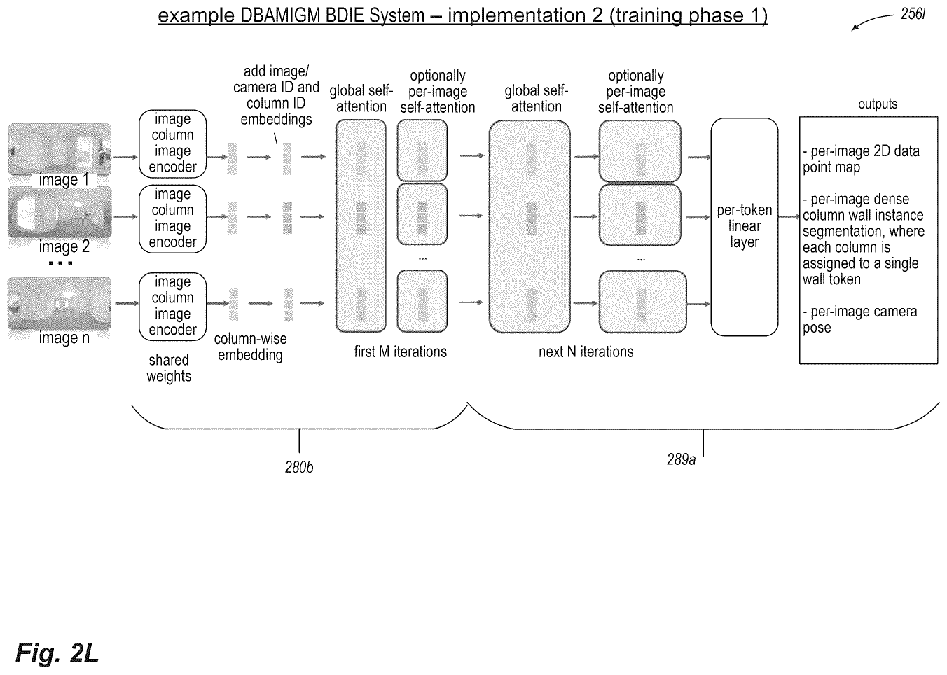

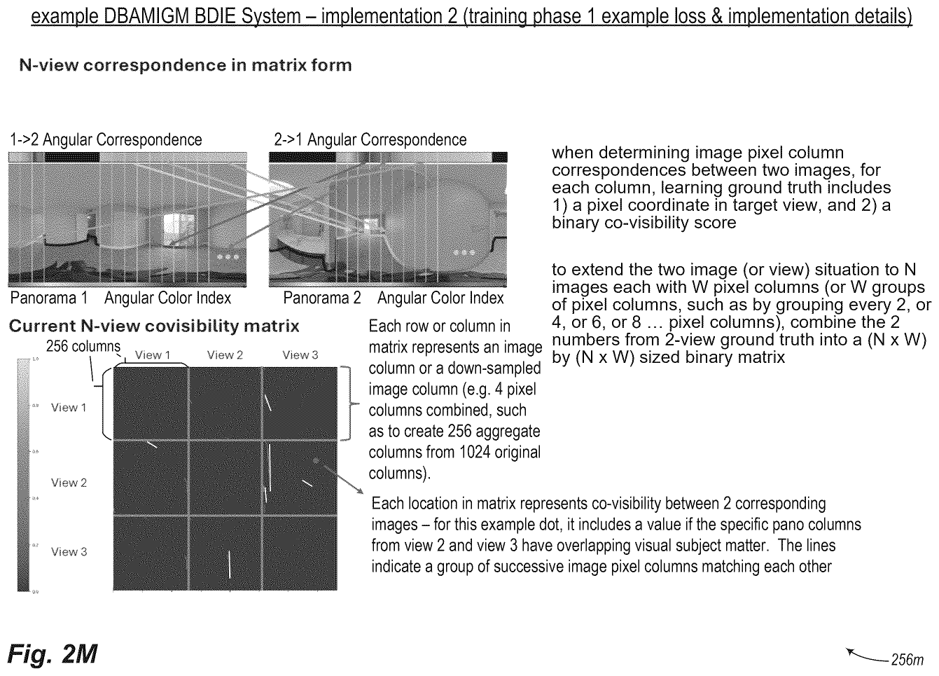

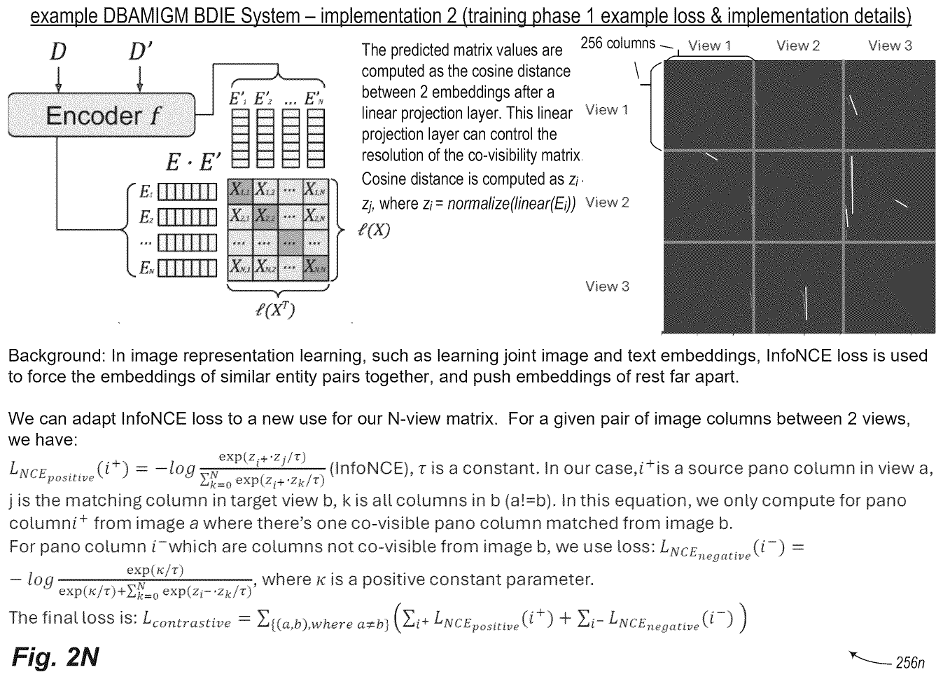

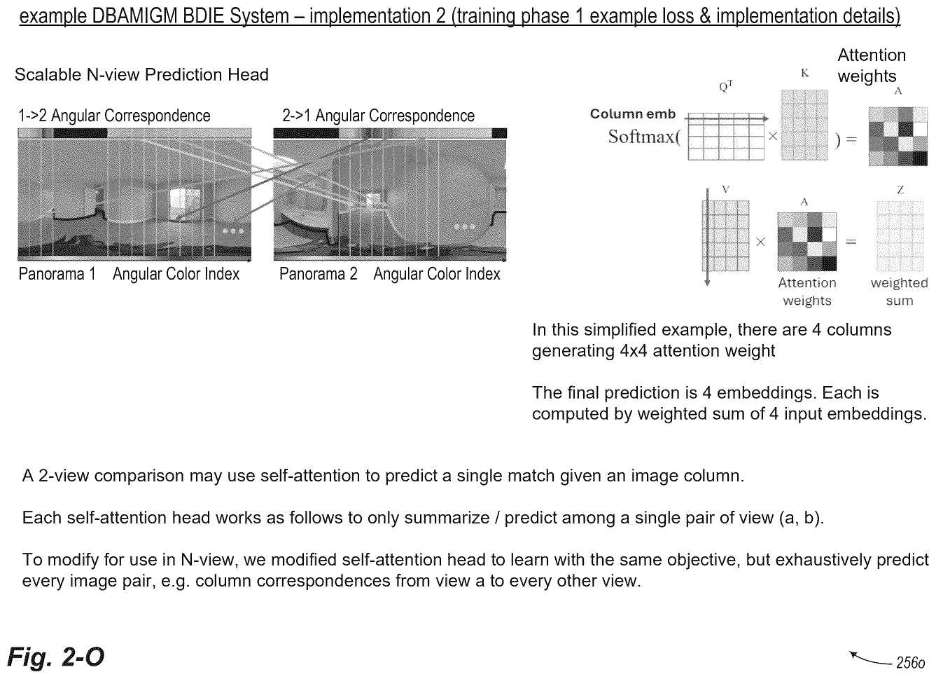

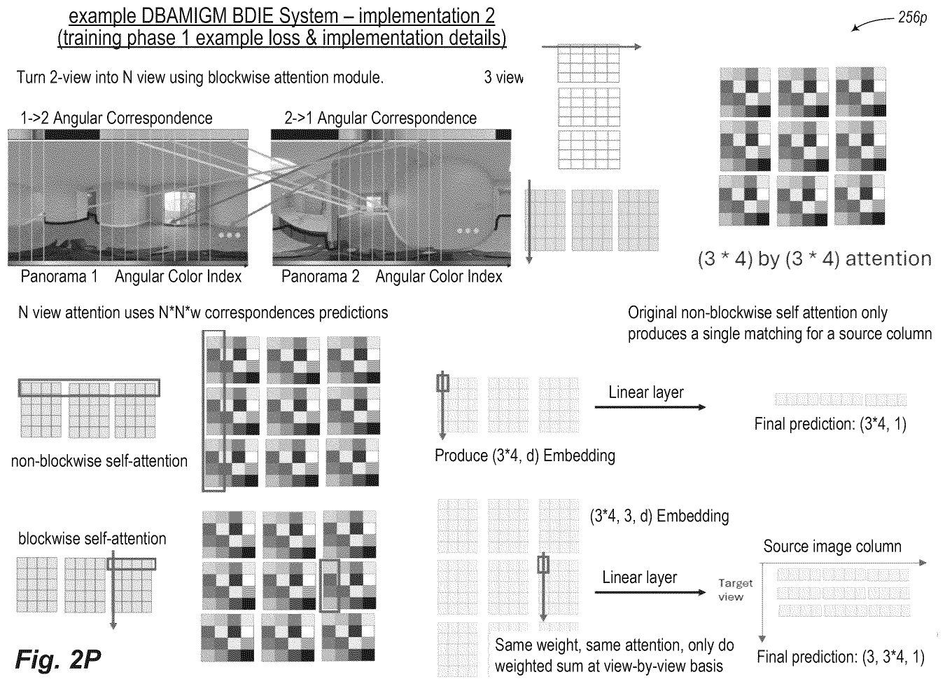

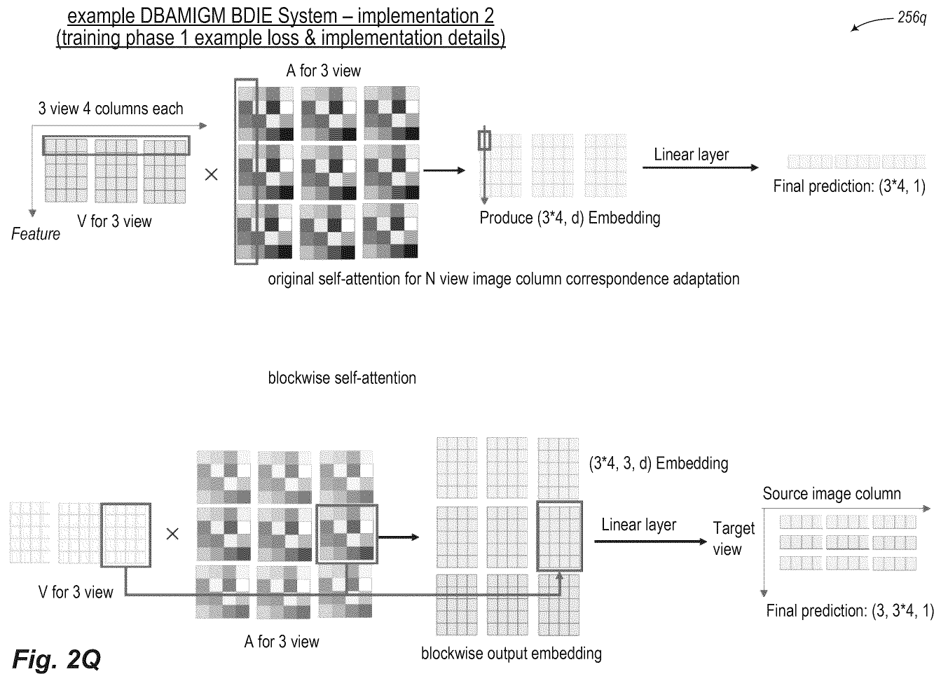

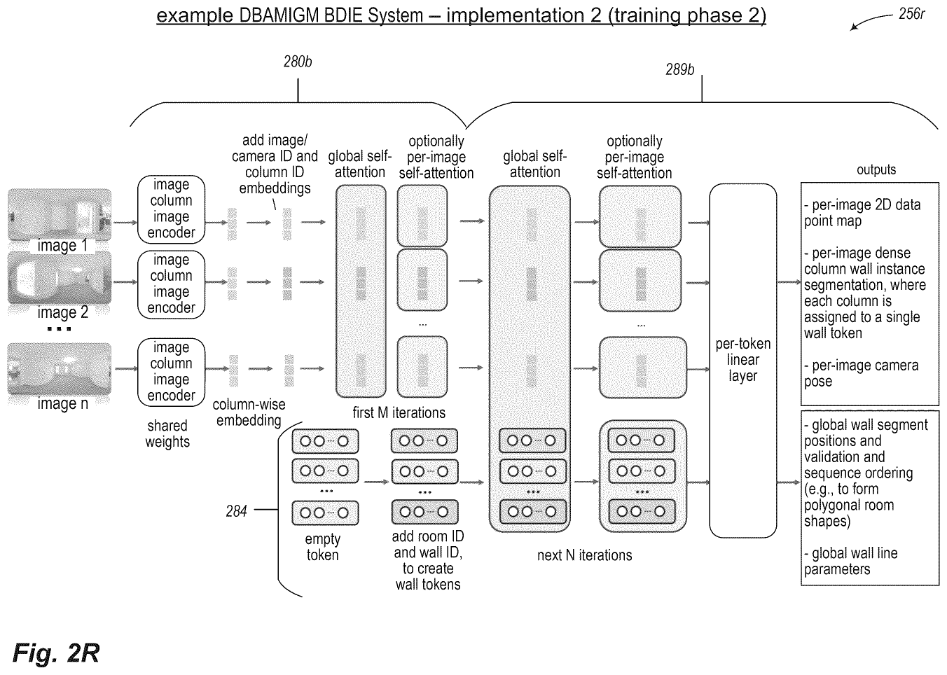

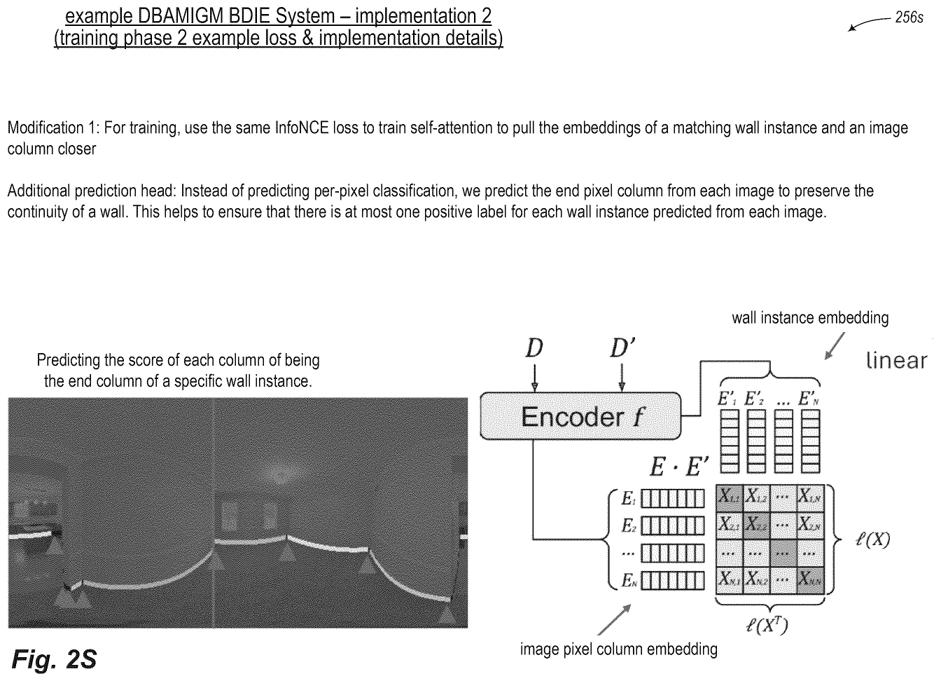

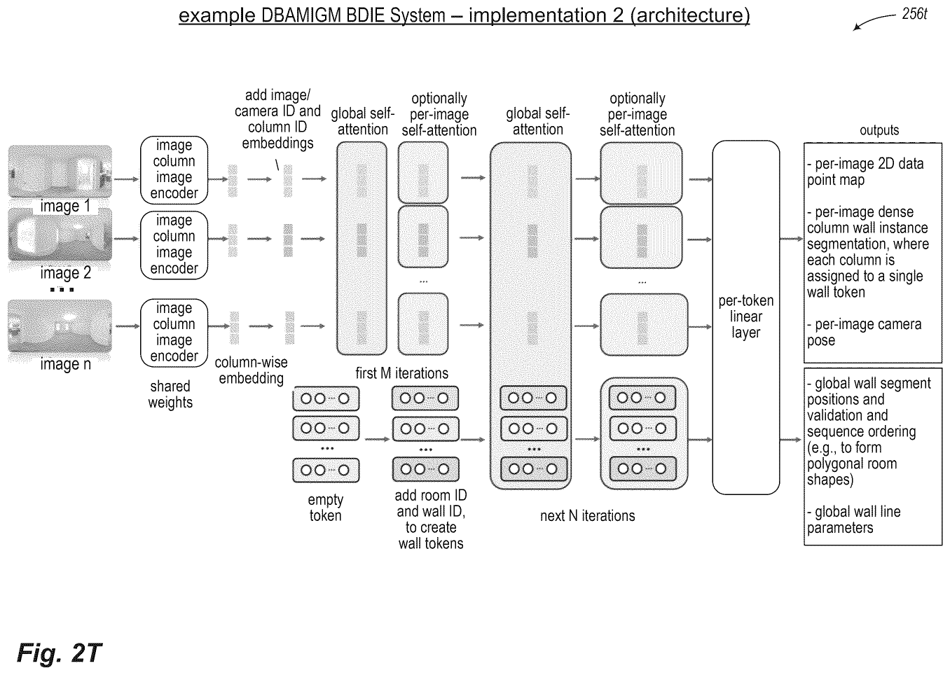

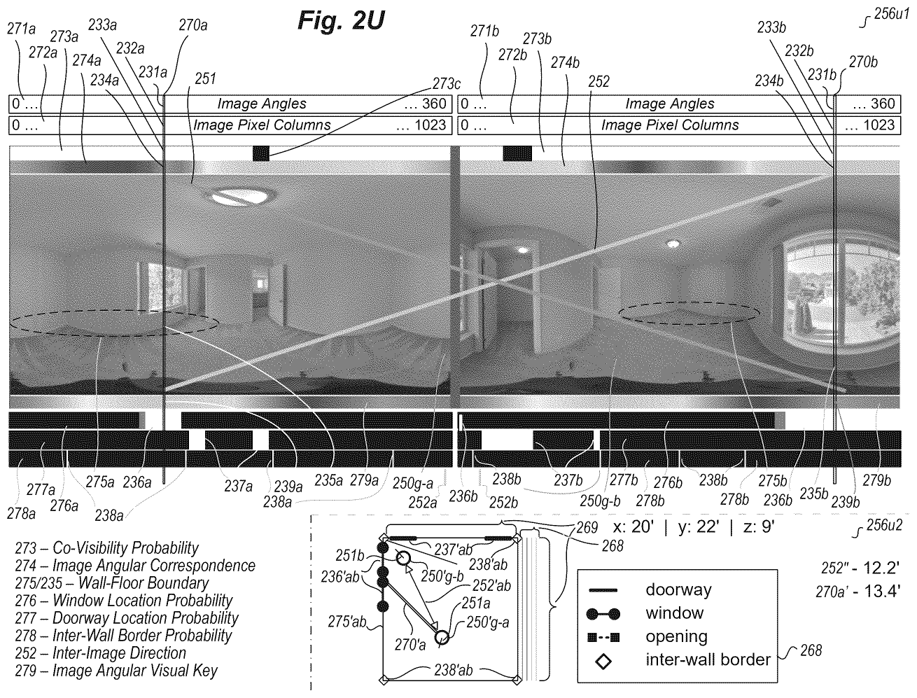

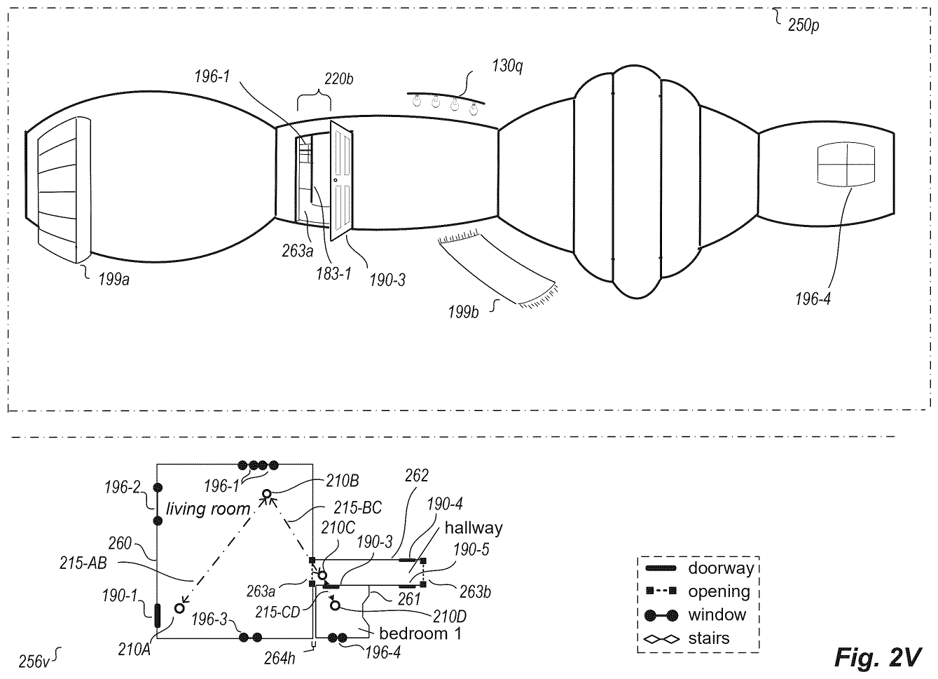

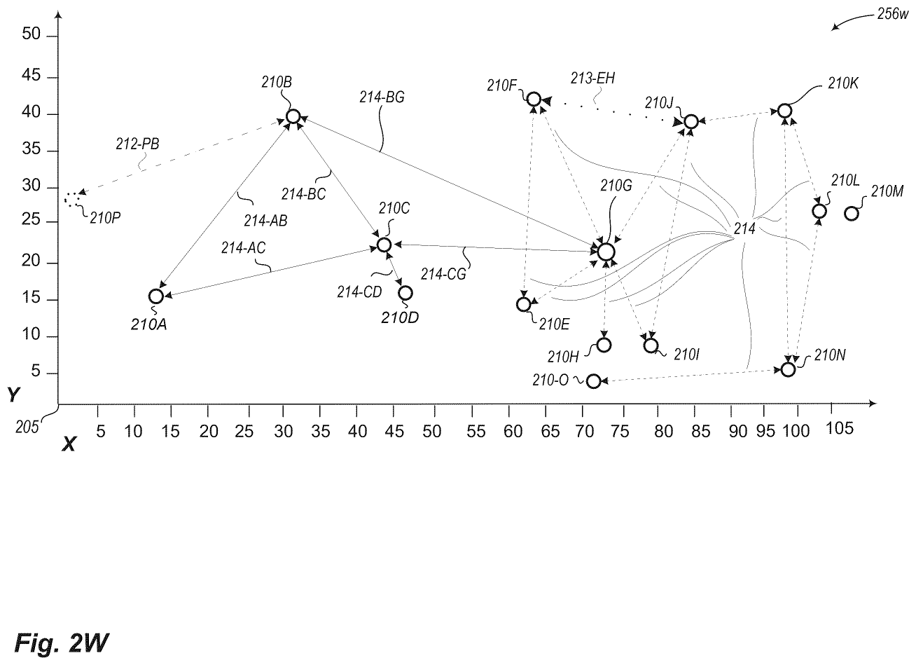

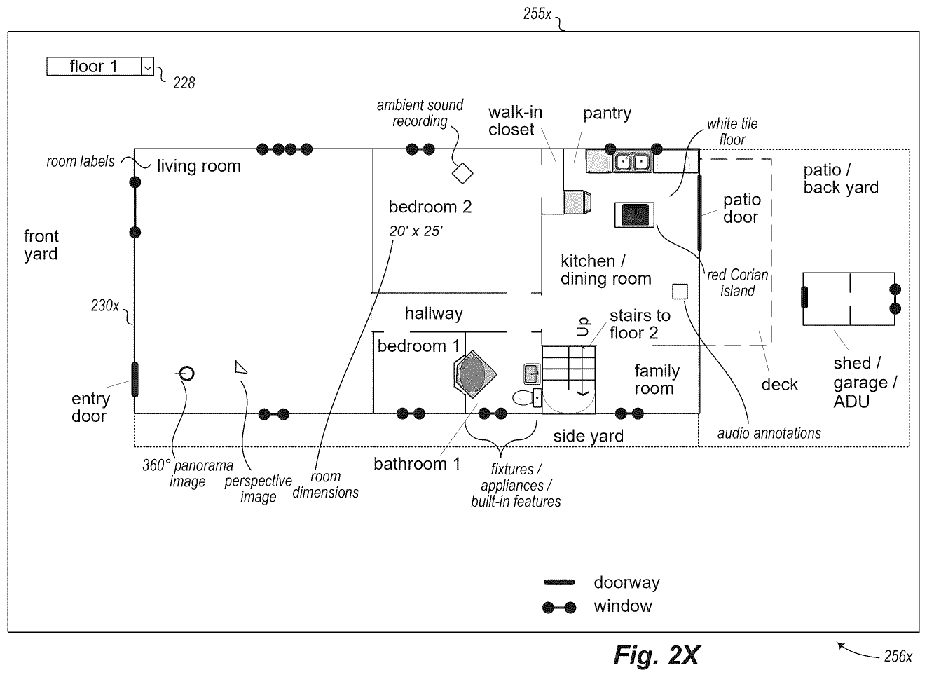

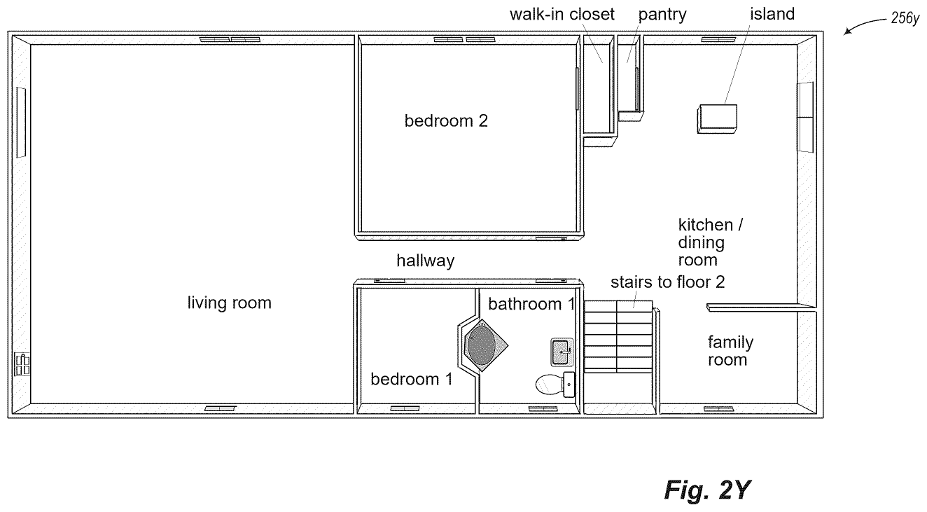

In some situations, the combination of the trained diffusion transformer machine learning model and the bundle adjustment optimizer model used by the DBAMIGM system includes using the bundle adjustment optimizer capabilities to produce data that is used as guidance to further determinations performed by the diffusion transformer machine learning model during each of multiple iterations performed by the diffusion transformer machine learning model (e.g., hundreds or thousands of iterations for each group of input images), such as to use, as guidance, data from computations by the bundle adjustment optimizer model of deltas between initial building wall position data (e.g., as part of initial room polygonal shapes) and initial building image camera poses and generated corrected or otherwise adjusted wall position data (e.g., as part of adjusted room polygonal shapes) and building image camera poses (e.g., that eliminate or otherwise reduce errors from, when using the building image camera poses to reproject the room polygon shapes into the input images, differences in the reprojected room polygon shapes relative to corresponding aspects in the visual data of the input images)—the bundle adjustment optimizer capabilities may, for example, be implemented as part of a deep learning layer within the diffusion transformer machine learning model, so as to use deep learning to tune hyperparameters within the diffusion transformer machine learning model. In this manner, the guidance from the bundle adjustment optimizer in these situations acts to direct and constrain the further determinations performed by the diffusion transformer machine learning model, such as part of generation by the diffusion transformer machine learning model of a floor plan and optionally other mapping information for the building. It at least some situations, to train the diffusion transformer machine learning model to perform such activities, a reprojection loss is applied during model training (e.g., in addition to an L2 loss as described in the “HouseDiffusion: Vector Floorplan Generation Via A Diffusion Model With Discrete And Continuous Denoising” document noted above), such as in a manner similar to that described in U.S. Non-Provisional patent application Ser. No. 18/209,420, filed Jun. 13, 2023 and entitled “Automated Inter-Image Analysis Of Multiple Building Images For Building Floor Plan Generation”, which is hereby incorporated by reference in its entirety, and which provides additional details related to performing a bundle adjustment-based determination of building floor plan information. Additional details related to the use of the bundle adjustment optimizer functionality as a guidance layer within the diffusion transformer machine learning model are included elsewhere herein, including in the examples of FIGS. 2G-2I and associated textual descriptions.

In some situations, the combination of the trained diffusion transformer machine learning model and the bundle adjustment optimizer used by the DBAMIGM system includes, during each of multiple iterations (e.g., hundreds or thousands of iterations) for each group of input images, using the bundle adjustment optimizer capabilities to independently produce a first group of output data and the diffusion transformer machine learning model to in parallel independently produce a second group of output data, with those first and second groups of output data combined to form an aggregate group of output data for that iteration that may optionally be used as the starting point for a next iteration—for example, the input data for each iteration may include initial building wall position data (e.g., as part of initial room polygonal shapes) and image camera pose data corresponding to a group of building images, and the first and second and aggregate groups of output data may include adjusted wall position data (e.g., as part of adjusted room polygonal shapes) and image camera pose data, such as to eliminate or otherwise reduce errors from, when using the building image camera poses to reproject the walls into the input images, differences in the reprojected wall locations relative to corresponding elements in the visual data of the input images. In this manner, determinations by each of the diffusion transformer machine learning model and the bundle adjustment optimizer affect the iterative refinements to the wall position data and image camera pose data, with the aggregate data determined for an iteration in various manners in various situations (e.g., in a weighted manner, and optionally with the weighting changing during the course of the multiple iterations, such as to decrease or increase the weighting for the outputs from the bundle adjustment optimizer over time relative to the outputs from the diffusion model), and with the final aggregate output data after a last iteration (e.g., as determined by one or more ending criteria being satisfied, such as the differences between the first and second groups of output data being below a termination threshold, a defined quantity of iterations being reached, a defined amount of time being reached, etc.) being used as part of generation of a floor plan and optionally other mapping information for the building. Additional details are included elsewhere herein related to the use of the bundle adjustment optimizer functionality in parallel with the diffusion transformer machine learning model to each independently produce output data that is subsequently combined for each of one or more iterations, including in the example of FIG. 2F and associated textual description.

In addition, in at least some situations, the DBAMIGM system may include a Building Data Input Encoder (BDIE) system to, for a group of images captured for a building, perform an initial analysis of the visual data of those images to determine initial rough estimates of building wall position data and building image camera poses, such as for use as input to the diffusion model and/or bundle adjustment optimizer model of the DBAMIGM system-in at least some situations, the determined initial rough estimates of building wall position data and building image camera poses are included as part of an initial rough version of a floor plan for the building, such as including initial versions of polygonal room shapes relative to each other and with each room shape being a closed sequence of wall segments that begins and ends at a single position, and with the determined information optionally further including additional initial rough estimates of other information (e.g., a mapping for each wall of image pixel columns in the various input images that include visual data of that wall, an indication of one or more rows in each of at least some of the columns showing a floor-wall boundary for that column, etc.), and with those determined initial rough estimates to be further refined by the diffusion model and/or bundle adjustment optimizer model of the DBAMIGM system. The BDIE system may, for example, use a trained transformer machine learning model (different from the diffusion transformer model of the DBAMIGM system) to encode data about visual features in each of some or all pixel columns of the initial images, along with associated unique identifiers (IDs) for each such pixel column, and then use self-attention processing operations to, for each image, predict per-image data that includes a camera pose within a local coordinate system for that image, a 2D data point map corresponding to walls visible in that image (e.g., with positions using the local coordinate system for that image), a grouping of, for each wall visible in that image, pixel columns of that image associated with that wall, and for each pixel column, one or more rows (if any) having visual data showing a floor-wall boundary—the training of the transformer machine learning model may in some situations include supplying input training images with labels of these types of data for use in a first training phase, such as with a corresponding type of loss function for each of these types of data to be used with backpropagation to learn to later predict that type of data from other non-training input images, as discussed in greater detail elsewhere herein. In addition, the BDIE system may, for example, perform further operations to determine information across the multiple images, such as using cross-attention processing operations and/or further self-attention processing operations (e.g., using the same self-attention processing), including to determine global image poses for the multiple images in a single common coordinate system, and positions of the various walls in the single common coordinate system, such as part of an initial rough floor plan for the building (e.g., with each room being a closed polygonal shape from a sequence of line segments)—the training of the transformer machine learning model may in some situations further include, as part of a second training phase after the first training phase is completed, adding room and wall tokens to cause the transformer model to further associate the training image pixel columns with particular wall segments in particular orders to form particular room shapes (e.g., starting with the same self-encoder module used in the first training phase and beginning with the same training weights learned in that first training phase), such as with one or more additional types of loss function to be further used with backpropagation to learn to later predict these additional types of data from the other non-training input images, as discussed in greater detail elsewhere herein. As part of determining such an initial rough floor plan, the BDIE system may use, for each wall, a group of pixel columns across the multiple images that show that wall, and determined rows in the pixel columns showing the floor-wall boundary along with the determined image poses for the corresponding images to determine 2D data points representing that wall position, with the various 2D data point for that wall being combined to produce the position of that wall in the single common coordinate system. The training of the transformer model for the BDIE system may further be performed in various manners in various situations, including in some situations to have two training phases in which different types of information is supplied to the transformer model as noted above, including in the first phase to learn to generate the per-image data, and in the second phase to learn to generate the cross-image final output data. Additional details are included elsewhere herein regarding use of the DBAMIGM BDIE system, including in the examples of FIGS. 2K-2T and their associated textual descriptions.

In addition, in at least some situations, the DBAMIGM BDIE system may use a Pairwise Image Analyzer (PIA) component that does a pairwise analysis of pairs of target images having visual data overlap (or ‘visual overlap’) to determine initial local structural information from the visual data of the pair of images (e.g., in a separate local coordinate system for each target image, in a shared local coordinate system determined for and shared by the information for that pair of target images, etc.), such as by using a trained neural network (e.g., a transformer model) to jointly generate the multiple types of building information by combining visual data from pairs of the images, and with the initial local structural information including initial positions of walls and/or room shapes and including initial determinations of a camera pose (location and orientation) for each image. The DBAMIGM PIA component may use a trained transformer model or other trained neural network as a decoder to determine, for each image, groups of image pixel columns for each wall with visual data of that wall, and to determine matches between pairs of images of the image pixel columns groups of a pair of images that correspond to the same wall. In at least some situations, the trained transformer model determines, for each image, a predicted segmentation mask of each wall, with the image pixel columns within the predicted segmentation mask of each wall then being selected as the group of image pixel columns for that wall for that image. When determining matches for a pair of images of the image pixel columns groups that correspond to the same wall in the pair of images, the PIA component may use a loss function that includes a mask loss (e.g., to reflect accuracy of a predicted segmentation mask), a classification loss (e.g., to reflect accuracy of an area of an image being classified as a wall), and an instance matching loss (e.g., to reflect accuracy of two walls identified in two images as being instances of the same wall). In some situations, a self-attention encoder is pretrained with losses like angular correspondences, co-visibility, floor-wall boundary, etc., such as in an analogous manner to that discussed in U.S. Non-Provisional patent application Ser. No. 17/564,054, filed Dec. 28, 2021 and entitled “Automated Building Information Determination Using Inter-Image Analysis Of Multiple Building Images,” which is incorporated herein by reference in its entirety-if so, during the end-to-end training, the encoder portion may be frozen with only the types of losses discussed above in this paragraph being applied (e.g., a mask loss, classification loss, instance matching loss, etc.), or instead all of the portions may be trained together but with only the losses used during the pretraining being retained. Additional details are included elsewhere herein related to the use of a trained transformer model as a decoder to determine per-image groups of image pixel columns for each wall with visual data of that wall and to determine matches between pairs of images of the image pixel columns groups of a pair of images that correspond to the same wall, including in the example of FIG. 2K and associated textual description, and additional details related to one non-exclusive example of a transformer used to predict a segmentation mask in a single image of one or more visible objects (using a mask classification loss include a classification component and a masking component) that may be used by such situations of the PIA component are included in “Masked-attention Mask Transformer For Universal Image Segmentation” by Cheng et al., available Jun. 15, 2022 at https://arxiv.org/pdf/2112.01527, which is included herein by reference in its entirety.

The described techniques provide various benefits in various situations, including to allow partial or complete floor plans of multi-room buildings and other structures that provide more complete and accurate polygonal room shape information to be automatically generated from target image(s) acquired for the building or other structure, including in some situations without having or using information from depth sensors or other distance-measuring devices about distances from images' acquisition locations to walls or other objects in a surrounding building or other structure. The use of a combination of a trained diffusion transformer machine learning model and a bundle adjustment optimizer model to analyze visual data of multiple images for a building (e.g., multiple panorama images in equirectangular format, such as each showing 360 degrees of horizontal visual data) may enable precise floor plan reconstruction and precise camera extrinsic determination in a single coordinate system from only sparsely captured images, including to use capabilities of the diffusion transformer machine learning model to generate accurate polygonal room shapes for a building's rooms and to inpaint or otherwise fill in missing structural elements from the aggregate visual data of the input images, while using capabilities of the bundle adjustment optimizer model to provide highly accurate positioning of walls relative to each other (including to account for intervening wall widths) and of the images' camera poses (locations and orientations) using non-linear optimization (e.g., to iteratively improve the global data that it produces using one or more defined cost functions and other defined constraints, and in some situations to provide output data within a layer of the diffusion transformer machine learning model to provide guidance constraints on the determinations performed by the diffusion transformer machine learning model). In addition, the use of a trained transformer model to determine initial rough estimates of building wall position data and building image camera poses from analysis of visual data of multiple images for a building (e.g., multiple panorama images in equirectangular format, such as each showing 360 degrees of horizontal visual data) may further provide significant benefits in efficiently generating such data (e.g., using less computing resources, including to do so more rapidly) and/or generating such data more accurately, including based on particular loss functions and associated techniques as discussed herein. Furthermore, the described automated techniques allow the room shape determination and resulting floor plan generation to be performed more quickly than previously existing techniques and with greater accuracy, including by using information acquired from the actual building environment (rather than from plans on how the building should theoretically be constructed), as well as enabling identifying changes to structural elements that occur after a building is initially constructed. Such described techniques further provide benefits in allowing improved automated navigation of a building by devices (e.g., semi-autonomous or fully autonomous vehicles), based at least in part on the determined acquisition locations of images and/or the generated floor plan information (and optionally other generated mapping information), including to significantly reduce computing power and time used to attempt to otherwise learn a building's layout. In addition, in some situations, the described techniques may be used to provide an improved GUI in which a user may more accurately and quickly obtain information about a building's interior (e.g., for use in navigating that interior) and/or other associated areas, including in response to search requests, as part of providing personalized information to the user, as part of providing value estimates and/or other information about a building to a user, etc. Various other benefits are also provided by the described techniques, some of which are further described elsewhere herein.

As noted above, automated operations of the DBAMIGM system may include analyzing visual data from multiple target images acquired at a multi-room building, such as multiple panorama images acquired at multiple acquisition locations in the multiple rooms and optionally other areas of the building-in at least some situations, such panorama images each includes 360° of horizontal visual coverage around a vertical axis and visual coverage of some or all of the floor and/or ceiling in one or more rooms (e.g., 180° or more of vertical visual coverage) and are referred to at times herein as ‘360°’ or ‘360’ panorama images or panoramas (e.g., ‘360 panoramas’, ‘360 panorama images’, etc.), and each may in some situations be presented using an equirectangular projection (e.g., with vertical lines and other vertical information shown as straight lines in the projection if the panorama image is in a ‘straightened’ format as discussed below, and with horizontal lines and other horizontal information in an acquired surrounding environment being shown in the projection in a curved manner if they are above or below a horizontal midpoint of the image, with an amount of curvature increasing as a distance from the horizontal centerline increases). In addition, such panorama images or other images may be projected to or otherwise converted to a ‘straightened’ format when they are analyzed in at least some situations, such that a column of pixels in such a straightened image corresponds to a vertical slice of information in a surrounding environment (e.g., a vertical plane), whether based on being acquired in such a straightened format (e.g., using a camera device having a vertical axis that is perfectly aligned with such vertical information in the surrounding environment or a direction of gravity) and/or being processed to modify the original visual data in the image to be in the straightened format (e.g., using information about a variation of the camera device from such a vertical axis; by using vertical information in the surrounding environment, such as an inter-wall border or door frame side; etc.). The image acquisition device(s) that acquires target images may, for example, be one or more mobile computing devices that each includes one or more cameras or other imaging systems (optionally including one or more fisheye lenses for use in acquiring panorama images and/or other lenses), and optionally includes additional hardware sensors to acquire non-visual data, such as one or more inertial measurement unit (or “IMU”) sensors that acquire data reflecting the motion of the device, and/or may be one or more camera devices that each lacks computing capabilities and is optionally associated with a nearby mobile computing device.

As noted above, automated operations of a DBAMIGM system may include generating multiple types of building information for a multi-room building based at least in part on analysis of overlapping visual data from multiple target images acquired at the building, including to use a PIA component that does a pairwise analysis of pairs of target images having visual data overlap to determine initial local structural information from the visual data of the pair of images (e.g., in a separate local coordinate system for each target image, in a shared local coordinate system determined for and shared by the information for that pair of target images, etc.). For example, in at least some situations, a trained neural network may be used to analyze pairs of images and jointly determine multiple types of building information from the visual data of the two images of a pair, such as to perform an analysis of each of the image pixel columns of two straightened images to predict or otherwise determine some or all of the following: co-visibility information (e.g., whether the visual data of the image pixel column being analyzed is also visible in the other image of the pair, such as for both images to show a same vertical slice of a surrounding environment); image angular correspondence information (e.g., if the visual data of the image pixel column being analyzed is also visible in the other image of the pair, the one or more image pixel columns of the other image of the pair that contains visual data for the same vertical slice of the surrounding environment); wall-floor and/or wall-ceiling border information (e.g., if at least a portion of a wall and a boundary of that wall with a floor and/or a ceiling is present in the image pixel column being analyzed, one or more image pixel rows in that image pixel column that correspond to the wall-floor and/or wall-ceiling boundary); positions of structural wall elements and/or other structural elements (e.g., if at least a portion of one or more structural elements are present in the image pixel column being analyzed, one or more image pixel rows in that image pixel column that correspond to each of the structural elements); per-image groups of image pixel columns for each wall and matching per-wall image pixel columns groups of the pair of images; etc. Identified structural elements may have various forms in various situations, such as structural elements that are part of walls and/or ceilings and/or floors (e.g., windows and/or sky-lights; passages into and/or out of the room, such as doorways and other openings in walls, stairways, hallways, etc.; borders between adjacent connected walls; borders between walls and a floor; borders between walls and a ceiling; borders between a floor and a ceiling; corners (or solid geometry vertices) where at least three surfaces or planes meet; a fireplace; a sunken and/or elevated portion of a floor; an indented or extruding portion of a ceiling; etc.), and optionally other fixed structural elements (e.g., countertops, bath tubs, sinks, islands, fireplaces, etc.). In addition, in at least some situations, some or all of the determined per-pixel column types of building information may be generated using probabilities or other likelihood values (e.g., an x % probability that an image pixel column's visual data is co-visible in the other image) and/or with a measure of uncertainty (e.g., based on a standard deviation for a predicted normal or non-normal probability distribution corresponding to a determined type of building information for an image pixel column, and optionally with a value selected from the probability distribution being used for the likely value for that building information type, such as a mean or median or mode). In at least some situations, the information about walls and other structural elements may be further used to determine initial polygonal room shapes of rooms of the building, and to combine the initial rough room shapes to form an initial rough floor plan for the building. Alternatively, if an image of a floor plan of the building is available (e.g., a raster image), an initial rough floor plan for the building may be generated by analyzing that image (e.g., a raster-to-vector conversion), whether in addition to or instead of using a combination of initial rough room shapes, including in some situations to combine a first initial rough floor plan for a building using information about structural elements and a second initial rough floor plan for a building that is generated from an image of an existing building floor plan (e.g., in a weighted manner).

As noted, the DBAMIGM system may use a bundle adjustment optimizer component that analyzes a group of target images (e.g., 360° panorama images) for a building that have visual overlap between those images, to determine building information that includes global inter-image pose and structural element locations (e.g., room shapes and their wall positions, wall thicknesses, etc.) as well as matching groups of image pixel columns between a pair of images that represent the same wall, and to generate a resulting floor plan for the building, such as by starting with initial local structural information for each target image or target image pair that is determined by the PIA component if available, or in some situations by determining such initial local structural information in other manners or not using such initial local structural information. In contrast to other bundle adjustment technique usage with images (e.g., with Structure from Motion, or SfM; with Simultaneous Localization And Mapping, or SLAM; etc.) that attempt to simultaneously refine camera pose information with that of three-dimensional (“3D”) locations of individual one-dimensional (“1D”) points (e.g., as part of a point cloud), the described bundle adjustment optimizer component uses bundle adjustment optimization techniques to simultaneously refine camera pose information with that of positions of entire wall portions (e.g., planar or curved 2D surfaces, 3D structures, etc.) and optionally other two dimensional (“2D”) or 3D structural elements during each of multiple iterations for a single stage or phase of analysis and optionally using a combination of multiple separate loss functions, as part of floor plan generation with interconnected polygonal room shapes using such wall portions and optionally other structural elements. The techniques may include estimating at least initial wall information (e.g., position and shape) for each target image and initial image pose data (acquisition position and orientation) for each target image, and then using a combination of information from multiple target images to adjust at least the initial pose data to determine revised wall position and/or shape information that fits the walls together (e.g., at 90° angles in at least some situations) and forms corresponding rooms and other geographical areas, including determining wall thicknesses in at least some situations, and ultimately resulting in a generated floor plan for the building. In at least some such situations, the techniques may include analyzing the visual data of a target image to model each wall visible in the target image as including a planar or curved surface corresponding to a group of multiple identified pixel columns of the target image, with each such wall optionally having one or more visible inter-wall borders with another visible wall (and each such inter-wall border having one or more associated pixel columns of the target image) and/or having one or more borders between the wall and at least part of a floor that is visible in the target image (and each such wall-floor border having one or more associated rows in each of some or all of the wall's pixel columns of the target image) and/or having one or more borders between the wall and at least part of a ceiling that is visible in the target image (and each such wall-ceiling border having one or more associated rows in each of some or all of the wall's pixel columns of the target image)-additional details related to such information determination for a target image are included elsewhere herein, including with respect to FIG. 2U. The techniques may further include performing scene initialization, to combine different wall portions of a wall (e.g., for a wall that extends linearly across multiple rooms, different wall portions for different rooms; for a wall between two adjacent rooms and having two opposite faces or sides in those two rooms, the wall portions from those two rooms and having an initial estimated wall thickness corresponding to an initial estimated wall width between those wall portions, etc.). The bundle adjustment optimizer component may, for example, use bundle adjustment techniques and one or more of multiple defined loss functions as constraints for determining the building information using optimization techniques to minimize the loss function(s), such as part of a pipeline architecture, and with the defined loss functions related to differences in information across the multiple target images (e.g., differences in corresponding visual data in pairs of target images, and/or differences in walls and/or other geometric shapes identified in target images, and/or differences in other location data or other metadata associated with target images)-non-exclusive examples of such optimization techniques include least squares, adaptive memory programming for global optimization, dual annealing, etc. In addition, in at least some situations, a modeled wall may further each be treated as a three-dimensional (“3D”) shape with two opposing faces (e.g., with opposite normal orientations, such as in two different rooms for a wall that forms an inter-room divider) that are separated by an initial determined wall thickness (such as for a flat wall to be represented as a 3D ‘slab’ or other 3D shape), and optionally with a given wall extending linearly across multiple rooms-if so, the defined loss functions may further be used to determine revised wall thicknesses for particular walls, as well as to isolate particular target images having the most potential or actual error in their initial estimated data, as discussed further below.

The defined loss functions used by the bundle adjustment optimizer component may be of various types in various situations, such as one or more of the following: one or more image-based loss functions and constraints that reflect differences that are based on overlapping visual data between a pair of target images, such as based on co-visibility information and/or image angular correspondence information for the target images of the pair, and with differences that result at least in part on errors in initial estimate position and orientation (or ‘pose’) for one or both of the two target images; one or more loss functions and constraints based on structural elements that reflect differences that are based on initial positions and/or shapes of walls and/or of other structural elements (e.g., windows, doorways, non-doorway wall openings, inter-wall vertical borders, horizontal borders between a wall and one or both of a ceiling or floor, etc.) that are determined from target images of a pair, such as for walls modeled as 3D shapes and having planar surfaces (for ‘flat’ walls) or curved surfaces (e.g., for curved walls, such as fitted to a curved shape and/or a series of piecewise linear shapes); one or more loss functions and constraints based on geometry, such as to reflect differences between initial thickness of a wall (e.g., as initially determined from image data, default data, etc.) and subsequent determination of positions of the opposing faces of the wall, to (if an initial rough floor plan is available) reflect differences between locations of walls and/or other structural elements from the initial rough floor plan and a determined floor plan generated by the bundle adjustment optimizer component; one or more loss functions to reflect differences that are based on non-visual data associated with target images (e.g., GPS data or other location data); etc. As one non-exclusive example, the identification of wall-floor and/or wall-ceiling boundaries in a target image may be used to estimate initial distance to those one or more walls from the acquisition location of the target image, and differences in such wall-distance information from a pair of target images each having a view of the same wall (whether the same of different faces of the wall in a single room, whether the same or different linear portions of a wall extending across multiple rooms, etc.) may be used as one of the loss functions, such as based on reprojecting wall information for one of the target images into the other of the target images and measuring differences between wall positions based on the distances. As another non-exclusive example, differences in image angular correspondence information for target images of a pair may be used as one of the loss functions, such as based on reprojecting information for one or more image pixel columns from one of the target images into the other of the target images and determining differences from the corresponding image pixel columns in the other target image. As another non-exclusive example, differences in wall position and shape information from a pair of target images each having a view of the same wall (whether the same of different faces of the wall in a single room, whether the same or different linear portions of a wall extending across multiple rooms, etc.) may be used as one of the loss functions, such as based on reprojecting wall information for one of the target images into the other of the target images and measuring differences between wall position and/or shape. In addition, with respect to one or more loss functions and constraints based on structural elements that reflect differences based on initial positions and/or shapes of walls and/or of other structural elements, non-exclusive examples of such loss functions and constraints include the following: based on perpendicularity between walls (e.g., two walls joined at an inter-wall border); based on adjacency between walls and an intervening inter-wall border (e.g., wall A ending at an inter-wall border, and wall B also ending at that same inter-wall border, such that no overlapping or crossing should exist); based on parallelism between walls (e.g., two walls on opposite sides of a room); based on wall alignment in multiple rooms (e.g., for a wall that extends across multiple rooms, different portions of the wall in different rooms); based on individual room shapes (e.g., differences between initial rough room shapes, such as determined by a PIA component or otherwise received as input, and additional room shapes, such as determined by the bundle adjustment optimizer component); based on overall floor plan layout (e.g., differences between an initial floor plan layout, such as determined by a PIA component or otherwise received as input, and an additional floor plan layout, such as determined by the bundle adjustment optimizer component); etc. In some situations, a machine learning model may be trained and used to take a wall-distance matrix and extracted structural elements from images and to predict wall relations.

In addition, in at least some situations, information about associations between a wall (or a portion of the wall) and corresponding matching groups of image pixel columns in at least two target images may be used to identify outlier wall-pixel column associations that may not be used during the bundle adjustment, such as due to a higher likelihood of errors (or that may be used but given a lower weight). In some situations, the PIA component produces both floor-wall boundary information and an associated prediction confidence as standard deviations, and such prediction confidences may be used to identify outliers in edge and image column associations, as discussed in greater detail below. In addition, multiple ‘cycles’ may be identified that each includes a sequence of at least two target images, and at least one wall for each two adjacent target images in the sequence that is visible in both of those target images, with each such pair of adjacent target images and associated wall being referred to as a ‘link’ in the cycle, and with the respective image-wall information for such a pair of target images used as constraints in the poses of those target images and the positions and shapes of the walls. The constraints for such a cycle (also referred to herein as a ‘constraint cycle’) having one or more links may be used to determine an amount of error associated with the wall information, and for multi-link cycles, one or more particular links may be identified as having a greater likelihood of errors sufficiently high to treat it as an outlier (e.g., an amount of error above a defined threshold). In addition, such constraint cycles may be ‘direct’ cycles in which the target images of each link are viewing the same portion of the same face of the wall, or ‘indirect’ cycles in which the target images of at least one link are looking at different portions of the same wall that are further connected with each other via intermediate estimated information (e.g., with two faces of the same wall portion being separated by an estimated wall depth).

For illustrative purposes, some examples are described below in which specific types of information are acquired, used and/or presented in specific ways for specific types of structures and by using specific types of devices-however, it will be understood that the described techniques may be used in other manners in other situations, and that the invention is thus not limited to the exemplary details provided. As one non-exclusive example, while floor plans may be generated for houses that do not include detailed measurements for particular rooms or for the overall houses, it will be appreciated that other types of floor plans or other mapping information may be similarly generated in other situations, including for buildings (or other structures or layouts) separate from houses (including to determine detailed measurements for particular rooms or for the overall buildings or for other structures or layouts), and/or for other types of environments in which different target images are acquired in different areas of the environment to generate a map for some or all of that environment (e.g., for areas external to and surrounding a house or other building, such as on a same property as the building; or for environments separate from a building and/or a property, such as roads, neighborhoods, cities, runways, etc.). As another non-exclusive example, while floor plans for houses or other buildings may be used for display to assist viewers in navigating the buildings, generated mapping information may be used in other manners in other situations. As yet another non-exclusive example, while some examples discuss obtaining and using data from one or more types of image acquisition devices (e.g., a mobile computing device and/or a separate camera device), in other situations the one or more devices used may have other forms, such as to use a mobile device that acquires some or all of the additional data but does not provide its own computing capabilities (e.g., an additional ‘non-computing’ mobile device), multiple separate mobile devices that each acquire some of the additional data (whether mobile computing devices and/or non-computing mobile devices), etc. As another non-exclusive example, while the DBAMIGM system may in some situations determine positions of walls of rooms as part of generating a floor plan for a building, in some situations the DBAMIGM system may perform the same types of processing to determine the layout of fixtures and/or furniture (whether in addition to or instead of generating a building floor plan with positions of room walls), such as to produce 2D and/or 3D bounding boxes of non-structural objects in a common coordinate system (and optionally overlay those non-structural objects on a generated floor plan or otherwise associate them with particular positions on such a generated floor plan). As yet another non-exclusive example, while the DBAMIGM system may in some situations use a generated floor plan for a building to control or improve navigation in the building, in some situations the DBAMIGM system may perform the same types of processing as part of determining and visualizing structural changes to the building (whether in addition to or instead of using a generated floor plan for a building to control or improve navigation in the building), such as to remove and/or add walls or other built-in objects, to remove and/or add furniture or other movable objects, to change the texture of walls and/or other surfaces, etc. In addition, the term “building” refers herein to any partially or fully enclosed structure, typically but not necessarily encompassing one or more rooms that visually or otherwise divide the interior space of the structure, and in some situations including one or more adjacent or otherwise associated external areas and/or external accessory structures-non-limiting examples of such buildings include houses, apartment buildings or individual apartments therein, condominiums, office buildings, commercial buildings or other wholesale and retail structures (e.g., shopping malls, department stores, warehouses, etc.), etc. The term “acquire” or “capture” as used herein with reference to a building interior, acquisition location, or other location (unless context clearly indicates otherwise) may refer to any recording, storage, or logging of media, sensor data, and/or other information related to spatial and/or visual characteristics and/or otherwise perceivable characteristics of the building interior or other location or subsets thereof, such as by a recording device or by another device that receives information from the recording device. As used herein, the term “panorama image” may refer to a visual representation that is based on, includes or is separable into multiple discrete component images originating from a substantially similar physical location in different directions and that depicts a larger field of view than any of the discrete component images depict individually, including images with a sufficiently wide-angle view from a physical location to include angles beyond that perceivable from a person's gaze in a single direction (e.g., greater than 120° or 150° or 180°, etc.). The term “sequence” of acquisition locations, as used herein, refers generally to two or more acquisition locations that are each visited at least once in a corresponding order, whether or not other non-acquisition locations are visited between them, and whether or not the visits to the acquisition locations occur during a single continuous period of time or at multiple different times, or by a single user and/or device or by multiple different users and/or devices. In addition, various details are provided in the drawings and text for exemplary purposes, but are not intended to limit the scope of the invention. For example, sizes and relative positions of elements in the drawings are not necessarily drawn to scale, with some details omitted and/or provided with greater prominence (e.g., via size and positioning) to enhance legibility and/or clarity. Furthermore, identical reference numbers may be used in the drawings to identify similar elements or acts.

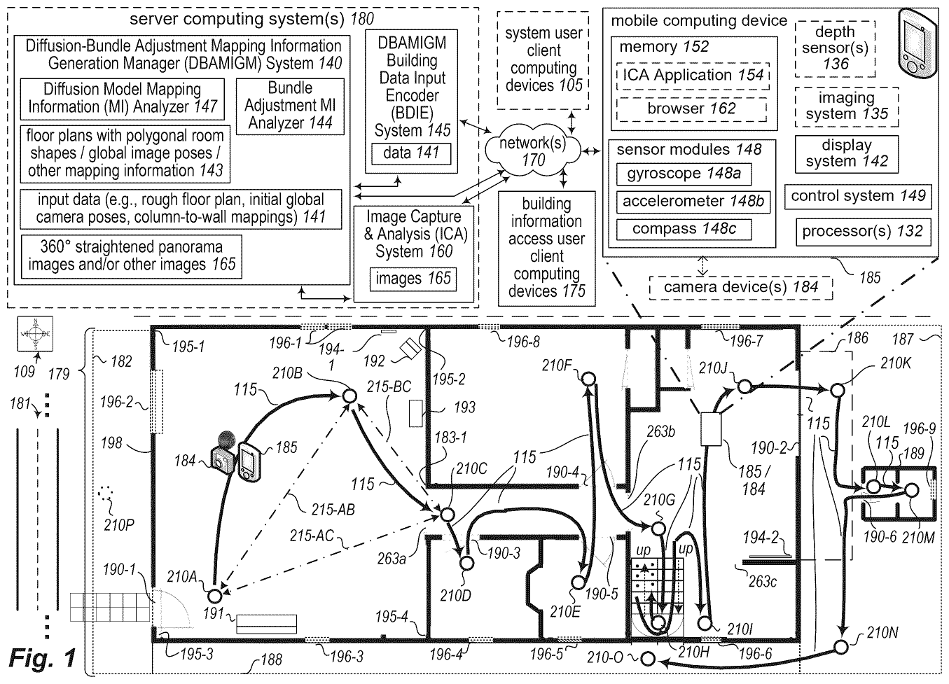

FIG. 1 is an example block diagram of various devices and systems that may participate in the described techniques in some situations. In particular, target images 165 have been acquired at acquisition locations for one or more buildings or other structures by one or more mobile computing devices 185 with imaging systems and/or by one or more separate camera devices 184 (e.g., without onboard computing capabilities), such as under control of an Interior Capture and Analysis (“ICA”) system 160 executing in this example on one or more server computing systems 180, and with the images 165 in this example being panorama images with 360° of horizontal visual coverage and being straightened-FIG. 1 further shows one example of such panorama image acquisition locations 210 for part of a particular example house 198, as discussed further below, and additional details related to the automated operation of the ICA system are included elsewhere herein. In at least some situations, at least some of the ICA system may execute in part on a mobile computing device 185 (e.g., as part of ICA application 154, whether in addition to or instead of ICA system 160 on the one or more server computing systems 180) to control acquisition of target images and optionally additional non-visual data by that mobile computing device and/or by one or more nearby (e.g., in the same room) optional separate camera devices 184 operating in conjunction with that mobile computing device, as discussed further below.

FIG. 1 further illustrates a DBAMIGM (Diffusion-Bundle Adjustment Mapping Information Generation Manager) system 140 that is executing on one or more server computing systems 180 to analyze visual data of target images (e.g., panorama images 165) acquired in each of some or all building rooms or other building areas of a building, and to use results of the analysis to generate information 143 for the building that includes global inter-image pose information and building floor plans (e.g., with 2D and/or 3D polygonal room shapes) and associated underlying 2D and/or 3D information (e.g., polygonal room shapes and inter-room shape layouts; locations of in-room structural elements such as doorways, windows, non-doorway wall openings, etc.; in-room acquisition locations of images; etc.) and optionally other mapping-related information (e.g., linked panorama images, 3D models, etc.) based on use of the target images and optionally associated metadata about their acquisition and linking-FIGS. 2X through 2Y show non-exclusive examples of such floor plans, as discussed further below, and additional details related to the automated operations of the DBAMIGM system are included elsewhere herein. In the illustrated example, the DBAMIGM system includes a Bundle Adjustment Analyzer MI (Mapping Information) component 144 that provides bundle adjustment optimizer functionality, and a Diffusion Model Mapping Information analyzer component 147 that includes a diffusion transformer machine learning model.

In addition, FIG. 1 further illustrates a DBAMIGM Building Data Input Encoder (BDIE) system 145 that in this example is also executing on the one or more server computing systems to analyze visual data of target images (e.g., panorama images 165) to determine data 141 including initial rough estimates of building wall position data and building image camera poses, such as for use by the DBAMIGM system (e.g., as input to the diffusion model of component 147 and/or the bundle adjustment optimizer model of component 144)-in at least some situations, the determined initial rough estimates of building wall position data and building image camera poses are included as part of an initial rough version of a floor plan for the building, such as including initial versions of polygonal room shapes relative to each other, and with those determined initial rough estimates to be further refined by the diffusion model and/or bundle adjustment optimizer model of the DBAMIGM system. In some situations, the BDIE system may include a Pairwise Image Analyzer (PIA) component that does a pairwise analysis of pairs of target images, while in other situations the BDIE system may simultaneously analyze all target images, as discussed in greater detail elsewhere herein.

In some situations, the ICA system 160 and/or DBAMIGM system 140 and/or BDIE system 145 may execute on the same server computing system(s), such as if multiple or all of those systems are operated by a single entity or are otherwise executed in coordination with each other (e.g., with some or all functionality of those systems integrated together into a larger system), while in other situations the DBAMIGM system and/or BDIE system may instead operate separately from the ICA system (e.g., without interacting with the ICA system), such as to obtain target images and/or optionally other information (e.g., other additional images, etc.) from one or more external sources and optionally store them locally (not shown) with the DBAMIGM system for further analysis and use. In addition, in some situations the DBAMIGM system and BDIE system may instead operate separately from each other, such as if the rough building floor plans of the BDIE system are used as final versions of floor plans for those buildings without use of the DBAMIGM system, and/or if the DBAMIGM system obtains its input data from a different source (or incorporates functionality of the BDIE system).

In at least some situations, one or more system operator users (not shown) of client computing devices 105 may optionally further interact over the network(s) 170 with the DBAMIGM system 140 (and/or one or more of its components 144 and 147) and/or with the BDIE system 145, such as to assist with some of the automated operations of the DBAMIGM and/or BDIE system/component(s) and/or for subsequently using information determined and generated by the DBAMIGM and/or BDIE system/component(s) in one or more further automated manners. One or more other end users (not shown) of one or more other client computing devices 175 may further interact over one or more computer networks 170 with the DBAMIGM system 140 and/or the BDIE system 145 and optionally the ICA system 160, such as to obtain and use generated floor plans and/or other generated mapping information, and/or to optionally interact with such a generated floor plan and/or other generated mapping information, and/or to obtain and optionally interact with additional information such as one or more associated target images (e.g., to change between a floor plan view and a view of a particular target image at an acquisition location within or near the floor plan; to change the horizontal and/or vertical viewing direction from which a corresponding subset of a panorama image is displayed, such as to determine a portion of a panorama image to which a current user viewing direction is directed, etc.), and/or to obtain information about images matching one or more indicated target images. In addition, in at least some situations, a mobile image acquisition device 185 may further interact with the DBAMIGM system (and/or one or more of its components) and/or the BDIE system (and/or one or more of its components) during an image acquisition session to obtain feedback about images that have been acquired and/or that should be acquired (e.g., by receiving and displaying at least partial building floor plan information generated from the acquired images, such as for one or more rooms), as discussed in greater detail elsewhere herein. In addition, while not illustrated in FIG. 1, a floor plan (or portion of it) may be linked to or otherwise associated with one or more other types of information, including for a floor plan of a multi-story or otherwise multi-level building to have multiple associated sub-floor plans for different stories or levels that are interlinked (e.g., via connecting stairway passages), for a two-dimensional (“2D”) floor plan of a building to be linked to or otherwise associated with a three-dimensional (“3D”) model floor plan of the building, etc.-in other situations, a floor plan of a multi-story or multi-level building may instead include information for all of the stories or other levels together and/or may display such information for all of the stories or other levels simultaneously. In addition, while not illustrated in FIG. 1, in some situations the client computing devices 175 (or other devices, not shown) may receive and use generated floor plan information and/or other related information in additional manners, such as to control or assist automated navigation activities by those devices (e.g., by autonomous vehicles or other devices), whether instead of or in addition to display of the generated information.

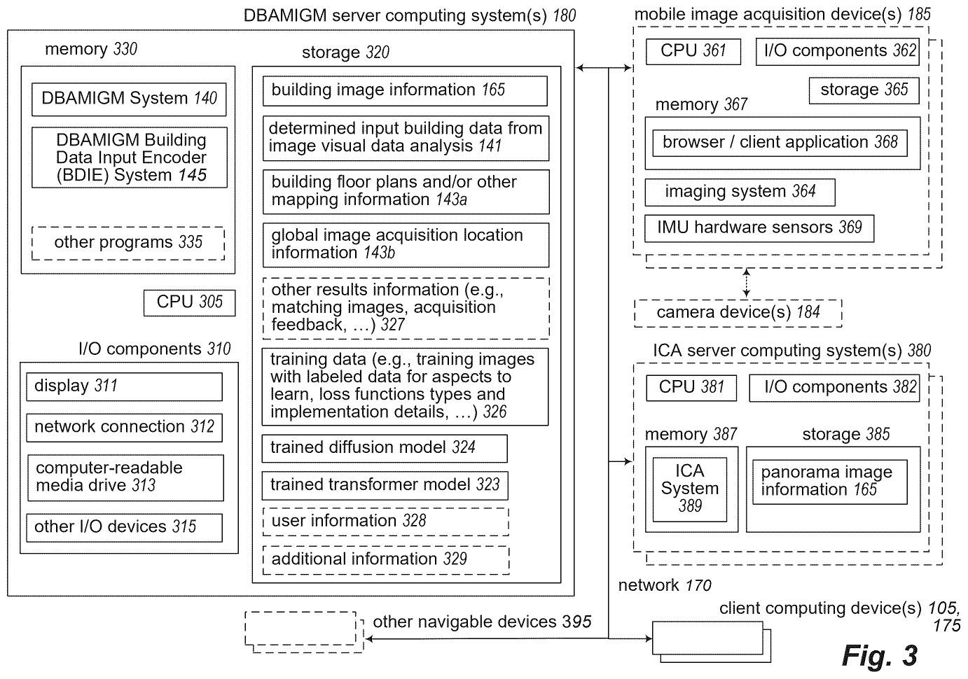

In the computing environment of FIG. 1, the network 170 may be one or more publicly accessible linked networks, possibly operated by various distinct parties, such as the Internet. In other implementations, the network 170 may have other forms. For example, the network 170 may instead be a private network, such as a corporate or university network that is wholly or partially inaccessible to non-privileged users. In still other implementations, the network 170 may include both private and public networks, with one or more of the private networks having access to and/or from one or more of the public networks. Furthermore, the network 170 may include various types of wired and/or wireless networks in various situations. In addition, the client computing devices 105 and 175 and server computing systems 180 may include various hardware components and stored information, as discussed in greater detail below with respect to FIG. 3.

In the example of FIG. 1, ICA system 160 may perform automated operations involved in generating multiple target panorama images (e.g., each a 360 degree panorama around a vertical axis) at multiple associated acquisition locations (e.g., in multiple rooms or other areas within a building or other structure and optionally around some or all of the exterior of the building or other structure), such as for use in generating and providing a representation of the building (including its interior) or other structure. In some situations, further automated operations of the ICA system may further include analyzing information to determine relative positions/directions between each of two or more acquisition locations, creating inter-panorama positional/directional links in the panoramas to each of one or more other panoramas based on such determined positions/directions, and then providing information to display or otherwise present multiple linked panorama images for the various acquisition locations within the building, while in other situations some or all such further automated operations may instead be performed by the DBAMIGM system or one or more of its components 144 and 147. Additional details related to examples of a system providing at least some such functionality of an ICA system are included in U.S. Non-Provisional patent application Ser. No. 16/693,286, filed Nov. 23, 2019 and entitled “Connecting And Using Building Data Acquired From Mobile Devices” (which includes disclosure of an example BICA system that is generally directed to obtaining and using panorama images from within one or more buildings or other structures); in U.S. Non-Provisional patent application Ser. No. 16/236,187, filed Dec. 28, 2018 and entitled “Automated Control Of Image Acquisition Via Use Of Acquisition Device Sensors” (which includes disclosure of an example ICA system that is generally directed to obtaining and using panorama images from within one or more buildings or other structures); in U.S. Non-Provisional patent application Ser. No. 16/190,162, filed Nov. 14, 2018 and entitled “Automated Mapping Information Generation From Inter-Connected Images”; in U.S. Non-Provisional patent application Ser. No. 17/080,604, filed Oct. 26, 2020 and entitled “Generating Floor Maps For Buildings From Automated Analysis Of Visual Data Of The Buildings' Interiors”; in U.S. Provisional Patent Application No. 63/035,619, filed Jun. 5, 2020 and entitled “Automated Generation On Mobile Devices Of Panorama Images For Buildings Locations And Subsequent Use”; and in U.S. Non-Provisional patent application Ser. No. 17/459,820, filed Aug. 27, 2021 and entitled “Automated Mapping Information Generation From Analysis Of Building Photos”; each of which is incorporated herein by reference in its entirety.

FIG. 1 further depicts a block diagram of an exemplary building environment in which panorama images may be acquired, linked and used to generate and provide a corresponding building floor plan, as well as for use in presenting the panorama images to users and/or for other uses as discussed herein. In particular, FIG. 1 illustrates part of a building 198 on a property 179 that includes yards 182, 187 and 188 and an additional outbuilding 189, and with an interior and exterior of the building 198 that is acquired at least in part via multiple target panorama images, such as by a user (not shown) carrying one or more mobile computing devices 185 with image acquisition capabilities and/or one or more separate camera devices 184 through the building interior to a sequence of multiple acquisition locations 210 to acquire the target images and optionally additional non-visual data for the multiple acquisition locations 210. An example of the ICA system (e.g., ICA system 160 on server computing system(s) 180; a copy of some or all of the ICA system executing on the user's mobile device, such as ICA application system 154 executing in memory 152 on device 185; etc.) may automatically perform or assist in the acquiring of the data representing the building interior. The mobile computing device 185 of the user may include various hardware components, such as one or more sensors 148 (e.g., a gyroscope 148a, an accelerometer 148b, a compass 148c, etc., such as part of one or more IMUs, or inertial measurement units, of the mobile device; an altimeter; light detector; etc.), one or more hardware processors 132, memory 152, a display 142, optionally one or more cameras or other imaging systems 135, optionally a GPS receiver, and optionally other components that are not shown (e.g., additional non-volatile storage; transmission capabilities to interact with other devices over the network(s) 170 and/or via direct device-to-device communication, such as with an associated camera device 184 or a remote server computing system 180; one or more external lights; a microphone, etc.)-however, in some situations, the mobile device may not have access to or use hardware equipment to measure the depth of objects in the building relative to a location of the mobile device (such that relationships between different panorama images and their acquisition locations may be determined in part or in whole based on analysis of the visual data of the images, and optionally in some such situations by further using information from other of the listed hardware components (e.g., IMU sensors 148), but without using any data from any such depth sensors), while in other situations the mobile device may have one or more distance-measuring sensors 136 (e.g., using lidar or other laser rangefinding techniques, structured light, synthetic aperture radar or other types of radar, etc.) used to measure depth to surrounding walls and other surrounding objects for one or more images' acquisition locations (e.g., in combination with determined building information from analysis of visual data of the image(s), such as determined inter-image pose information for one or more pairs of panorama images relative to structural layout information that may correspond to a room or other building area). While not illustrated for the sake of brevity, the one or more camera devices 184 may similarly each include at least one or more image sensors and storage on which to store acquired target images and transmission capabilities to transmit the acquired target images to other devices (e.g., an associated mobile computing device 185, a remote server computing system 180, etc.), optionally along with one or more lenses and lights and other physical components (e.g., some or all of the other components shown for the mobile computing device). While directional indicator 109 is provided for viewer reference, the mobile device and/or ICA system may not use absolute directional information in at least some situations, such as to instead determine relative directions and distances between panorama images' acquisition locations 210 without use of actual geographical positions/directions.

In operation, the mobile computing device 185 and/or camera device 184 (hereinafter referred to at times as “one or more image acquisition devices”) arrive at a first acquisition location within a first room of the building interior (e.g., acquisition location 210A in a living room of the house, such as after entering the house from an external doorway 190-1), and acquires visual data for a portion of the building interior that is visible from that acquisition location (e.g., some or all of the first room, and optionally small portions of one or more other adjacent or nearby rooms, such as through doorways, halls, stairways or other connecting passages from the first room)-in this example situation, a first image may be acquired at acquisition location 210A and a second image may be acquired in acquisition location 210B within the same room (as discussed further with respect to example images shown in FIGS. 2A-2D) before proceeding to acquire further images at acquisition locations 210C and 210D (as discussed further with respect to an example image shown in FIGS. 2D and 2V). In at least some situations, the one or more image acquisition devices may be carried by or otherwise accompanied by one or more users, while in other situations may be mounted on or carried by one or more self-powered devices that move through the building under their own power (e.g., aerial drones, ground drones, etc.). In addition, the acquisition of the visual data from an acquisition location may be performed in various manners in various situations (e.g., by using one or more lenses that acquire all of the image data simultaneously, by an associated user turning his or her body in a circle while holding the one or more image acquisition devices stationary relative to the user's body, by an automated device on which the one or more image acquisition devices are mounted or carried rotating the one or more image acquisition devices, etc.), and may include recording a video at the acquisition location and/or taking a succession of one or more images at the acquisition location, including to acquire visual information depicting a number of objects or other elements (e.g., structural details) that may be visible in images (e.g., video frames) acquired from or near the acquisition location. In the example of FIG. 1, such objects or other elements include various elements that are structurally part of the walls (or “wall elements”), such as the doorways 190 and their doors (e.g., with swinging and/or sliding doors), windows 196, inter-wall borders (e.g., corners or edges) 195 (including corner 195-1 in the northwest corner of the building 198, corner 195-2 in the northeast corner of the first room, corner 195-3 in the southwest corner of the building 198, and corner 195-4 in the southeast corner of the first room), other corners or inter-wall borders 183 (e.g., corner/border 183-1 at the northern side of the wall opening between the living room and the hallway to the east), etc.-in addition, such objects or other elements in the example of FIG. 1 may further include other elements within the rooms, such as furniture 191-193 (e.g., a couch 191; chair 192; table 193; etc.), pictures or paintings or televisions or other objects 194 (such as 194-1 and 194-2) hung on walls, light fixtures, etc. The one or more image acquisition devices may optionally further acquire additional data (e.g., additional visual data using imaging system 135, additional motion data using sensor modules 148, optionally additional depth data using distance-measuring sensors 136, etc.) at or near the acquisition location, optionally while being rotated, as well as to optionally acquire further such additional data while the one or more image acquisition devices move to and/or from acquisition locations. Actions of the image acquisition device(s) may in some situations be controlled or facilitated via use of program(s) executing on the mobile computing device 185 (e.g., via automated instructions to image acquisition device(s) or to another mobile device, not shown, that is carrying those devices through the building under its own power; via instructions to an associated user in the room; etc.), such as ICA application system 154 and/or optional browser 162, control system 149 to manage I/O (input/output) and/or communications and/or networking for the device 185 (e.g., to receive instructions from and present information to its user, such as part of an operating system, not shown, executing on the device), etc. The user may also optionally provide a textual or auditory identifier to be associated with an acquisition location, such as “entry” for acquisition location 210A or “living room” for acquisition location 210B, while in other situations the ICA system may automatically generate such identifiers (e.g., by automatically analyzing video and/or other recorded information for a building to perform a corresponding automated determination, such as by using machine learning) or the identifiers may not be used.

After visual data and optionally other information for the first acquisition location has been acquired, the image acquisition device(s) (and user, if present) may optionally proceed to a next acquisition location along a path 115 during the same image acquisition session (e.g., from acquisition location 210A to acquisition location 210B, etc.), optionally recording movement data during movement between the acquisition locations, such as video and/or other data from the hardware components (e.g., from one or more IMU sensors 148, from the imaging system 135, from the distance-measuring sensors 136, etc.). Additional details related to examples of generating and using linking information between panorama images, including using travel path information and/or elements or other features visible in multiple images, are included in U.S. Non-Provisional patent application Ser. No. 16/693,286, filed Nov. 23, 2019 and entitled “Connecting And Using Building Data Acquired From Mobile Devices” (which includes disclosure of an example BICA system that is generally directed to obtaining and using linking information to inter-connect multiple panorama images acquired within one or more buildings or other structures), in U.S. Non-Provisional patent application Ser. No. 17/080,604, filed Oct. 26, 2020 and entitled “Generating Floor Maps For Buildings From Automated Analysis Of Visual Data Of The Buildings' Interiors”; and in U.S. Provisional Patent Application No. 63/035,619, filed Jun. 5, 2020 and entitled “Automated Generation On Mobile Devices Of Panorama Images For Buildings Locations And Subsequent Use”; each of which is incorporated herein by reference in its entirety. At the next acquisition location, the one or more image acquisition devices may similarly acquire one or more images from that acquisition location, and optionally additional data at or near that acquisition location. The process may repeat for some or all rooms of the building and optionally outside the building, as illustrated for acquisition locations 210A-210P, including in this example to acquire target panorama image(s) on an external deck or patio or balcony area 186, on a larger external back yard or patio area 187, in a separate side yard area 188, near or in an external additional outbuilding or accessory structure area 189 (e.g., a garage, shed, accessory dwelling unit, greenhouse, gazebo, car port, etc.) that may have one or more rooms, in a front yard 182 between the building 198 and the street or road 181 (e.g., during a different image acquisition session than used to acquire some or all of the other target images), and in other situations from an adjoining street or road 181 (not shown), from one or more overhead locations (e.g., from a drone, airplane, satellite, etc., not shown), etc. Acquired video and/or other images for each acquisition location are further analyzed to generate a target panorama image for each of some or all of acquisition locations 210A-210P, including in some situations to stitch together multiple constituent images from an acquisition location to create a target panorama image for that acquisition location and/or to otherwise combine visual data in different images (e.g., objects and other elements, etc.).

In addition to generating such target panorama images, further analysis may be performed in at least some situations by the BDIE and/or DBAMIGM systems (e.g., concurrently with the image acquisition activities or subsequent to the image acquisition) to determine layouts (e.g., room shapes and optionally locations of identified structural elements and other objects) for each of the rooms (and optionally for other defined areas, such as a deck or other patio outside of the building or other external defined area), including to optionally determine acquisition position information for each target image, and to further determine a floor plan for the building and any associated surrounding area (e.g., a lot or parcel for the property 179 on which the building is situated) and/or other related mapping information for the building (e.g., a 3D model of the building and any associated surrounding area, an interconnected group of linked target panorama images, etc.). The overlapping features visible in the panorama images may be used in some situations to ‘link’ at least some of those panorama images and their acquisition locations together (with some corresponding directional lines 215 between example acquisition locations 210A-210C being shown for the sake of illustration), such as using the described techniques. FIG. 2W illustrates additional details about corresponding inter-image links that may be determined and used by the DBAMIGM system, including in some situations to further link at least some acquisition locations whose associated target images have little-to-no visual overlap with any other target image and/or to use other determined alignments to link two acquisition locations whose images do not include any overlapping visual coverage.

Additional details related to examples of a system providing at least some such functionality of a system for generating floor plans and associated information and/or presenting floor plans and associated information are included in U.S. Non-Provisional patent application Ser. No. 16/190,162, filed Nov. 14, 2018 and entitled “Automated Mapping Information Generation From Inter-Connected Images” (which includes disclosure of an example Floor Map Generation Manager, or FMGM, system that is generally directed to automated operations for generating and displaying a floor plan or other floor plan of a building using images acquired in and around the building); in U.S. Non-Provisional patent application Ser. No. 16/681,787, filed Nov. 12, 2019 and entitled “Presenting Integrated Building Information Using Three-Dimensional Building Models” (which includes disclosure of an example FMGM system that is generally directed to automated operations for displaying a floor plan or other floor plan of a building and associated information); in U.S. Non-Provisional patent application Ser. No. 16/841,581, filed Apr. 6, 2020 and entitled “Providing Simulated Lighting Information For Three-Dimensional Building Models” (which includes disclosure of an example FMGM system that is generally directed to automated operations for displaying a floor plan or other floor plan of a building and associated information); in U.S. Non-Provisional patent application Ser. No. 17/080,604, filed Oct. 26, 2020 and entitled “Generating floor plans For Buildings From Automated Analysis Of Visual Data Of The Buildings' Interiors” (which includes disclosure of an example VTFM system that is generally directed to automated operations for generating a floor plan or other floor plan of a building using visual data acquired in and around the building); and in U.S. Non-Provisional patent application Ser. No. 16/807,135, filed Mar. 2, 2020 and entitled “Automated Tools For Generating Mapping Information For Buildings” (which includes disclosure of an example MIGM system that is generally directed to automated operations for generating a floor plan or other floor plan of a building using images acquired in and around the building); and in U.S. Non-Provisional patent application Ser. No. 17/069,800, filed Oct. 13, 2020 and entitled “Automated Tools For Generating Building Mapping Information” (which includes disclosure of an example MIGM system that is generally directed to automated operations for generating mapping information for a building using images acquired in and around the building); each of which is incorporated herein by reference in its entirety. Moreover, further details related to examples of a system providing at least some such functionality of a system for using acquired images and/or generated floor plans are included in U.S. Non-Provisional patent application Ser. No. 17/185,793, filed Feb. 25, 2021 and entitled “Automated Usability Assessment Of Buildings Using Visual Data Of Captured In-Room Images” (which includes disclosure of an example Building Usability Assessment Manager, or BUAM, system generally directed to automated operations for analyzing visual data from images acquired in building rooms to assess room layout and other usability information for the rooms and optionally for the overall building, and subsequently using the assessed usability information in one or more further automated manners); each of which is incorporated herein by reference in its entirety.

Various details are provided with respect to FIG. 1, but it will be appreciated that the provided details are non-exclusive examples included for illustrative purposes, and other examples may be performed in other manners without some or all such details.

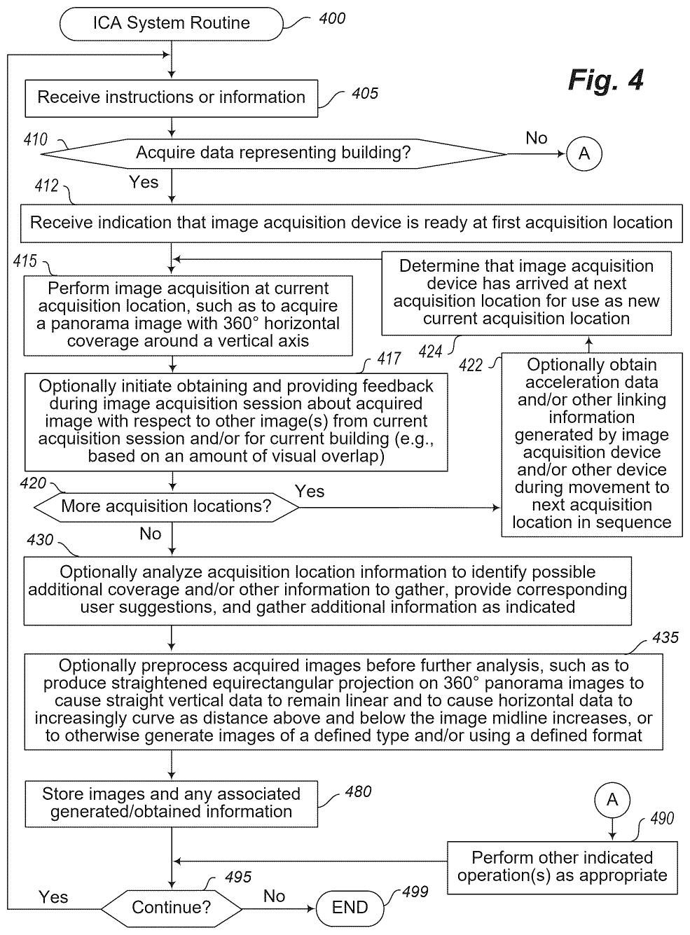

As noted above, in at least some situations, some or all of the images acquired for a building may be panorama images that are each acquired at one of multiple acquisition locations in or around the building, such as to generate a panorama image at each such acquisition location from one or more of a video acquired at that acquisition location (e.g., a 360° video taken from a smartphone or other mobile device held by a user turning at that acquisition location), or multiple images acquired in multiple directions from the acquisition location (e.g., from a smartphone or other mobile device held by a user turning at that acquisition location; from automated rotation of a device at that acquisition location, such as on a tripod at that acquisition location; etc.), or a simultaneous acquisition of all the image information for a particular acquisition location (e.g., using one or more fisheye lenses), etc. It will be appreciated that such a panorama image may in some situations be presented using an equirectangular projection (with vertical lines and other vertical information in an environment being shown as straight lines in the projection, and with horizontal lines and other horizontal information in the environment being shown in the projection in a curved manner if they are above or below a horizontal centerline of the image and with an amount of curvature increasing as a distance from the horizontal centerline increases) and provide up to 360° coverage around horizontal and/or vertical axes (e.g., 360° of coverage along a horizontal plane and around a vertical axis), while in other situations the acquired panorama images or other images may include less than 360° of vertical coverage (e.g., for images with a width exceeding a height by more than a typical aspect ratio, such as at or exceeding 21:9 or 16:9 or 3:2 or 7:5 or 4:3 or 5:4 or 1:1, including for so-called ‘ultrawide’ lenses and resulting ultrawide images). In addition, it will be appreciated that a user viewing such a panorama image (or other image with sufficient horizontal and/or vertical coverage that only a portion of the image is displayed at any given time) may be permitted to move the viewing direction within the panorama image to different orientations to cause different subset images of the panorama image to be rendered, and that such a panorama image may in some situations be stored and/or presented using an equirectangular projection (including, if the panorama image is represented using an equirectangular projection, and if a particular subset image of it is being rendered, to convert the image being rendered into a planar coordinate system before it is displayed, such as into a perspective image). Furthermore, acquisition metadata regarding the acquisition of such panorama images may be obtained and used in various manners, such as data acquired from IMU sensors or other sensors of a mobile device as it is carried by a user or otherwise moved between acquisition locations-non-exclusive examples of such acquisition metadata may include one or more of acquisition time; acquisition location, such as GPS coordinates or other indication of location; acquisition direction and/or orientation; relative or absolute order of acquisition for multiple images acquired for a building or that are otherwise associated; etc., and such acquisition metadata may further optionally be used as part of determining the images' acquisition locations in at least some situations, as discussed further below. Additional details are included below regarding automated operations of device(s) implementing an Image Capture and Analysis (ICA) system involved in acquiring images and optionally acquisition metadata, including with respect to FIGS. 2A-2D and 4 and elsewhere herein.

As is also noted above, a building floor plan having associated room layout or shape information for some or all rooms of the building may be generated in at least some situations, and further used in one or more manners, such as in the subsequent automated determination of an additional image's acquisition location within the building. A building floor plan with associated room shape information may have various forms in various situations, such as a 2D (two-dimensional) floor map of the building (e.g., an orthographic top view or other overhead view of a schematic floor map that does not include or display height information) and/or a 3D (three-dimensional) or 2.5D (two and a half-dimensional) floor map model of the building that does display height information. In addition, layouts and/or shapes of rooms of a building may be automatically determined in various manners in various situations, including in some situations at a time before automated determination of a particular image's acquisition location within the building. For example, in at least some situations, a BDIE system and/or a DBAMIGM system may analyze various target images acquired in and around a building in order to automatically determine room shapes of the building's rooms (e.g., 3D room shapes, 2D room shapes, etc., such as to reflect the geometry of the surrounding structural elements of the building)—the analysis may include, for example, automated operations to ‘register’ the camera positions for the images in a common frame of refence so as to ‘align’ the images and to estimate 3D locations and shapes of objects in the room, such as by determining features visible in the content of such images (e.g., to determine the direction and/or orientation of the acquisition device when it took particular images, a path through the room traveled by the acquisition device, etc.) and/or by determining and aggregating information about planes for detected features and normal (orthogonal) directions to those planes to identify planar surfaces for likely locations of walls and other surfaces of the room and to connect the various likely wall locations (e.g., using one or more constraints, such as having 90° angles between walls and/or between walls and the floor, as part of the so-called ‘Manhattan world assumption’) and form an estimated partial room shape for the room. After determining the estimated partial room layouts and/or shapes of the rooms in the building, the automated operations may, in at least some situations, further include positioning the multiple room shapes together to form a floor plan and/or other related mapping information for the building, such as by connecting the various room shapes, optionally based at least in part on information about doorways and staircases and other inter-room wall openings identified in particular rooms, and optionally based at least in part on determined travel path information of a mobile computing device between rooms. Additional details are included below regarding automated operations of device(s) implementing a DBAMIGM system involved in determining room shapes and combining room shapes to generate a floor plan and/or a BDIE system to generate an initial rough floor plan with polygonal room shapes that are each a closed sequence of wall segments, including with respect to FIGS. 2E through 2Y, 5A-5D and 6 and elsewhere herein.

In addition, the generating of the multiple types of building information based on automated operations of the PIA component to perform pairwise analysis of visual data from multiple target images acquired at a building may further include, in at least some situations as part of analyzing a pair of images, using a combination of the visual data of the two images to determine additional types of building information, such as one or more of the following: locations of the structural elements (e.g., using bounding boxes and/or pixel masks for the two images); a 2D and/or 3D room shape or other structural layout for at least a portion of one or more rooms visible in the images (e.g., by combining information from the images about wall-floor and/or wall-ceiling boundaries, optionally with the locations of structural elements shown as part of the structural layout and/or with the acquisition locations of the images); inter-image directions and acquisition location positions (in combination, referred to at times herein as inter-image “pose” information) and optionally a distance between the acquisition locations of the two images, such as in a relative and/or absolute manner (e.g., identifying one or more image pixel columns in each of the images that contain visual data of the other image's acquisition location or otherwise point toward that other acquisition location; identifying the acquisition locations of the images within the structural layout(s) of some or all of the one or more rooms visible in the images or otherwise at determined points; etc.); etc. As with the types of building information determined using per-pixel column analysis, some or all of the determined additional types of building information may be generated in at least some situations using probabilities or other likelihood values (e.g., a probability mask for the location of a structural element) and/or with a measure of uncertainty (e.g., using a predicted normal or non-normal probability distribution corresponding to a determined type of building information).

The generating of the multiple types of building information based on automated operations of the DBAMIGM system from analysis of visual data from multiple target images acquired at a building may further include, in at least some situations, combining information from multiple image pairs to determine one or more further types of building information, such as one or more of the following: a partial or complete floor plan of the building; a group of ‘linked’ target images, such as based on inter-image directions between some or all pairs of images of the group, and optionally for use as a virtual tour of the building by using displayed user-selectable links overlaid on one or more of the displayed images of the group to cause display of a corresponding next image associated with a link that is selected; etc. As part of the generation of some or all such further types of building information, the automated operations of the DBAMIGM system may include combining local inter-image pose information from multiple pairs of images for some or all of target images, such as to cluster together the acquisition locations of those target images and determine global alignments of those acquisition locations (e.g., determining the acquisition locations of those some or all target images in a global common coordinate system, whether in a relative or absolute manner), and using the images' globally aligned acquisition locations and associated structural layout information to form a 2D and/or 3D floor plan (whether partial or complete, such as based on which target images are acquired and/or included in the common coordinate system).

In some situations, the BDIE and/or DBAMIGM systems may further use additional data acquired during or near the acquisition of some or all target images (e.g., IMU motion data of an image acquisition device and/or accompanying mobile computing device, depth data to surrounding structural elements, etc.), while in other situations no such additional data may be used. In at least some such situations, the determined structural layout information from a pair of target images may be 2D structural information (e.g., indications of positions of planar wall surfaces relative to each other, optionally with additional information added such as locations of structural wall elements), while in other situations the determined structural layout information may include a partial or complete 3D structure for visible room(s) or other building area(s)-such a 3D structure from a pair of target images may correspond to an estimated partial or full room shape for each of one or more rooms visible in the visual data of the target images of the pair, such as, for example, a 3D point cloud (with a plurality of 3D data points corresponding to locations on the walls and optionally the floor and/or ceiling) and/or disconnected partial planar surfaces (corresponding to portions of the walls and optionally the floor and/or ceiling) and/or wireframe structural lines (e.g., to show one or more of borders between walls, borders between walls and ceiling, borders between walls and floor, outlines of doorways and/or other inter-room wall openings, outlines of windows, etc.). In addition, in situations in which such room shapes are generated, they may be further used as part of one or more additional operations, such as when generating a floor plan (e.g., to generate a 3D model floor plan using 3D room shapes, to generate a 2D floor plan by fitting 3D room shapes together and then removing height information, etc., and such as by using a globally aligned and consistent 2D and/or 3D point cloud, globally aligned and consistent planar surfaces, globally aligned and consistent wireframe structural lines, etc.), and/or when determining local alignment information (e.g., by aligning the 3D room shapes generated from two panorama images of a pair, such as using locations of inter-room passages and/or room shapes), and/or when performing global alignment information from determined local information for pairs of panorama images or other images. In at least some such situations, the determination of structural layout information for a pair of target images may further determine, within the determined layout(s) of the room(s) or other area(s), each of the target image's pose (the acquisition location of the target image, such as in three dimensions or degrees of freedom, and sometimes represented in a three-dimensional grid as an X, Y, Z tuple, and the orientation of the target image, such as in three additional dimensions or degrees of freedom, and sometimes represented as a three-dimensional rotational tuple or other directional vector), which is also referred to at times herein as an ‘acquisition pose’ or an ‘acquisition position’ of the target image. In addition, information about determined structural elements of rooms and other building areas may be used to fit structural layouts together in at least some such situations, such as to match doorways and other wall openings between two rooms, to use windows for exterior walls lacking another room on the other side (unless visual data available through a window between two rooms shows matches for images acquired in those two rooms) and that optionally have a matching external area on the other side. In some situations, local alignment information may be determined for, rather than a pair of images, one or more sub-groups each having two or more images (e.g., at least three images), and the group of inter-connected target images used to determine the global alignment information may include multiple such image sub-groups. Additional details are included below regarding the analysis of visual data of target images for a building to determine multiple types of building information for the building.

In addition, automated operations of the BDIE system and/or of the DBAMIGM system and/or of one or more associated systems may further include using one or more types of determined building information for a building for one or more uses in one or more situations. Non-exclusive examples of such uses may include one or more of the following: displaying or otherwise presenting or providing information about a generated floor plan for the building and/or other generated mapping information for the building (e.g., a group of inter-linked images) to enable navigation of the building, such as physical navigation of the building by a vehicle or other device that moves under its own power (e.g., automated navigation by the device, user-assisted navigation by the device, etc.), physical navigation of the building by one or more users, virtual navigation of the building by one or more users, etc.; using one or more indicated target images to identify other images that have a threshold or other indicated amount of visual overlap with the indicated target image(s) and/or that otherwise satisfy one or more matching criteria (e.g., based on a quantity and/or percentage of an indicated target image's pixel columns that are co-visible with another identified image, using identified structural wall elements and/or generated structural layouts and/or determined inter-image pose information between an indicated target image and another identified image, etc.), such as by searching other target images for the building, and/or by searching other images for a plurality of buildings (e.g., in situations in which the building(s) associated with the one or more indicated target image(s) are not known), and optionally for use in search results to a query that indicates the one or more target images; to provide feedback during an image acquisition session for a building, such as for one or more most recently acquired target images (e.g., in a real-time or near-real-time manner after the most recent image acquisition, such as within one or more seconds or minutes or fractions of a second) or other indicated target images for the building and with respect to other images acquired for the building (e.g., other images acquired during the image acquisition session), such as feedback based on an amount of visual overlap between the indicated target image(s) and one or more other identified images and/or based on one or more other feedback criteria (e.g., feedback to reflect whether there is sufficient coverage of the building and/or to direct acquisition of one or more additional images that have an indicated amount of visual overlap with other acquired images or that otherwise have indicated characteristics, such as based on a quantity and/or percentage of an indicated target image's pixel columns that are co-visible with another identified image, using identified structural wall elements and/or generated structural layouts and/or determined inter-image pose information between an indicated target image and another identified image, etc.), etc. Additional details are included below regarding uses of building information of various types determined from analysis of visual data of target images for a building.

In addition, in some situations, the automated operations of the BDIE system and/or the DBAMIGM system may include obtaining input information of one or more types from one or more users (e.g., system operator users of the BDIE and/or DBAMIGM systems that assist in their operations, end users that obtain results of information from the BDIE and/or DBAMIGM systems, etc.), such as to be incorporated into subsequent automated analyses in various manners, including to replace or supplement automatically generated information of the same type, to be used as constraints and/or prior probabilities during later automated analysis (e.g., by a trained neural network), etc. Furthermore, in some situations, the automated operations of the BDIE and/or DBAMIGM systems further include obtaining and using additional types of information during its analysis activities, with non-exclusive examples of such additional types of information uses including the following: obtaining and using names or other tags for particular rooms or other building areas, such as for use in grouping target images whose acquisition locations are in such rooms or other areas; obtaining information to use as initial pose information for a target image (e.g., to be refined in subsequent automated determination of structural layout information from the target image); obtaining and using other image acquisition metadata to group target images or to otherwise assist in image analysis, such as to use image acquisition time information and/or order information to identify consecutive images that may be acquired in proximate acquisition locations; etc. Additional details are included below regarding other automated operations of the BDIE and DBAMIGM systems in some situations, and additional details related to examples of a system providing related functionality are included in U.S. Non-Provisional patent application Ser. No. 17/564,054, filed Dec. 28, 2021 and entitled “Automated Building Information Determination Using Inter-Image Analysis Of Multiple Building Images”; which is incorporated herein by reference in its entirety.

FIGS. 2A through 2Y illustrate examples of automated operations for analyzing visual data of images acquired in multiple rooms of a building to determine multiple types of building information (e.g., a floor plan for the building) based at least in part on using visual data of the images, and for generating and presenting information about the floor plan for the building, such as based on target images acquired within the building 198 of FIG. 1.

In particular, FIG. 2A illustrates an example image 250a, such as a non-panorama perspective image acquired by one or more image acquisition devices in a northeasterly direction from acquisition location 210B in the living room of house 198 of FIG. 1 (or a northeasterly facing subset formatted in a rectilinear manner of a 360-degree panorama image taken from that acquisition location)—the directional indicator 109a is further displayed in this example to illustrate the northeasterly direction in which the image is taken. In the illustrated example, the displayed image includes several visible elements (e.g., light fixture 130a), furniture (e.g., chair 192), two windows 196-1, and a picture 194-1 hanging on the north wall of the living room. No passages into or out of the living room (e.g., doorways or other wall openings) are visible in this image. However, multiple room borders are visible in the image 250a, including horizontal borders between a visible portion of the north wall of the living room and the living room's ceiling and floor, horizontal borders between a visible portion of the east wall of the living room and the living room's ceiling and floor, and the inter-wall vertical border 195-2 between the north and east walls.

FIGS. 2B and 2C continue the example of FIG. 2A, with FIG. 2B illustrating an additional perspective image 250b acquired by the one or more image acquisition devices in a northwesterly direction from acquisition location 210B in the living room of house 198 of FIG. 1 (or a northwesterly facing subset formatted in a rectilinear manner of a 360-degree panorama image taken from that acquisition location), and with FIG. 2C illustrating third perspective image 250c acquired by the one or more image acquisition devices in a southwesterly direction in the living room of house 198 of FIG. 1 from acquisition location 210B (or a southwesterly facing subset formatted in a rectilinear manner of a 360-degree panorama image taken from that acquisition location)-directional indicators 109b and 109c are also displayed in FIGS. 2B and 2C, respectively, to illustrate a northwesterly direction in which the image 250b is taken, and to illustrate a southwesterly direction in which the image 250c is taken. In example image 250b, a small portion of one of the windows 196-1 continues to be visible, along with a portion of window 196-2 and a new lighting fixture 130b, and horizontal and vertical room borders are visible in a manner similar to that of FIG. 2A. In example image 250c, a portion of window 196-2 continues to be visible, as is a couch 191 and visual horizontal and vertical room borders in a manner similar to that of FIGS. 2A and 2B. This example image 250c further illustrates a wall opening passage into/out of the living room, which in this example is doorway 190-1 to enter and leave the living room (which is an exterior door to the house's front yard 182 and subsequent street or road 181, as shown in FIG. 1). It will be appreciated various other perspective images may be acquired from acquisition location 210B and/or other acquisition locations.

FIG. 2D continues the examples of FIGS. 2A-2C, and illustrates further information for a portion of the house 198 of FIG. 1, including a target panorama image 250d that shows the living room and limited portions of the hallway and a bedroom to the east of the living room (including doorway 190-3 between the hallway and the bedroom, visible through wall opening 263a between the living room and hallway, as well as structural wall elements of the living room that include the inter-wall borders 183-1 and 195-1 to 195-4, windows 196-1 to 196-3, etc.)-in particular, the image 250d is a 360° target panorama image acquired at acquisition location 210B, with the entire panorama image displayed using a straightened equirectangular projection format. As discussed with respect to FIGS. 1 and 2A-2C, in some situations, target panorama images may be acquired at various locations in the house interior, such as at location 210B in the living room, with corresponding visual contents of example target panorama image 250d subsequently used to determine a layout of at least the living room. In addition, in at least some situations, additional images may be acquired, such as if the one or more image acquisition devices (not shown) are acquiring video or one or more other sequences of continuous or near-continuous images as they move through the interior of the house. FIG. 2D further illustrates an additional 360° target panorama image 250e acquired at acquisition location 210C, with the entire panorama image displayed using a straightened equirectangular projection format. As is shown, a portion of the living room is visible through wall opening 263a, including window 196-2, doorway 190-1, inter-wall borders 195-1 and 195-3, etc. In addition, the image 250e further illustrates additional portions of the hallway and dining room to the east of the hallway (through inter-wall opening 263b), as well as a small portion of the bedroom through doorway 190-3. In this example, portions of the rooms behind doorways 190-4 and 190-5 (a bathroom and second bedroom, respectively) are not visible due to the door in those doorways being closed.

FIG. 2E continues the examples of FIGS. 2A-2D, with FIG. 2E illustrating further information 256e that shows an example high-level overview of data and processing flow during automated operations of a Pairwise Image Analyzer (PIA) component in at least some situations, such as part of a BDIE system (not shown). In particular, in the example of FIG. 2E, multiple panorama images 241 are first acquired for a building, such as to correspond to some or all of acquisition locations 210A-210P illustrated in FIG. 1—some or all of the panorama images may, for example, be generated by the ICA system, or may instead be provided to the illustrated PIA component from one or more other sources. The multiple panorama images 241 and optionally additional information (e.g., camera height information, floor/ceiling height information, one or more additional indicated target images, etc.) are then provided to the PIA component.

In this example, after the multiple panorama images 241 are provided to the PIA component, they are each optionally converted in step 281 to a straightened spherical projection format, such as if not already in that format, with the output of step 281 including the target images in straightened spherical projection format 242, which are further provided after step 281 is completed as input to step 282 as well as optionally to later step 286, although in other situations the steps 281 and 282 may instead be performed at least partially concurrently (such as for step 282 to begin the analysis of a first pair of images that have already been analyzed in step 281, while step 281 concurrently performs its processing for additional images). After step 281 (or concurrently with step 281 once step 281 has analyzed at least two images), the operations of the PIA component continue in step 282, which takes as input the target images in straightened spherical projection format 242, selects the next pair of images (referred to as images A and B for the sake of reference), beginning with a first pair, and uses a trained neural network to jointly determine multiple types of predicted local information for the room(s) visible in the images of the pair, based at least in part on per-image pixel column analysis of visual data of each of the images, and with the determined building information in this example including data 243 (e.g., probabilities for per-pixel column co-visibilities and angular correspondence matches and locations of structural elements, such as windows, doorways and non-doorway openings, inter-wall borders, etc., per-image pixel column groups associated with each wall, and per-pixel column wall boundary with the floor and/or the ceiling, optionally with associated uncertainty information), as discussed in greater detail elsewhere herein-in at least some such situations, the order in which pairs of images are considered may be random.

After step 282, the operations of the PIA component continue in step 283, where a combination of visual data of the two images of the pair is used to determine one or more additional types of building information for the room(s) visible in the images (e.g., a 2D and/or 3D structural layout for the room(s), inter-image pose information for the images, matching per-wall image pixel column groups in the two images for each of one or some or all identified walls, and in-room acquisition locations of the images within the structural layout, etc.), such as by using data 243 and generating corresponding output image pair information 244. The automated operations then continue to determine if there are more pairs of images to compare (e.g., until all pairs of images have been compared), and if so returns to step 282 to select a next pair of images to compare. Otherwise, the automated operations continue to step 285 to store the determined information 242 and 243 and 244 for later use. After step 285, the automated operations continue to determine whether the determined building information from the analysis of the visual data of the pairs of images is for use in generating and providing feedback with respect to one or more indicated target images (e.g., during ongoing acquisition of building images), and if so continues to step 286, where the data 242 and/or 243 and/or 244 for the various images is used to identify feedback according to one or more specified feedback criteria (e.g., based on visual overlap of the indicated target image(s) with other images), and to provide the feedback. After step 286, or if it determined not to perform step 286, the routine ends, or otherwise continues (not shown) to process additional of the panorama images 241 that are received during an ongoing image acquisition session (e.g., based at least in part on feedback provided in step 286 during that ongoing image acquisition session). Additional details related to operations of an example of the PIA component are included in “SALVe: Semantic Alignment Verification for Floorplan Reconstruction from Sparse Panoramas” by Lambert et al. (European Conference On Computer Vision, Oct. 23, 2022, and accessible at https://doi.org/10.1007/978-3-031-19821-2_37) and in “CoVisPose: Co-Visibility Pose Transformer for Wide-Baseline Relative Pose Estimation in 360° Indoor Panoramas” by Hutchcroft et al. (European Conference On Computer Vision, Oct. 23, 2022, and accessible at https://www.ecva.net/papers/eccv_2022/papers_ECCV/papers/136920610.pdf), each of which is incorporated herein by reference in its entirety.

FIG. 2F continues the examples of FIGS. 2A-2E, and illustrates further information 256f regarding an example of the DBAMIGM system in which a combination of the trained diffusion transformer machine learning model and the bundle adjustment optimizer are used in parallel for each of one or more iterations (e.g., multiple iterations), including to use the bundle adjustment optimizer capabilities to independently produce a first group of output data (e.g., during multiple second iterations) and to use the diffusion transformer machine learning model to independently produce a second group of output data (e.g., during multiple first iterations, whether the same or different quantity as the second iterations), with those first and second groups of output data combined to form an aggregate group of output data. For example, the input data may include initial wall position data and image camera pose data corresponding to a group of building images (e.g., from the BDIE system), and the first and second and aggregate groups of output data may include adjusted wall position data and image camera pose data (e.g., deltas from the initial data), such as to eliminate or otherwise reduce errors from, when using the building image camera poses to reproject the walls into the input images, differences in the reprojected wall locations relative to corresponding aspects in the visual data of the input images, and with the aggregate output data being used as part of generation of a floor plan (not shown) and optionally other mapping information for the building, as discussed in greater detail elsewhere herein. In some situations, optimization iterations can be a permutation of 1) a weighted sum of 2 deltas computed in parallel, and 2) a single module run in each iteration, such that the 2 modules are alternating in determining adjustments to the scene parameters.

FIGS. 2G, 2H and 2I continue the examples of FIGS. 2A-2F, and illustrate further information 256g and 256h and 256i, respectively, regarding examples of the DBAMIGM system in which a combination of the trained diffusion transformer machine learning model and the bundle adjustment optimizer are used by including bundle adjustment optimizer functionality as a layer within the diffusion transformer machine learning model. For example, the DGAMIGM system may include using the bundle adjustment optimizer capabilities to produce data that is used as guidance to further determinations performed by the diffusion transformer machine learning model during each of one or more iterations performed by the diffusion transformer machine learning model (e.g., hundreds or thousands of iterations for each group of input images), such as to use data from computations by the bundle adjustment optimizer for deltas between initial room polygon shapes and initial building image camera poses and generated corrected room polygon shapes and building image camera poses (e.g., that eliminate or otherwise reduce errors from, when using the building image camera poses to reproject the room polygon shapes into the input images, differences in the reprojected room polygon shapes relative to corresponding aspects in the visual data of the input images), and with the final output data from the diffusion transformer model being used as part of generation of a floor plan (not shown) and optionally other mapping information for the building, as discussed in greater detail elsewhere herein. With respect to the information 256g of FIG. 2G, the illustrated architecture is used for both training and run-time activities—during training, losses from the outputs are computed and back-propagated to each layer of the neural network, and the trained neural network is then used during run-time operations. The information 256i of FIG. 2I illustrates additional details about one example of the architecture shown in FIG. 2G, with image columns from different images corresponding to the same wall being grouped. The information 256h of FIG. 2H illustrates additional details, in which the depth observations or predicted deltas from the bundle adjustment (BA) layer initially are by image columns, with Np images each having 512 columns in this example. Using the column-to-wall association, Np×512 inputs are turned into Nr×Np×512 outputs, where Nr is number of walls. This Nr×Np×512 output is a sparse matrix, where most of the positions are zero valued (because there is no value associated to a specific image and a specific wall at this current column position), which is passed through 2 layers of convolution in this example, followed by an MLP layer, to compress this 3D matrix into a Nr×512 2D matrix, which is the embedding corresponding to each wall.

As one non-exclusive example, the output of the bundle adjustment optimizer includes learned outlier rejection, learned room shape prior distribution and learned geometric constraints among walls, and is used as an additional channel to guide the sampling process performed by the diffusion transformer machine learning model, which is executed, for example, 10-60 times until it converges. The diffusion transformer machine learning model may further use angular constraints on walls, such as to permit one degree of freedom per wall during movements. The diffusion transformer machine learning model may be trained in a manner that is similar to that of a denoising diffusion probabilistic model and using classifier-free diffusion guidance, with additional details regarding such denoising included in “Denoising Diffusion Probabilistic Models” by Ho et al., available Dec. 16, 2020 at https://arxiv.org/pdf/2006.11239; in “Denoising Diffusion Implicit Models” by Song et al., available Oct. 5, 2022 at https://arxiv.org/pdf/2010.02502; and in “Classifier-Free Diffusion Guidance” by Ho et al., available Jul. 26, 2022 at https://arxiv.org/pdf/2207.12598, each of which is incorporated herein by reference in its entirety. For example, zero convolution training may include training an initial version of the diffusion transformer machine learning model without using the bundle adjustment optimizer, with weights used with outputs of the bundle adjustment optimizer being gradually increased, and using classifier-free guidance in which outputs of the bundle adjustment optimizer are used with only a subset of the training examples (e.g., 10%, 20%, 30%, 40%, etc.). When using the bundle adjustment optimizer output for training, noise sampling components of the denoising diffusion probabilistic model may be modified to add the first Gaussian noise θ₁ to a clean data point to simulate the noisy point at step t−1, to then add another Gaussian noise θ₂ to noisy point at step t while using a different noise pattern that is a subset of the original Gaussian noise distribution to generate θ₂ (with the Gaussian distribution angularly truncated and centered at the direction of the adjustment vector from the bundle adjustment optimizer), and to use another parameter controlling how much to rely on the bundle adjustment optimizer guidance versus that of the diffusion transformer machine learning model, which is controlled by an amount of noise injected during the sampling process. For the ‘image encoder’ component of FIG. 2G, pixel embeddings may, for example, be used based on image features extracted by the BDIE system, and/or from image foundational models, with non-exclusive examples of such image foundational models included in “DINOv2: Learning Robust Visual Features Without Supervision” by Oquab et al., available Feb. 2, 2024 at https://arxiv.org/pdf/2304.07193; and in “Masked Autoencoders Are Scalable Vision Learners” by He et al., available Dec. 19, 2021 at https://arxiv.org/pdf/2111.06377, each of which is incorporated herein by reference in its entirety.

FIG. 2J continues the examples of FIGS. 2A-2I, and illustrates further information 256j that shows an example high-level overview of data and processing flow during automated operations of a bundle adjustment optimizer component 151 in at least some situations. In particular, in the example of FIG. 2J, multiple panorama images 241 are acquired for a building, such as to correspond to some or all of acquisition locations 210A-210P illustrated in FIG. 1 some or all of the panorama images may, for example, be generated by the ICA system, or may instead be provided to the illustrated DBAMIGM system 140 from one or more other sources. The multiple panorama images 241 and optionally additional information (e.g., camera height information; floor/ceiling height information; one or more additional indicated target images, such as a rasterized image of an existing floor plan of a building; etc.) are then provided to the DBAMIGM system 140. The panorama images 241 may in some situations first be provided to a Pairwise Image Analyzer (PIA) component to determine 240a initial local information 231a specific to particular images and image pairs, such as in local coordinate systems or other local frames of reference specific to the particular images and image pairs, with one example of operations of such a PIA component being further discussed with respect to FIG. 2E. After step 240a, or alternatively if step 240a is not performed, the routine proceeds to perform step 240e, with the local information 231a that is the output of step 240a provided as further input to the step 240e if step 240a is performed. While not illustrated here, in other situations (e.g., if the PIA component is not provided or is otherwise not used), some or all such local information 231a may instead be provided to step 240e from other sources and/or may be determined in step 240e by the corresponding bundle adjustment optimizer component.

With respect to step 240e, the routine uses the Bundle Adjustment Mapping Information Analyzer (bundle adjustment optimizer) component to determine a floor plan for the building from some or all of the multiple panorama images 241 that have at least pairwise visual overlap, such as by performing bundle adjustment operations using multiple loss functions to determine global image pose information (e.g., in a common coordinate system) and room shape determinations and relative room shape placements and wall thickness determinations, so as to simultaneously refine camera pose information with that of positions of entire wall portions (e.g., planar or curved 2D surfaces, 3D structures, etc.) and optionally other two dimensional (“2D”) or 3D structural elements during each of multiple iterations for a single stage or phase of analysis. Such operations may include, for example, the following: obtaining predicted local image information about the building from multiple target images, such as from the PIA component performing block 240a; modeling the visible walls and optionally other structural elements in the images as 2D or 3D structural elements (if not already done in the obtained information); optionally determining and removing outlier information from use in the subsequent bundle adjustment optimization operations, with the outliers based on amount of error in image-wall information, and the determination of outliers including determining and analyzing constraint cycles each having one or more links that each includes at least two images and at least one wall portion visible in those images; selecting one or more of multiple defined loss functions, and using the defined loss functions and the information remaining after the optional removal of outlier information as part of bundle adjustment optimization operations to combine information from the multiple target images to adjust wall positions and/or shapes, and optionally wall thicknesses, as part of generating and/or adjusting wall connections to produce a building floor plan, including to generate global inter-image poses and to combine structural layouts. Corresponding output information 231e (e.g., a floor plan, globally aligned inter-image poses, additional building information such as determined room structural layouts and wall thicknesses and in-room image acquisition locations, etc.) is generated in block 240e and provided to step 240f for storage and further use, before ending.

FIGS. 2K-2T illustrate data and process flow examples for a DBAMIGM Building Data Input Encoder (BDIE) system in accordance with the present disclosure. In particular, FIG. 2K continues the examples of FIGS. 2A-2J, and illustrates further information 256k related to a first implementation using a trained transformer model as a decoder to determine, for each wall of a building that is visible in images of the building, per-image groups of image pixel columns with visual data of that wall, and to determine matches between pairs of images of the image pixel columns groups of a pair of images that correspond to the same wall. In at least some situations, the trained transformer model determines, for each image, a predicted segmentation mask of each wall, with the image pixel columns within the predicted segmentation mask of each wall then being selected as the group of image pixel columns for that wall for that image. In the example of FIG. 2K, the pipeline includes a self-attention encoder component 280a (top left) and a cross-attention decoder section 288 (rest of the illustrated module). The self-attention encoder performs an analysis analogous to that discussed in U.S. Non-Provisional patent application Ser. No. 17/564,054, filed Dec. 28, 2021 and entitled “Automated Building Information Determination Using Inter-Image Analysis Of Multiple Building Images,” but the image embeddings before the output layer are used as the inputs to the cross-attention decoder (rather than to generate predicted output). These embeddings not only include per-image information, but also the cross-view relation (the global information between 2 input images at a per-column level). The decoder uses a cross-attention mechanism, where the concatenated column embeddings and query embeddings, which represent inter-image global wall objects, are input. After a few layers of cross-attention, the query embedding is modified to represent individual global walls, which are then used in the first multiplication to pass global wall information to the column embedding. The second multiplication is used to finally generate the binary classification for each column to each wall class.

FIG. 2L continues the examples of FIGS. 2A-2K, and illustrates further information 256I related to a second implementation using a trained transformer machine learning model to determine, for each wall of a building that is visible in images of the building, per-image groups of image pixel columns with visual data of that wall, and to determine matches between images of the image pixel columns groups that correspond to the same wall. In the illustrated example of FIG. 2L, the example BDIE system simultaneously analyzes the visual data of all of the input images (in this example, N images), rather than performing the pairwise analysis of the example of FIG. 2K, and FIG. 2L illustrates activities involved in a first training phase for the transformer model. In particular, in this example, the operations include performing processing 280b that is similar to that of 280a of FIG. 2K, including to, for each of some or all pixel columns of each of the target input images being used for training, encode visual features of that image column using shared weights, and to further embed a unique column identifier for each set of encoded data (in this example using a combination of an image ID and a column ID within that image)-in this example, the operations further include performing at least global self-attention operations for a first M iterations, and further optionally alternating per-image self-attention operations for each of those iterations (e.g., to save memory). In this example, the operations then further include performing additional processing 289a, which in this example includes an additional N iterations in which additional self-attention processing is performed in a manner similar to that of operations 280b, with a further per-token linear layer, to learn to produce per-image outputs that in this example include per-image 2D data point maps, per-image column wall instance segmentation to map pixel columns two particular walls, and per-image camera poses (e.g., in a local coordinate system for each image).

FIGS. 2M-2Q illustrate example implementation details for use in training phase 1 in some situations, including example loss functions used in at least some such situations for training during backpropagation activities-in other situations, other loss functions and/or other implementation details may be used, as discussed in part elsewhere herein. In particular, FIG. 2M continues the examples of FIGS. 2A-2L, and shows information 256m illustrating an extension of 2-image (or ‘2-view’) comparison and analysis, such as similar to that performed in the first implementation of the BDIE system illustrated in FIG. 2K, to N-image (or ‘N-view’) comparison for an arbitrary number N of images. As illustrated in FIG. 2M, an N×W matrix is constructed and used, where N is the number of images and W is the number of pixel columns being analyzed for each image (whether all pixel columns, or a reduced number by grouping or otherwise aggregating multiple pixel columns together, such as each 2 or 4 or 6 or 8 or other quantity of pixel columns, with 4 pixel column groupings used in this example). As is noted, each location in the matrix represents co-visibility between two corresponding images (whether between a particular first pixel column in a first of the two images to a particular second pixel column in a second of the two images, or to a particular first group of multiple pixel columns in the first image to a particular second group of multiple pixel columns in the second image), and with the degree of co-visibility being determined in a range from 0 to 1 in this example, while in other embodiments may be measured in other manners (e.g., a binary 0 for no co-visibility, or 1 for co-visibility). In at least some situations, the intra-image sections of the matrix along the diagonal from upper left to lower right may not be performed.

FIG. 2N continues the examples of FIGS. 2A-2M, and shows information 256n illustrating further details about how to compute a co-visibility value for two pixel columns (or two groups of pixel columns) of two images by determining the vector distance between the generated embeddings for those two pixel columns (or groups of pixel columns). FIG. 2N further illustrates a particular example loss function (referred to as InfoNCE) that may be used in some situations, such as in situations where a single match (at most) is expected between a first pixel column (or first group of pixel columns) in a first image to another pixel column (or another group of pixel columns, optionally of a different quantity) in another image (since each image will only show a given segment of a particular wall at most once), to increase the difference between the co-visibility values for that one matching pixel column (or one matching group of pixel columns) in the other image relative to other pixel columns (or other groups of pixel columns) in that other image.

FIG. 2O (referred to herein as “2-O” to prevent confusion with the numeral ‘20’) continues the examples of FIGS. 2A-2N, and shows information 256o illustrating further details about how to use self-attention to predict image column co-visibility matches in N-view scenarios. In particular, as is illustrated, in a 2-view comparison, each self-attention prediction head predicts only between a pair of 2 images/views. In the N-view scenario, in at least some situations, a self-attention prediction head is modified to learn using the same objective, but to exhaustively predict, for all pairs of the N images/views, matching co-visibility column correspondences between the two images/views of that pair.

FIGS. 2P and 2Q continue the examples of FIGS. 2A through 2-O, and show further information 256p and 256q, respectively, illustrating further details about one specific example implementation for performing such N-view comparison in some situations, although other implementations may be used in other situations. In this example, a blockwise attention module is used to implement the N-view comparison. As previously noted, the first implementation of the BDIE system shown in FIG. 2K uses, in some situations, self-attention to do 2-view comparison, including to compute dense correspondences from each image column i of source image Iₐ to target view I_{b}—for example, a transformer machine learning model (e.g., deep neural network) F with attention mechanism is trained to regress the horizontal texture coordinate of the corresponding image column from view b as Corres_{i,a,b}=F(i,Iₐ,I_{B}), where Corres_{i,a,b}∈[0, 1], with the final token embeddings predicted as Z=V×Attention Matrix, where K Q V Z all have shape (s, d), and A has shape (s, s), such as illustrated in the upper right portion of FIG. 2-O. When instead using N views as input to this 2-view attention mechanism, it may produce shape (n*s, d) for K Q V Z and attention matrix of shape (n*s, n*s), but the attention mechanism using A, specifically the weighted sum of each embedding from V, will consider the image embeddings from all image columns from N views to compute each updated token, preventing training of the network to produce N view image column correspondences shaped as (n, n, s), as shown in the upper portion of FIG. 2Q.

Instead, blockwise self-attention is used to address this issue. Using block wise self-attention, the same Q K V A may be maintained, but focusing the weighted sum of the features in V by distinguishing different blocks defined by views as shown as different color coding, as shown in the lower portion of FIG. 2Q if each of the 3 ‘A for 3 view’ rows and associated 3 ‘blockwise output embedding’ rows and associated 3 rows in the ‘Final Prediction: (3, 3*4, 1)’ had a different color. With this design, each blockwise output embedding is computed by only considering its corresponding views, and does not increase the amount of computation. In at least some such situations, a blockwise attention layer is used only as a plugin in the last layer of global attention of the main architecture, to regress pairwise image correspondence texture coordinates. This means that the Q K V A used in blockwise attention is also used without any modification to compute normal token embeddings, and with the loss from the 2-view scenario being averaged among N views in this case as the loss function used to model backpropagation partly or completely in conjunction with other losses mentioned herein. As non-exclusive examples, such other losses may include one or more of the following: a global camera pose loss, to measure differences between predicted and actual pose data for each image; a global point map loss, to measure differences between predicted and actual wall positions (e.g., 2D points) for each image; a floor-wall boundary loss, to measure differences between predicted and actual rows in pixel columns of each image showing the floor-wall boundary; etc.

FIG. 2R continues the examples of FIGS. 2A-2Q, and illustrates further information 256r related to a second training phase for the illustrated second implementation of a trained transformer model. In particular, in this example, the training further includes additional operations 289b in a manner similar to operations 289a of FIG. 2L, but with adding further room and wall token information 284 that is further used as part of the second set of self-attention processing operations—in some situations, 256 or 512 tokens may be used, with each room token (shown as oblongs with a sequence of circles inside) having a specified number of wall segment tokens (e.g., 20) inside. By enabling the particular wall information identified in the first training phase to now be associated with particular rooms and global wall identifiers, identifications of the same wall in different images may be combined together and used to determine an aggregate global position of each wall in a single common coordinate system, along with determining sequences of wall segments that form each room shape (in a polygonal room shape), by, for each room token, filling in the first M wall tokens (e.g., 4 for a rectangular room) with a sequence of wall segment IDs. In particular, in this example the output from the transformer model further includes global information from across the various input images, including global wall segment positions in a single common coordinate system, as well as to optionally include sequence ordering for particular wall segments to form room shapes and validation information for each wall, and to optionally include further global wall line parameters.

FIG. 2S continues the examples of FIGS. 2A-2R, and illustrates further information 256s related to loss functions and implementations that may be used in some situations in the second training phase. In this example, FIG. 2S illustrates use the same InfoNCE loss function that was previously discuss to assist in identifying wall instance matches to corresponding pixel columns (or groups of pixel columns) of the N input images, such as by using the same self-attention encoder used in training phase 1, including to begin the phase 2 training using the same weights learned in the phase 1 training. In this example, an additional prediction head is used to predict the start and/or end pixel column for each wall visible in each image, such as to help ensure that there is at most one positive label for each wall instance from each image.

FIG. 2T continues the examples of FIGS. 2A-2S, and illustrates further information 256t related to the architecture of the illustrated second implementation after the transformer model is trained and ready to use. In particular, as is shown, multiple target images for a target building may be supplied as input, with the trained transformer model generating output that includes, for each wall of a target building that is visible in the target images of the target building, per-image groups of image pixel columns with visual data of that wall, and matches between target images of the image pixel columns groups that correspond to the same wall. In particular, in this example the output from the transformer model includes global information from across the various input target images, including global wall segment positions in a single common coordinate system, as well as to optionally include sequence ordering for particular wall segments to form room shapes and validation information for each wall, and to optionally include further global wall line parameters.

FIGS. 2U through 2V further illustrate examples of the various operations 281-283 discussed with respect to the DBAMIGM PIA component in FIG. 2E. In particular, FIG. 2U continues the examples of FIGS. 2A-2T, and illustrates examples of various types of building information that is determined based on analysis of the visual data of two example panorama images 250g-a and 250g-b-while not illustrated with respect to the example panorama images 250d and 250e in FIG. 2D, the same or similar types of information may be generated for that pair of images, as discussed further with respect to FIGS. 2V through 2Y. With respect to FIG. 2U, it includes information 256u1 that illustrates a pair of two example panorama images 250g-a and 250g-b in straightened equirectangular projection format, with various outputs 273-278 and 252 of the PIA component being shown. In this example, each image has 360° of horizontal visual coverage, as illustrated by image angle information 271a and 271b for the images 250g-a and 250g-b, respectively, and the visual data of each of the images is separated into 512 pixel rows (not shown) and 1024 pixel columns, as illustrated by image pixel column information 272a and 272b, respectively-it will be appreciated that each image angle may correspond to one or more pixel columns.

Information 273 of FIG. 2U illustrates probabilistically predicted co-visibility data for the two images, including information 273a for image 250g-a and information 273b for image 250g-b. In this example, almost all of the visual data of each of the two images is co-visible with respect to the other image, such as based on the acquisition locations of the two images being in the same room and with at most minimal intervening obstructions or other occluding objects. For example, with respect to image 250g-a, most of the image pixel columns in information 273a are shown in white to indicate a 100% probability of co-visibility with image 250g-b, except for an area 273c shown in hashed fashion to indicate different possible values in different situations for a small portion of the image 250g-a with visual data for a portion of another room through a doorway (e.g., if the visual data through the doorway is considered, to be shown in black to indicate a 0% probability of co-visibility since the corresponding doorway in image 250g-b at 252g is shown at approximately a 90° angle from the acquisition location for that image such that the other room is not visible in image 250g-b, or if the visual data through the doorway is not considered, then area 273c may similarly be shown in white to indicate a 100% probability of co-visibility since the portion of the room up to the doorway is visible in both rooms), and with a similar situation for area 273d corresponding to a portion of the doorway in image 250g-b (since there is co-visibility in image 250g-a for the left part of the same doorway). In other situations, the probability information for the co-visibility data may include intermediate values between 0% and 100%, in a manner analogous to that discussed below with respect to window location probabilities. In addition, information 274 of FIG. 2U illustrates probabilistically predicted image angular correspondence data for the two images, including information 274a for image 250g-a and information 274b for image 250g-b. In this example, to assist in illustrating matches in image angular correspondence data between the two images, a visual legend 279 is shown below each image (legend 279a for image 250g-a and legend 279b for image 250g-b) using a spectrum of colors (e.g., chosen randomly) to correspond to different image angles, and with the information in the image angular correspondence data for a first image of the pair using the pixel column legend color for the other second image of the pair to illustrate pixel columns in the first image that correspond to other pixel columns of the second image. For example, an image angular correspondence bar 252 is overlaid to show that example pixel column 270a of image 250g-a, which corresponds to just left of the middle of the window in the image, is given a color in the legend 279a of a mid-green shade 239a, with a corresponding image pixel column 270b of image 250g-b having been identified as including visual data for the same part of the surrounding room and thus having the same mid-green shade, with corresponding information 231a, 232a, 233a and 234a shown for image 250g-a for image angles 271a, pixel columns 272a, co-visibility information 273a and image angular correspondence data 274a, and similar corresponding information 231b, 232b, 233b and 234b shown for image 250g-b for image angles 271b, pixel columns 272b, co-visibility information 273b and image angular correspondence data 274b—it will be appreciated that since the image 250g-a has a smaller number of image pixel columns with visual data of the window than does image 250g-b, there are a larger number of image pixel columns in the image angular correspondence information 274b for image 250g-b that include the various shades of green corresponding to respective parts of the legend information 279a for image 250g-a. A second image angular correspondence bar 251 is similarly overlaid to illustrate one or more pixel columns of image 250g-a that have visual data whose color of a shade of magenta in the image angular correspondence data 274a corresponds to the same color 239b in the legend 279b for image 250g-b.

In addition, FIG. 2U further illustrates information 275 to correspond to a portion of the wall-floor boundary that is probabilistically predicted in each of the images and shown as a series of red arcs (including in this example to estimate the boundary for doorways and other areas in which a wall is not present or is not visible, such as behind the open doorway shown in image 250g-b), including information 275a for image 250g-a to show a portion of that image's wall-floor boundary, and information 275b for image 250g-b to show a portion of that image's wall-floor boundary. For example, with respect to image pixel column 270a in image 250g-a, an image pixel row 235a of image 250g-a is identified to correspond to the wall-floor boundary for that pixel column, and an image pixel row 235b of image 250g-b is similarly identified to correspond to the wall-floor boundary for image pixel column 270b of image 250g-b. Information 276, 277 and 278 is also shown to illustrate probabilistically predicted data for locations of windows, doorways, and non-doorway wall openings, respectively, including information 276a-278a of image 250g-a and information 276b-278b of image 250g-b. For example, with respect to window location probability information 276a for image 250g-a, information 236a illustrates the pixel columns of image 250g-a that are predicted to include visual data for the window, with the leftmost portion of the information 236a shown in gray to indicate a lower probability (e.g., due to the window shades partially obscuring the left end of the window) then the other portions of the information 236a-information 236b of window location probability data 276b for image 250g-b similarly shows the predicted window location information for that image. In a similar manner, the portions 237a of the doorway location probability information 277a of image 250g-a show the predicted locations of the two doorways visible in that image, and the corresponding portions 237b of the doorway location probability information 277b for image 250g-b show the predicted locations of the two doorways visible in that image. The portions 238a of the inter-wall border location probability information 278a of image 250g-a show the predicted locations of the four inter-wall borders visible in that image, and the corresponding portions 238b of the inter-wall border location probability information 278b of image 250g-b show the predicted locations of the four inter-wall borders visible in that image.

In addition to the per-image pixel column predicted types of building information 273-278, additional types of building information is determined based on a combination of the visual data of the two images, including structural layout information 275′ab based on the wall-floor boundary information 275 and inter-image pose information 252′ab, as illustrated as part of information 256u2 of FIG. 2U, and with pixel column indicators 252a and 252b shown for images 250g-a and 250g-b, respectively, to show the pixel column in each image that includes visual data in the direction of the other image. In this example, the structural layout information 275′ab is based on a combination of the boundary information 275a and 275b from images 250g-a and image 250g-b, respectively, and the inter-wall border probability information 278a and 278b from images 250g-a and image 250g-b, respectively, and is shown in the form of a two-dimensional room shape of the room in which the two images are acquired. Additional determined building information is shown on the structural layout 275′ab, including determined acquisition locations 250′g-a and 250′g-b for the images 250g-a and 250g-b, respectively, and indications of window locations 236′ab, doorway locations 237′ab, non-doorway wall opening locations 238′ab and inter-wall border locations 238′ab, with a corresponding legend 268 shown for reference. In this example, the two acquisition locations indicated on the structural layout further include indicators 251a and 251b to show the direction from that acquisition location to which the 0° portion of the image corresponds-in addition, for reference purposes, an indication of the direction 270′a is shown on the structural layout to indicate the pixel column 270a of image 250g-a. Each of the types of information labeled with an ‘ab’ in this example indicate a combination of data from the two images. In this example, scale information of various types is further determined for the room, including predicted values for room width length and height 269, a predicted value 252″ for the distance between the two images' acquisition locations, and predicted distance value 270a′ corresponding to the distance from image acquisition location 250′g-a to the wall shown in pixel column 270a. In addition, uncertainty information may exist with respect to any and/or all of the predicted types of building information, as illustrated in this example for the structural layout information 275′ab by uncertainty bands 269 corresponding to uncertainty about a location of a right side of the room-uncertainty information is not illustrated in this example for other types of determined building information or for other parts of the structural layout 275′ab. It will be appreciated that various other types of building information may be determined in other situations, and that building information types may be illustrated in other manners in other situations.

FIG. 2V continues the examples of FIGS. 2A through 2U, and further illustrates information 256v that may result from pairwise alignment of the target panorama images 250d and 250e corresponding to acquisition locations 210B and 210C respectively, from pairwise alignment of the target panorama images 250e and 250p (shown in FIG. 2V) corresponding to acquisition locations 210C and 210D respectively, and from pairwise alignment of a target panorama image corresponding to acquisition location 210A (e.g., a panorama or non-panoramic image, not shown) and panorama image 250e corresponding to acquisition location 210B. In particular, as previously discussed with respect to images acquired at acquisition locations 210A-210C, pairwise analysis of those images may generate inter-image pose information that corresponds to link 215-AB (between acquisition locations 210A and 210B via pairwise analysis of the images acquired at those acquisition locations) and link 215-BC (between acquisition locations 210A and 210B via pairwise analysis of the images acquired at those acquisition locations), with those links displayed on a structural layout 260 corresponding to the living room that may be determined based at least in part on the pairwise analysis of the images acquired at acquisition locations 210A and 210B, with further indications on that structural layout of the positions of the windows 196-1 through 196-3, doorway 190-1 and wall opening 263a, as well as the acquisition locations 210A and 210B. The information 256v further illustrates a structural layout 262 corresponding to the hallway (e.g., based at least in part on a pairwise analysis of the target panorama images 250d and 250e corresponding to acquisition locations 210B and 210C), including the positions of doorways 190-3 through 1900-5 and the acquisition location 210C. Similarly, the information 256v further illustrates a structural layout 261 corresponding to the bedroom with doorway 190-3 (e.g., based at least in part on a pairwise analysis of the target panorama images 250e and 250m corresponding to acquisition locations 210C and 210D), including the positions of doorway 190-3, window 196-4 and the acquisition location 210D, but optionally not some visible features such as lighting 130q. The structural layouts for the three rooms are further fitted together in this example, such as based at least in part on positions and doorways and non-doorway wall openings. In this example, it is illustrated that walls of the living room and bedroom may not be fitted together perfectly with a resulting gap 264h, such as a gap that may be incorrect and result from an initial imperfect pairwise alignment from the limited visual overlap between panorama images 250e and 250m (e.g., to be later corrected during global alignment activities and/or generation of a final floor plan), or a gap that is correct and reflects a thickness width of the wall between the living room and bedroom (i.e., the bedroom's western wall).

FIG. 2W continues the examples of FIGS. 2A-2V, and further illustrates information corresponding to step 240e of FIG. 2E, including information 256w that includes information resulting from globally aligning at least target panorama images 250d, 250e, 250g for acquisition locations 210B-210D and additional target images (not shown) for acquisition locations 210A and 210G together into a common coordinate system 205 (as shown using links 214-AB, 214-BC, 214-AC, 214-CD, 214-BG and 214-CG). FIG. 2W further illustrates that the automated operations may include identifying other links 214 between the target panorama images for other acquisition locations 210E-210N, and may optionally include using other determined information to link two acquisition locations whose images do not include any overlapping visual coverage (e.g., link 213-EH shown between acquisition locations 210E and 210H) and/or further linking at least some acquisition locations whose associated target images have no visual overlap with any other target image (e.g., link 212-PB shown in FIG. 2W between acquisition locations 210P and 210B), such as based on a determination that the visual data of a target panorama image for acquisition location 210P corresponds to a front yard and includes a view of entry doorway 190-1 and that the entry doorway 190-1 of the living room shown in the target panorama image for acquisition location 210B is likely to lead to the front yard (such that the two doorways visible in the two panorama images correspond to the same doorway). In some situations, given relative measurements between pairs of acquisition locations of target panorama images, global inter-image pose information is generated for some or all of the target panorama images. For example, if a simple noise-free case existed, all of the measurements would agree with one another and could just be chained together, with a spanning tree of the resulting graph giving the global pose information by chaining transformations together. In actual cases with some measurements being noisy and incorrect, rotation averaging may be used to estimate rotations in a single common global coordinate system from pairwise relative rotations of the locally aligned pairwise information. As part of doing so, a series of cascaded cycle consistency checks may be used, including on translation directions in the common coordinate system frame if scale is known, to ensure that a cycle of three or more inter-connected acquisition locations (each having local pairwise alignment information) results in zero total translation in the cycle (e.g., with relative rotations in a cycle triplet of three acquisition locations should compose to the identity rotation). Additional details corresponding to example situations of generating such global alignment information are included in U.S. Non-Provisional patent application Ser. No. 17/585,433, filed Jan. 26, 2022 and entitled “Automated Building Floor Plan Generation Using Visual Data Of Multiple Building Images”; which is incorporated herein by reference in its entirety.

FIGS. 2X through 2Y continue the examples of FIG. 2A-2W, and illustrate further mapping information for house 198 that may be generated from the types of analyses discussed in FIGS. 2E-2W. In particular, FIG. 2X illustrates information 256x that includes an example floor plan 230x that may be constructed based on the described techniques, which in this example includes walls and indications of doorways and windows. In some situations, such a floor plan may have further information shown, such as about other features that are automatically detected by the analysis operations and/or that are subsequently added by one or more users. For example, floor plan 230x includes additional information of various types, such as may be automatically identified from analysis operations of visual data from images and/or from depth data, including one or more of the following types of information: room labels (e.g., “living room” for the living room), room dimensions, visual indications of fixtures or appliances or other built-in features, visual indications of positions of additional types of associated and linked information (e.g., of panorama images and/or perspective images acquired at specified acquisition positions, which an end user may select for further display; of audio annotations and/or sound recordings that an end user may select for further presentation; etc.), visual indications of doorways and windows, etc.-in other situations, some or all such types of information may instead be provided by one or more DBAMIGM system operator users and/or ICA system operator users. In addition, when the floor plan 230x is displayed to an end user, one or more user-selectable controls may be added to provide interactive functionality as part of a GUI (graphical user interface) screen 255x, such as to indicate a current floor that is displayed, to allow the end user to select a different floor to be displayed, etc., with a corresponding example user-selectable control 228 added to the GUI in this example-in addition, in some situations, a change in floors or other levels may also be made directly by user interactions with the displayed floor plan, such as via selection of a corresponding connecting passage (e.g., a stairway to a different floor), and other visual changes may be made directly from the displayed floor plan by selecting corresponding displayed user-selectable controls (e.g., to select a control corresponding to a particular image at a particular location, and to receive a display of that image, whether instead of or in addition to the previous display of the floor plan from which the image is selected). In other situations, information for some or all different floors may be displayed simultaneously, such as by displaying separate sub-floor plans for separate floors, or instead by integrating the room connection information for all rooms and floors into a single floor plan that is shown together at once (e.g., a 3D model). It will be appreciated that a variety of other types of information may be added in some situations, that some of the illustrated types of information may not be provided in some situations, and that visual indications of and user selections of linked and associated information may be displayed and selected in other manners in other situations. FIG. 2Y continues the examples of FIGS. 2A through 2X, and illustrates additional information 256y that may be generated from the automated analysis techniques disclosed herein and displayed (e.g., in a GUI similar to that of FIG. 2X), which in this example is a 2.5D or 3D model floor plan of one story of the house. Such a model may be additional mapping-related information that is generated based on the floor plan 230r, with additional information about height shown in order to illustrate visual locations in walls of features such as windows and doors, or instead by combined final estimated room shapes that are 3D shapes. While not illustrated in FIG. 2Y, additional information may be added to the displayed walls in some situations, such as from acquired images (e.g., to render and illustrate actual paint, wallpaper or other surfaces from the house on the rendered model), and/or may otherwise be used to add specified colors, textures or other visual information to walls and/or other surfaces, and/or other types of additional information shown in FIG. 2X (e.g., information about exterior areas and/or accessory structures) may be shown using such a rendered model.

Additional details related to examples of a system providing at least some such functionality for generating floor plans and associated information and/or presenting floor plans and associated information, and/or of a system providing at least some such functionality of an ILDM (Image Location Determination Manager) system for determining acquisition positions of images, are included in U.S. Non-Provisional patent application Ser. No. 16/190,162, filed Nov. 14, 2018 and entitled “Automated Mapping Information Generation From Inter-Connected Images” (which includes disclosure of an example Floor Map Generation Manager, or FMGM, system that is generally directed to automated operations for generating and displaying a floor map or other floor plan of a building using images acquired in and around the building); in U.S. Non-Provisional patent application Ser. No. 16/681,787, filed Nov. 12, 2019 and entitled “Presenting Integrated Building Information Using Three-Dimensional Building Models” (which includes disclosure of an example FMGM system that is generally directed to automated operations for displaying a floor map or other floor plan of a building and associated information); in U.S. Non-Provisional patent application Ser. No. 16/841,581, filed Apr. 6, 2020 and entitled “Providing Simulated Lighting Information For Three-Dimensional Building Models” (which includes disclosure of an example FMGM system that is generally directed to automated operations for displaying a floor map or other floor plan of a building and associated information); in U.S. Non-Provisional patent application Ser. No. 17/080,604, filed Oct. 26, 2020 and entitled “Generating Floor Maps For Buildings From Automated Analysis Of Visual Data Of The Buildings' Interiors” (which includes disclosure of an example Video-To-Floor Map, or VTFM, system that is generally directed to automated operations for generating a floor map or other floor plan of a building using video data acquired in and around the building); in U.S. Provisional Patent Application No. 63/035,619, filed Jun. 5, 2020 and entitled “Automated Generation On Mobile Devices Of Panorama Images For Buildings Locations And Subsequent Use”; in U.S. Non-Provisional patent application Ser. No. 17/069,800, filed Oct. 13, 2020 and entitled “Automated Tools For Generating Building Mapping Information”; in U.S. Non-Provisional patent application Ser. No. 16/807,135, filed Mar. 2, 2020 and entitled “Automated Tools For Generating Mapping Information For Buildings” (which includes disclosure of an example MIGM system that is generally directed to automated operations for generating a floor map or other floor plan of a building using images acquired in and around the building); in U.S. Non-Provisional patent application Ser. No. 17/013,323, filed Sep. 4, 2020 and entitled “Automated Analysis Of Image Contents To Determine The Acquisition Location Of The Image” (which includes disclosure of an example Image Location Mapping Manager, or ILMM, system that is generally directed to automated operations for determining acquisition positions of images); in U.S. Non-Provisional patent application Ser. No. 17/150,958, filed Jan. 15, 2021 and entitled “Automated Determination Of Image Acquisition Locations In Building Interiors Using Multiple Data Capture Devices” (which includes disclosure of an example Image Location Determination Manager, or ILDM, system that is generally directed to automated operations for determining room shapes and acquisition positions of images); and in U.S. Provisional Patent Application No. 63/117,372, filed Nov. 23, 2020 and entitled “Automated Determination Of Image Acquisition Locations In Building Interiors Using Determined Room Shapes” (which includes disclosure of an example Mapping Information Generation Manager, or MIGM, system that is generally directed to automated operations for determining acquisition positions of images); each of which is incorporated herein by reference in its entirety. In addition, further details related to examples of a system providing at least some such functionality of a system for using acquired images and/or generated floor plans are included in U.S. Non-Provisional patent application Ser. No. 17/185,793, filed Feb. 25, 2021 and entitled “Automated Usability Assessment Of Buildings Using Visual Data Of Captured In-Room Images” (which includes disclosure of an example Building Usability Assessment Manager, or BUAM, system that is generally directed to automated operations for analyzing visual data from images captured in rooms of a building to assess room layout and other usability information for the building's rooms and optionally for the overall building, and to subsequently using the assessed usability information in one or more further automated manners); which is incorporated herein by reference in its entirety.

In one non-exclusive example, the DBAMIGM PIA component may perform automated operations to determine, for a pair of panorama images (“panoramas”), 1) whether or not the two panoramas see the same wall structure, 2) what visual correspondences exist, 3) the wall structure and wall features (e.g., doors/windows) visible to both panoramas, including a group of pixel columns associated with each identified wall in each panorama image, and 4) the position of one panorama with respect to the coordinate system of the other, such as by jointly estimating these quantities from a single trained neural network in order to improve the performance of each single task through mutually beneficial context, as well as to simplify and speed up the extraction of the necessary information.

As part of the automated operations of this example, the neural network accepts a pair of straightened spherical panoramic images (e.g., captured by a camera device in which the camera axis is aligned with the vertical axis), which may or may not share the same space (i.e., may or may not, share visual overlap)—if the image is straightened (or has a pitch angle and/or roll angle below a defined threshold, such as 5 degrees), and provided walls are also vertically aligned, the wall depth is then a single shared value for a given image column. The neural network then estimates multiple quantities for each column of each image. In other situations, other types of images may be received as input, such as images of different projections with unknown field-of-view (FOV) angle (e.g., perspective images from a pinhole camera), a partial panoramic image with equirectangular image projection or cylindrical image projection, images with RGB pixel data and/or other data channels (e.g., depth, synthetic aperture radar, etc.).

Types of determined building information may include the following:
for each image pixel column in one panorama, the probability that the other panorama includes the image content in the pixel column;
for each image pixel column in one panorama, the line-of-sight angle in the other panorama that includes the same image content (if any, only valid if co-visible)—as one example, in a 512×1024-pixel equirectangular panoramic image, each of the 1024 image columns corresponds to a specific angle (angular band with mean value) in the total 360-degree spherical FOV, and the image angular correspondence information for each image pixel column in one panorama may include zero or one or more image pixel columns in the other panorama;
for each image pixel column in one panorama, the vertical line-of-sight angle from which the floor-wall boundary is visible. With a known camera height, and by intersecting the vertical line-of-sight with the floor plane, this is equivalent to the wall depth in a given image column;
for each image pixel column in a panorama, the probability that a door, window, or wall-wall border junction is visible in the pixel column;
for each wall identified in a panorama image, a group of pixel columns in the panorama image that include visual data of that wall; and
in addition to these column-wise outputs indicated above, two additional quantities may be jointly estimated, including inter-image relative pose (e.g., a 2D translation vector, which may be factored into the product of a unit directional vector and a scale factor, and a 2D orientation (rotation) vector of the second panorama relative to the first); and a segmentation mask of combined visible geometry for both panoramas (e.g., by projecting the floor boundary contours indicated above for each panorama into the floor plane to produce visible floor segmentations from each perspective, which may then be jointly refined to produce a combined visible floor segmentation, from which a room layout polygon can be extracted).
   In addition, regression targets of the PIA component in this (e.g., image correspondence angles, boundary contour angles, and relative pose), may be learned directly using mean-squared error (L2 norm), or mean absolute error (L1 norm) loss functions; however, in addition to the target value (the predicted mean), the trained neural network also predicts a standard deviation, with the predicted mean and standard deviation values then defining a normal probability distribution that in turn induces a negative log-likelihood loss function used to learn the regression targets, and with the learned standard deviation value able to be used as a measure of uncertainty (e.g., to indicate to what extent the network's prediction should be trusted). Further, this loss formulation allows the network to widen the standard deviation for difficult examples, and tighten the standard deviation for easy examples, which adjusts the importance of instance-specific error during training. This error adjusting scheme can provide a better signal to train the model.

As part of the automated operations of the PIA component in this example, each image is passed through the same feature extractor, which applies multiple convolutional layers to extract features at multiple scales, which are then reshaped and concatenated to produce column-wise image features. The resultant features are then considered as two column-wise sequences and input to a transformer module for processing-such extracted features for an image may further be used as part of an image feature embedding vector to represent the image for later inter-image comparison (e.g., as part of a search for one or more other images that have a degree of match to a target image that satisfies a defined threshold), as discussed further below. As transformers process all sequence elements in parallel, without any inherent consideration of order, two embeddings are added to the image column feature sequences, as follows: positional embeddings (e.g., to encode sequence position, such as which image column a given sequence element corresponds to); and segment embeddings (e.g., to encode image membership, such as which image a given sequence element belongs to). The transformer encoder may include multiple blocks, each with a fixed layer structure. After adding the positional and segment embeddings to the column-wise image feature sequences, the sequences are concatenated lengthwise and input to the first of the transformer encoder blocks. In each block, first a multi-headed layer of self-attention is applied. The input sequence is mapped to Queries, Keys, and Values, and the scaled dot product attention, which is a function of the Queries and Keys, is used to create weights for an attention-weighted sum of the Values. In this way, for a given sequence position, the model can assess relevance of information at any other position in the input sequences; both intra and inter-image attention is applied. After the attention layer, a feedforward layer maps the results to the output. After both the attention and feed forward layers, the input sequence is added to the output sequence in the form of a skip connection, which allows information from the input to propagate directly unaffected to the output, and then a normalization is applied to the output to normalize the sample statistics. After the last transformer encoder block, a new sequence is output. From this sequence, either linear or convolutional layers can be used to predict the final column wise outputs, as well as the directly regressed relative pose, from the sequence that is produced by the transformer encoder. For joint estimation of the floor segmentation, first the floor boundary contour segmentations are produced. The floor segmentation of a first of the panoramas of a pair can then be projected based on the estimated pose to align with the other panorama's segmentation. The image features from both panoramas can then undergo a perspective projection to extract features from the floor and/or ceiling view. The first panorama image's image features can then be processed with a learned affine transformation conditioned on the estimated pose. Finally, the floor segmentations and the processed features can be concatenated, and a final joint floor segmentation produced via a block of convolutional layers.

In addition to direct pose regression learning as described above, the angular correspondence, co-visibility, and boundary contour can alternatively be used to derive the relative pose in a subsequent post-processing step. Together these three outputs emit point correspondences in the 2D floor plane, which can be used to optimize for relative pose rotation and translation through singular value decomposition, or through a RANSAC process. First, the process of deriving bi-directional point correspondences from the three column-wise outputs is as follows. For a given image pixel column in each panorama, the x,y coordinates (in the panorama's local coordinate system) of the wall boundary visible in this image column by projecting the boundary position from image coordinates to the floor plane using a known camera height. In combination, all image columns then produce a point cloud in the x,y plane, for each image. Where the predicted co-visibility is high, the predicted angular correspondences can then be used to match points in the point clouds of the two panoramas, resulting in two point clouds each in their local coordinate system, with point correspondences/matches between them. For each point, the trained neural network will generate an uncertainty score, which conveys the network's confidence in the prediction. The rotation and translation can then be directly solved for, using singular value decomposition-based rigid registration, or can be used in a RANSAC routine. In singular value decomposition-based rigid registration, the uncertainty score can be used to weight the corresponding points. In other words, different points will have different importance in deriving the relative pose. In the iterative RANSAC process, at each iteration, two point pairs are randomly selected according to a probability. This probability is determined by the uncertainty scores of these two points. The points with low uncertainty score will have a high probability to be selected. From these two point correspondences a candidate rotation and translation can be derived. Once this R,t is applied to align the two panoramas' point clouds, a proximity-based point matching can be determined, and from this matching, the number of inliers and outliers can be determined to assess the pose goodness-of-fit. After multiple iterations, the matching from the candidate pose that resulted in the highest number of inliers can be used to do a final refinement to get the final RANSAC-based pose. Thus, three ways to extract relative pose are possible, as follows: direct pose regression as a model output; singular value decomposition (SVD)-based pose regression from point correspondences; and RANSAC-based pose regression from point correspondences.

Using joint prediction from a pair of images provides benefits with respect to attempts to do predictions from a single image, such as that occlusion and relative viewing position between camera and wall features in a single image may cause some wall features to have little-or-no field of view coverage from the single image, and are thus difficult to detect. Instead, by using image angular correspondence model output, column-wise matching between the panoramas of a pair exists, and based on the order of columns in one panorama, the column-wise feature corresponding to each image column in the other panorama can be resampled and reordered. After the column reorder, the re-shuffled features from one panorama will represent the similar image content as the other panorama at each column position, and the original column-wise feature from one panorama can be concatenated with reshuffled column-wise features of the other panorama at a per column level. A convolution layer and max pooling layer can then be used to eventually classify the types of each image column at one panorama (e.g., border, window, doorway, non-doorway wall opening, etc.) or to regress the per-column image depth at the one panorama, so as to fuse the information from 2 views together using image content from one panorama to enhance the prediction in the other panorama.

When run pairwise on all target panoramas for a building, the co-visibility output can be used to cluster groups of panoramas as follows: for each pair, the resultant co-visibility can be aggregated into a score by taking the mean co-visible FOV fraction over the two images. This score then summarizes whether or not two panoramas share the same space, as well as the extent of the visual overlap. This pairwise information may then be used to aggregate panoramas into a connected component based on visual connectivity, e.g., if a given panorama has a co-visibility score greater than some threshold with any other panorama in an existing cluster, this panorama is then added into the cluster. By growing clusters in this way, connected component pose graphs are formed, with relative poses defined along edges between pairs of panoramas. Within each of these clusters, global coordinate systems can be derived by iteratively combining panoramas together in a greedy fashion based on the relative pose confidence, e.g., from the number of inliers computed on the registered point clouds, or from some learned confidence on the directly estimated pose or per-column wall depth/angular correspondence. As poor quality relative poses may result in poor global coordinates, outlier relative poses may be suppressed using e.g., cycle consistency by applying relative poses sequentially along connected triplets and checking rotational/positional agreement between start and end points. Finally pose graph optimization may be applied to refine the global coordinate system accuracy, using the outlier-suppressed set of relative poses as constraints.

The outputs of the PIA component of this example provide a variety of benefits and may be used in various manners. One example includes estimating the relative pose of one panorama to another, which may be considered to differ from prior approaches that perform image feature point matching in which a pose is conditioned on geometry-in contrast to such prior approaches, the PIA component of the example may produce robust image content matching regardless of the amount of overlapping visual data between two images, as well as produce reliable feature matching for input images with mostly repetitive patterns or with a scarcity of salient features. Such prior approaches (e.g., image salient feature matching) have a higher level of requirement on the amount of similar contents between input images in order to produce robust matching features between two images. In addition, the structural features (e.g., for walls, inter-wall borders, and wall boundaries) predicted from combining visual data from two different acquisition locations may be higher quality compared to similar quantities that are attempted to be estimated with information from a single acquisition location alone. For example, if a first panorama of a pair has a better viewpoint of certain wall structure than the second panorama of the pair, the information provided by this first panorama can improve the quality of the geometry estimated from the second panorama. Thus, the visible wall geometry estimated from both acquisition locations can be combined and refined, either through projection to segmentation maps and processing through a series of convolutional layers, or via a post-processing step to integrate the information from each acquisition location, in order to generate a combined visible geometry, with wall features and layout, which can enable estimation of wall features and layout for larger spaces which may be only partially visible from any single acquisition location.

As one example use of outputs of the PIA component, co-visibility data and/or image angular correspondence data can be used for guiding the acquisition of images (e.g., for use in generation of mapping information such as floor plans and/or virtual tours of linked images), such as to ensure that newly acquired images are visually overlapping with previously acquired images, to provide good transitions for generation of mapping information. For example, an ICA system and/or other image acquisition system can suggest missing connectivity between a newly captured image and existing images, or reject the newly acquired image. Furthermore, image angular correspondence data and inter-image pose data can determine an acquisition location of each image (e.g., within a surrounding structural layout) once a newly acquired image is obtained, and an image acquisition system can suggest one or more new acquisition locations at which to acquire one or more additional images that will improve the co-visibility among images. Thus, as a user acquires each new image, the PIA component may determine co-visibility data and/or image angular correspondence data between the new image (or multiple new images) and the existing images to produce live acquisition feedback (e.g., in a real-time or near-real-time manner). To increase the speed of the image matching process, image embedding extraction and image embedding matching can be decoupled, such as to extract and store image feature embedding features for at least some images (e.g., that can be compared to quickly determine a degree of match between two images based on a degree of match between the two images' image feature embedding vectors), and with the image feature extraction performed only once per image even if the image is used for image matching as part of multiple different image pairs.

Various details have been provided with respect to FIGS. 2A through 2Y, but it will be appreciated that the provided details are non-exclusive examples included for illustrative purposes, and other situations may be performed in other manners without some or all such details.

FIG. 3 is a block diagram illustrating an example of one or more server computing systems 180 executing an implementation of a DBAMIGM system 140 and a BDIE system 145, and one or more server computing systems 380 executing an implementation of an ICA system 389—while not illustrated in FIG. 3, the DBAMIGM system 140 may further include one or more components (e.g., bundle adjustment optimizer component 144 of FIG. 1, diffusion model analyzer component 147 using a trained diffusion model 324, etc.) that each performs some or all of the functionality of the DBAMIGM system, and the BDIE system 145 may further include one or more components (e.g., a PIA component, a trained transformer model 323, etc.) that each performs some or all of the functionality of the BDIE system. The server computing system(s) and the DBAMIGM system (and/or its components) and/or the BDIE system (and/or its components) may be implemented using a plurality of hardware components that form electronic circuits suitable for and configured to, when in combined operation, perform at least some of the techniques described herein. In the illustrated example, each server computing system 180 includes one or more hardware central processing units (“CPU”) or other hardware processors 305, various input/output (“I/O”) components 310, storage 320, and memory 330, with the illustrated I/O components including a display 311, a network connection 312, a computer-readable media drive 313, and other I/O devices 315 (e.g., keyboards, mice or other pointing devices, microphones, speakers, GPS receivers, etc.). Each server computing system 380 may include hardware components similar to those of a server computing system 180, including one or more hardware CPU processors 381, various I/O components 382, storage 385 and memory 387, but with some of the details of server 180 being omitted in server 380 for the sake of brevity.

The server computing system(s) 180 and executing DBAMIGM system 140 and/or executing BDIE system 145 may communicate with other computing systems and devices via one or more networks 170 (e.g., the Internet, one or more cellular telephone networks, etc.), such as user client computing devices 105, 175 (e.g., used to view floor plans, associated images and/or other related information), ICA server computing system(s) 380, one or more mobile computing devices 185 and optionally one or more camera devices 184 (e.g., for use as image acquisition devices), optionally other navigable devices 395 that receive and use floor plans and optionally other generated information for navigation purposes (e.g., for use by semi-autonomous or fully autonomous vehicles or other devices), and optionally other computing systems that are not shown (e.g., used to store and provide additional information related to buildings; used to acquire building interior data; used to store and provide information to client computing devices, such as additional supplemental information associated with images and their encompassing buildings or other surrounding environment; etc.). In some situations, some or all of the one or more camera devices 184 may directly communicate (e.g., wirelessly and/or via a cable or other physical connection, and optionally in a peer-to-peer manner) with one or more associated mobile computing devices 185 in their vicinity (e.g., to transmit acquired target images, to receive instructions to initiate a target image acquisition, etc.), whether in addition to or instead of performing communications via network 170, and with such associated mobile computing devices 185 able to provide acquired target images and optionally other acquired data that is received from one or more camera devices 184 over the network 170 to other computing systems and devices (e.g., server computing systems 380 and/or 180).

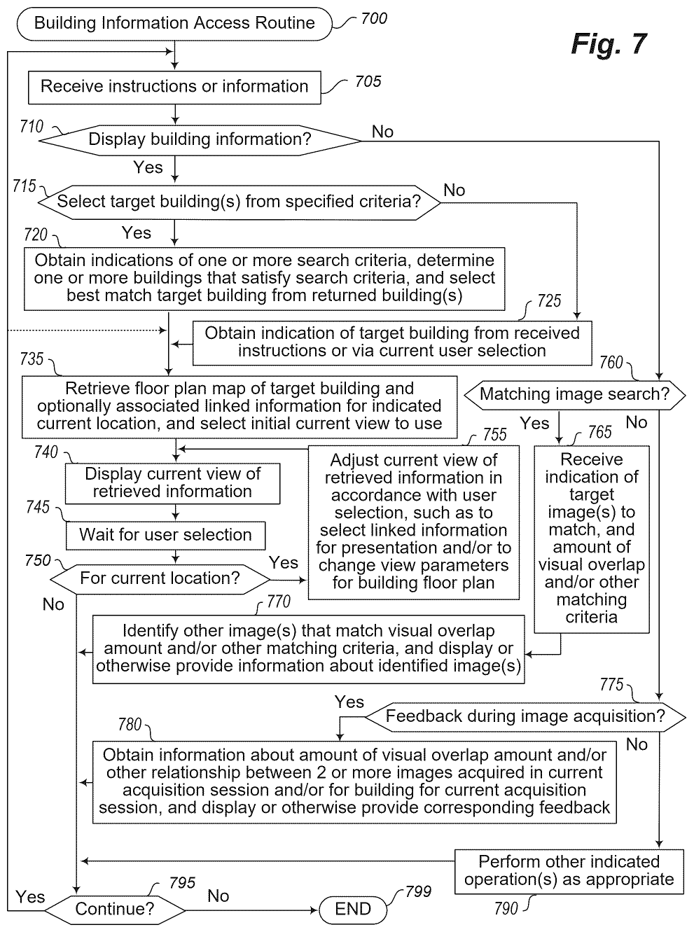

In the illustrated example, examples of the DBAMIGM system 140 and BDIE system 145 execute in memory 330 in order to perform at least some of the described techniques, such as by using the processor(s) 305 to execute software instructions of the systems 140 and/or 145 in a manner that configures the processor(s) 305 and computing system(s) 180 to perform automated operations that implement those described techniques. The illustrated example of the DBAMIGM system may include one or more components (not shown) to each perform portions of the functionality of the DBAMIGM system, the illustrated example of the BDIE system may include one or more components (not shown) to each perform portions of the functionality of the BDIE system, and the memory may further optionally execute one or more other programs 335—as one example, one of the other programs 335 may include an executing copy of the ICA system in at least some situations (such as instead of or in addition to the ICA system 389 executing in memory 387 on the server computing system(s) 380) and/or may include an executing copy of a system for accessing building information (e.g., as discussed with respect to client computing devices 175 and the routine of FIG. 7). The DBAMIGM system 140 and/or BDIE system 145 may further, during their operation, store and/or retrieve various types of data on storage 320 (e.g., in one or more databases or other data structures), such as information 165 about target panorama images (e.g., acquired by one or more camera devices 184 and/or mobile devices 185), information 141 about multiple types of determined building information from the target panorama images (e.g., locations of walls and other structural elements, locations of structural wall elements, image acquisition pose information, co-visibility information, image angular correspondence information, per-wall image pixel column groups for individual images and matching data across multiple images for the same wall, etc.), information 143b about globally aligned image acquisition location information (e.g., global inter-image pose information), various types of floor plan information and other building mapping information 143a (e.g., generated and saved 2D floor plans with polygonal 2D room shapes and positions of wall elements and other elements on those floor plans and optionally additional information such as building and room dimensions for use with associated floor plans, existing images with specified positions, annotation information, etc.; generated and saved 2.5D and/or 3D model floor plans that are similar to the 2D floor plans but further include height information and 3D room shapes; etc.), optionally other types of results information 327 from the DBAMIGM and/or BDIE systems (e.g., matching images with respect to one or more indicated target images, feedback during an image acquisition session with respect to one or more indicated target images acquired during the image acquisition session, etc.), optionally user information 328 about users of client computing devices 105, 175 and/or operator users of mobile devices 185 who interact with the DBAMIGM and/or BDIE systems, optionally additional information 329 (e.g., training data for use with one or more neural networks used by the DBAMIGM and/or BDIE systems, and/or the resulting trained neural network(s), and optionally various other types of additional information). In addition, in at least some situations, the BDIE system 145 may obtain and use at least some of the training data 326 to train the transformer model 323 before it is used, as discussed in greater detail elsewhere herein. Similarly, in at least some situations, the DBAMIGM system 140 may obtain and use at least some of the training data 326 to train the diffusion model 324 before it is used, although in other situations a pretrained diffusion model 324 (e.g., a diffusion model trained for general use; a diffusion model trained in a manner specific to buildings and/or real estate; etc.) may be obtained and used without further training, as discussed in greater detail elsewhere herein. The ICA system 389 may similarly store and/or retrieve various types of data on storage 385 (e.g., in one or more databases or other data structures) during its operation and provide some or all such information to the DBAMIGM system 140 for its use (whether in a push and/or pull manner), such as images 165 (e.g., 360° target panorama images acquired by one or more camera devices 184 and/or image acquisition devices 185 and transferred to the server computing systems 380), and optionally various types of additional information (e.g., various analytical information related to presentation or other use of one or more building interiors or other environments acquired by an ICA system, not shown).

Some or all of the user client computing devices 105, 175 (e.g., mobile devices), mobile computing devices 185, camera devices 184, other navigable devices 395 and other computing systems may similarly include some or all of the same types of components illustrated for server computing systems 180 and 380. As one non-limiting example, the mobile computing devices 185 are each shown to include one or more hardware CPU(s) 361, I/O components 362, storage 365, imaging system 364, IMU hardware sensors 369, optionally depth sensors (not shown), and memory 367, with one or both of a browser and one or more client applications 368 (e.g., an application specific to the DBAMIGM system and/or BDIE system and/or ICA system) optionally executing within memory 367, such as to participate in communication with one or more of the DBAMIGM system 140, BDIE system 145, ICA system 389, associated camera devices 184 and/or other computing systems. While particular components are not illustrated for the other navigable devices 395 or client computing systems 105, 175, it will be appreciated they may include similar and/or additional components.

It will also be appreciated that computing systems 180 and 380 and devices 184 and 185 and the other systems and devices included within FIG. 3 are merely illustrative and are not intended to limit the scope of the present invention. The systems and/or devices may instead each include multiple interacting computing systems or devices, and may be connected to other devices that are not specifically illustrated, including via Bluetooth communication or other direct communication, through one or more networks such as the Internet, via the Web, or via one or more private networks (e.g., mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, wearable devices, digital music player devices, handheld gaming devices, PDAs, wireless phones, Internet appliances, camera devices and accessories, and various other consumer products that include appropriate communication capabilities. In addition, the functionality provided by the illustrated DBAMIGM system 140 may in some situations be distributed in various components, some of the described functionality of the DBAMIGM system 140 may not be provided, and/or other additional functionality may be provided.

It will also be appreciated that, while various items are illustrated as being stored in memory or on storage while being used, these items or portions of them may be transferred between memory and other storage devices for purposes of memory management and data integrity. Alternatively, in other situations some or all of the software components and/or systems may execute in memory on another device and communicate with the illustrated computing systems via inter-computer communication. Thus, in some situations, some or all of the described techniques may be performed by hardware means that include one or more processors and/or memory and/or storage when configured by one or more software programs (e.g., by the DBAMIGM system 140 and/or the BDIE system 145 executing on server computing systems 180) and/or data structures, such as by execution of software instructions of the one or more software programs and/or by storage of such software instructions and/or data structures, and such as to perform algorithms as described in the flow charts and other disclosure herein. Furthermore, in some situations, some or all of the systems and/or components may be implemented or provided in other manners, such as by consisting of one or more means that are implemented partially or fully in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the components, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, components and data structures may also in some situations be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other situations. Accordingly, examples of the present disclosure may be practiced with other computer system configurations.

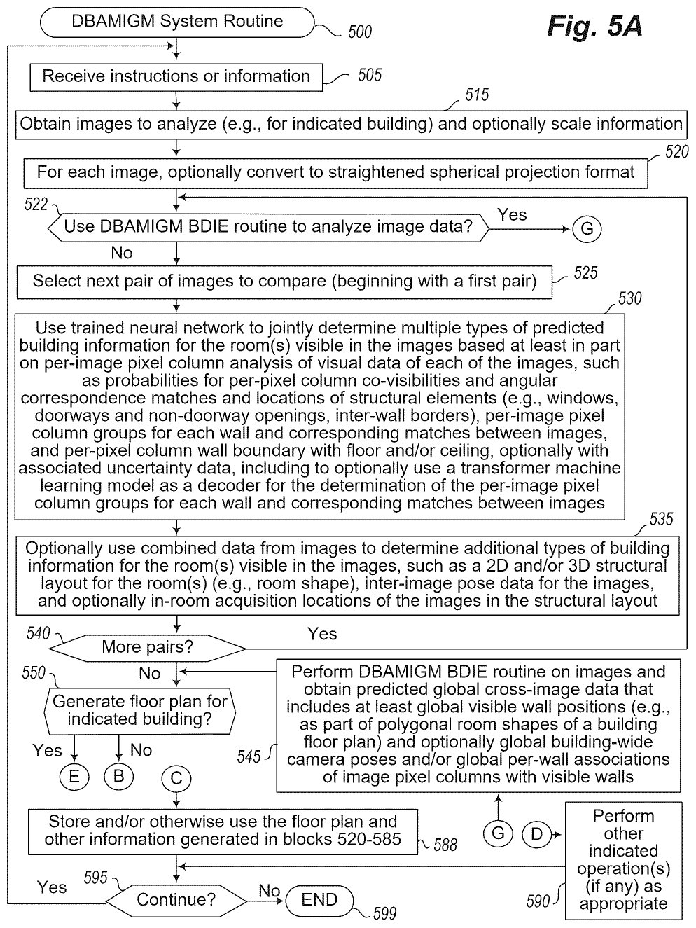

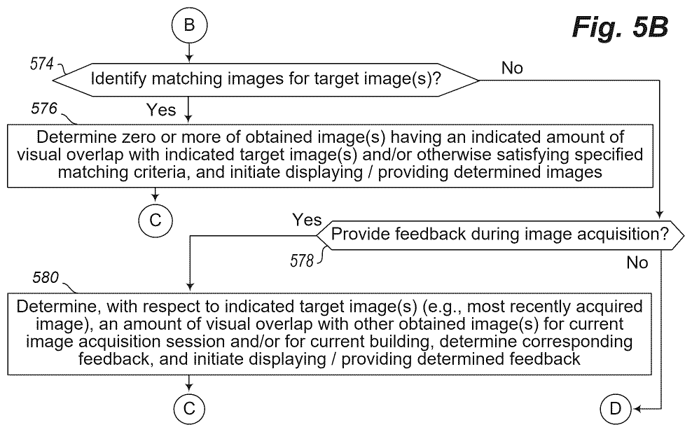

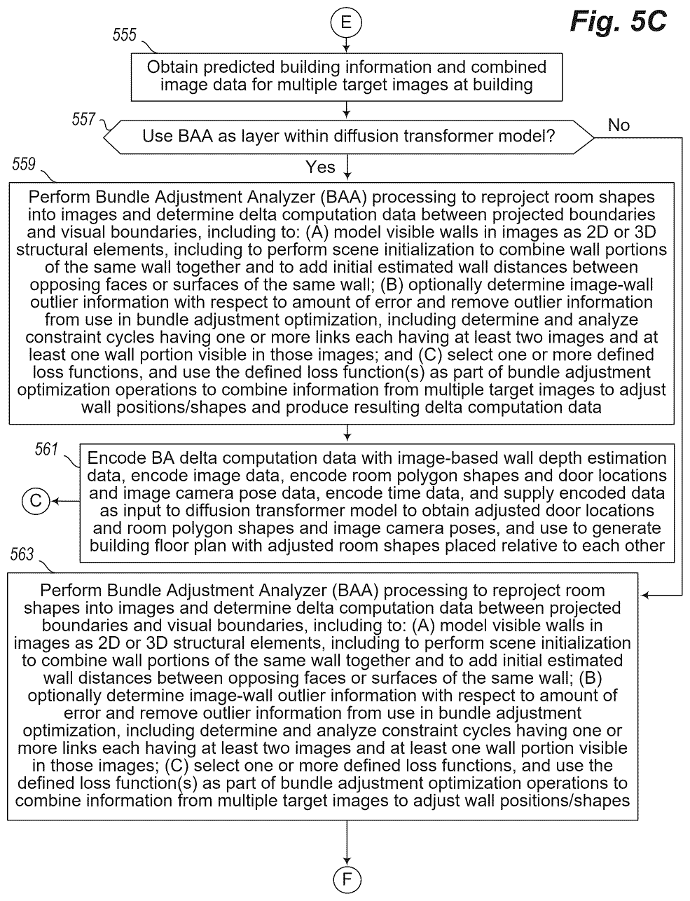

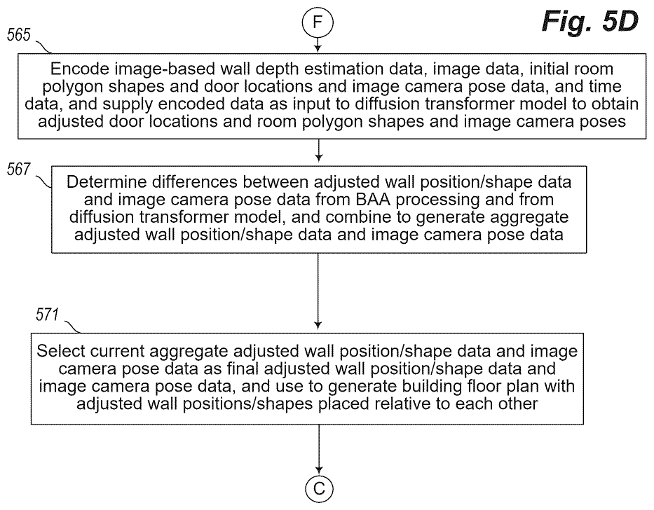

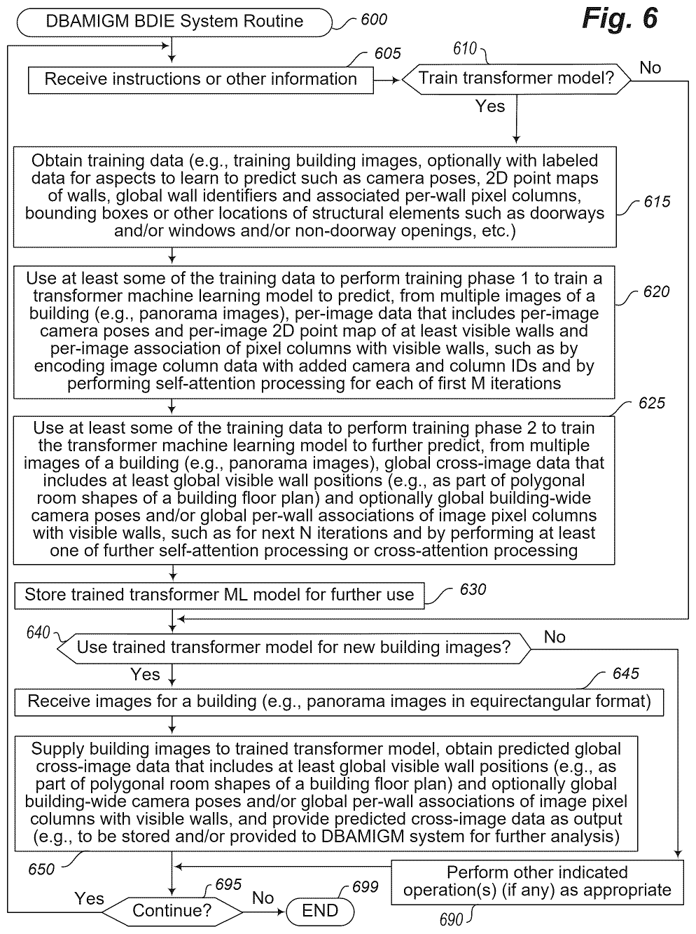

FIG. 4 illustrates an example flow diagram of an ICA System routine 400. The routine may be performed by, for example, the ICA system 160 of FIG. 1, the ICA system 389 of FIG. 3, and/or an ICA system as otherwise described herein, such as to provide a computer-implemented method to acquire 360° target panorama images and/or other images within buildings or other structures (e.g., for use in subsequent generation of related floor plans and/or other mapping information, such as by example DBAMIGM and/or BDIE system routines, with one example of such a DBAMIGM system routine illustrated with respect to FIGS. 5A-5D and one example of such a BDIE system routine illustrated with respect to FIG. 6; for use in subsequent determination of acquisition locations and optionally acquisition orientations of the target images; etc.). While portions of the example routine 400 are discussed with respect to acquiring particular types of images at particular locations, it will be appreciated that this or a similar routine may be used to acquire video or other data (e.g., audio) and/or other types of images that are not panoramic, whether instead of or in addition to such panorama images. In addition, while the illustrated example routine acquires and uses information from the interior of a target building, it will be appreciated that other examples may perform similar techniques for other types of data, including for non-building structures and/or for information external to one or more target buildings of interest. Furthermore, some or all of the routine may be executed on a mobile device used by a user to participate in acquiring image information and/or related additional data, and/or by a system remote from such a mobile device.

The illustrated example of the routine begins at block 405, where instructions or information are received. At block 410, the routine determines whether the received instructions or information indicate to acquire data representing a building (e.g., in the building interior), and if not continues to block 490. Otherwise, the routine proceeds to block 412 to receive an indication (e.g., from a user of a mobile computing device associated with one or more camera devices) to begin the image acquisition process at a first acquisition location. After block 412, the routine proceeds to block 415 in order to perform acquisition location image acquisition activities in order to acquire at least one 360° panorama image by at least one image acquisition device (and optionally one or more additional images and/or other additional data by a mobile computing device, such as from IMU sensors and/or depth sensors) for the acquisition location at the target building of interest, such as to provide horizontal coverage of at least 360° around a vertical axis. The routine may also optionally obtain annotation and/or other information from a user regarding the acquisition location and/or the surrounding environment, such as for later use in presentation of information regarding that acquisition location and/or surrounding environment. After block 415 is completed, the routine continues to block 417 to optionally initiate obtaining and providing feedback (e.g., to one or more users participating in the current image acquisition session) during the image acquisition session about one or more indicated target images (e.g., the image just acquired in block 415), such as by interacting with the MIGM system to obtain such feedback.

After block 417, the routine continues to block 420 to determine if there are more acquisition locations at which to acquire images, such as based on corresponding information provided by the user of the mobile computing device and/or to satisfy specified criteria (e.g., at least a specified quantity of panorama images to be acquired in each of some or all rooms of the target building and/or in each of one or more areas external to the target building). If so, the routine continues to block 422 to optionally initiate the acquisition of linking information (such as visual data, acceleration data from one or more IMU sensors, etc.) during movement of the mobile device along a travel path away from the current acquisition location and towards a next acquisition location for the building. As described elsewhere herein, the acquired linking information may include additional sensor data (e.g., from one or more IMU, or inertial measurement units, on the mobile computing device or otherwise carried by the user) and/or additional visual information (e.g., panorama images, other types of images, panoramic or non-panoramic video, etc.) recorded during such movement, and in some situations may be analyzed to determine a changing pose (location and orientation) of the mobile computing device during the movement, as well as information about a room shape of the enclosing room (or other area) and the path of the mobile computing device during the movement. Initiating the acquisition of such linking information may be performed in response to an explicit indication from a user of the mobile computing device or based on one or more automated analyses of information recorded from the mobile computing device. In addition, the routine in some situations may further optionally determine and provide one or more guidance cues to the user regarding the motion of the mobile device, quality of the sensor data and/or visual information being acquired during movement to the next acquisition location (e.g., by monitoring the movement of the mobile device), including information about associated lighting/environmental conditions, advisability of acquiring a next acquisition location, and any other suitable aspects of acquiring the linking information. Similarly, the routine may optionally obtain annotation and/or other information from the user regarding the travel path, such as for later use in presentation of information regarding that travel path or a resulting inter-panorama image connection link. In block 424, the routine then determines that the mobile computing device (and one or more associated camera devices) arrived at the next acquisition location (e.g., based on an indication from the user, based on the forward movement of the user stopping for at least a predefined amount of time, etc.), for use as the new current acquisition location, and returns to block 415 in order to perform the image acquisition activities for the new current acquisition location.

If it is instead determined in block 420 that there are not any more acquisition locations at which to acquire image information for the current building or other structure (or for the current image acquisition session), the routine proceeds to block 430 to optionally analyze the acquisition position information for the building or other structure, such as to identify possible additional coverage (and/or other information) to acquire within the building interior or otherwise associated with the building. For example, the ICA system may provide one or more notifications to the user regarding the information acquired during acquisition of the multiple acquisition locations and optionally corresponding linking information, such as if it determines that one or more segments of the recorded information are of insufficient or undesirable quality, or do not appear to provide complete coverage of the building. In addition, in at least some situations, if minimum criteria for images (e.g., a minimum quantity and/or type of images) have not been satisfied by the acquired images (e.g., at least two panorama images in each room, at most one panorama image in each room, panorama images within a maximum and/or minimum specified distance of each other, etc.), the ICA system may prompt or direct the acquisition of additional panorama images to satisfy such criteria. After block 430, the routine continues to block 435 to optionally preprocess the acquired 360° target panorama images before subsequent use for generating related mapping information (e.g., to place them in a straightened equirectangular format, to determine vanishing lines and vanishing points, etc.). In block 480, the images and any associated generated or obtained information is stored for later use.

If it is instead determined in block 410 that the instructions or other information recited in block 405 are not to acquire images and other data representing a building, the routine continues instead to block 490 to perform any other indicated operations as appropriate, such as any housekeeping tasks, to configure parameters to be used in various operations of the system (e.g., based at least in part on information specified by a user of the system, such as a user of a mobile device who acquires one or more building interiors, an operator user of the ICA system, etc.), to obtain and store other information about users of the system, to respond to requests for generated and stored information, etc.

Following blocks 480 or 490, the routine proceeds to block 495 to determine whether to continue, such as until an explicit indication to terminate is received, or instead only if an explicit indication to continue is received. If it is determined to continue, the routine returns to block 405 to await additional instructions or information, and if not proceeds to step 499 and ends.

FIGS. 5A-5D illustrate an example flow diagram for a Diffusion-Bundle Adjustment Mapping Information Generation Manager (DBAMIGM) System routine 500. The routine may be performed by, for example, execution of the DBAMIGM system 140 of FIGS. 1 and 3, the DBAMIGM system discussed with respect to FIGS. 2E through 2Y, and/or a DBAMIGM system as described elsewhere herein, such as to provide a computer-implemented method to generate a floor plan and/or other mapping information for a building or other defined area based at least in part on visual data of images of the area and optionally additional data acquired by an image acquisition device, such as by using a combination of a diffusion transformer machine learning model and a bundle adjustment optimizer that determines global inter-image pose and wall location data and that generates a resulting floor plan for the building. In the example of FIGS. 5A-5D, the generated mapping information for a building (e.g., a house) includes a 2D floor plan and/or 3D computer model floor plan, but in other examples, other types of mapping information may be generated and used in other manners, including for other types of structures and defined areas, as discussed elsewhere herein.

The illustrated example of the routine begins at block 505, where information or instructions are received. The routine continues to block 515 to obtain target images for a building (e.g., to retrieve stored target images that were previously acquired and associated with an indicated building; to use target images supplied in block 505; to concurrently acquire such information, with FIG. 4 providing one example of an ICA system routine for performing such image acquisition, including optionally waiting for one or more users or devices to move throughout one or more rooms of the building and acquire panoramas or other images at acquisition locations in building rooms and optionally other building areas, and optionally along with metadata information regarding the acquisition and/or interconnection information related to movement between acquisition locations, as discussed in greater detail elsewhere herein; etc.).

After block 515, the routine continues to block 520, where for each of the target images, the image is converted to a straightened projection format if not already in such a format (e.g., a straightened spherical projection format for a panorama image, a straightened spherical or rectilinear form for a non-panoramic image, etc.). In block 422, the routine then determines whether to use the BDIE system routine to perform an initial analysis of visual data of the target images, and if so proceeds to block 545, and otherwise proceeds to perform blocks 525-540. In block 545, the routine performs the BDIE system routine on the target images to obtain predicted global cross-image data that includes at least global visible wall positions (e.g., as part of polygonal room shapes of a building floor plan) and optionally global building-wide camera poses and/or global per-wall associations of image pixel columns with visible walls, with one example of such a BDIE routine illustrated in FIG. 6. Otherwise, in block 525, the routine then selects a next pair of the target images (beginning with a first pair), and then proceeds to block 530 to use a trained neural network to jointly determined multiple types of predicted building information for the room(s) visible in the images of the pair based at least in part on a per-image pixel column analysis of visual data of each of the images, such as probabilities for per-pixel column co-visibilities and angular correspondence matches and locations of structural elements (e.g., windows, doorways and non-doorway openings, inter-wall borders), per-pixel column wall boundary with floor and/or ceiling, and per-image pixel column groups associated with walls visible in the image (e.g., in aggregate across the multiple images, all walls of the building) along with matching pixel column groups for some or all such walls across multiple images, optionally with associated uncertainty information. In block 535, the routine then optionally uses a combination of data from the images of the pair to determine additional types of building information for the room(s) visible in the images, such as a 2D and/or 3D structural layout for the room(s), inter-image pose information for the images, and optionally in-room acquisition locations of the images within the structural layout. After block 535, the routine in block 540 proceeds to determine if there are more pairs of images to compare, and if so returns to block 525 to select a next pair of images. As discussed in greater detail elsewhere herein, some or all of the blocks 530 and 535 may in some situations be performed by a PIA component.

If it is instead determined in block 540 that there are not more pairs of images to compare, or after block 545, the routine continues to block 550 where it determines whether to further use the determined types of building information from blocks 545 or 530-535 as part of further generating a floor plan for the building, such as based on the instructions or other information received in block 505, and if not continues to block 574. Otherwise, the routine continues to perform blocks 555-571 to use a combination of a diffusion transformer machine learning model with bundle adjustment optimization based on one or more defined loss functions to reproject room shapes into images and determine delta computations between projected boundaries and visual boundaries, and to further combine information from the multiple image pairs to generate a global alignment of the acquisition locations of some or all of the target images and to use that information to generate a building floor plan for the building. In particular, in block 555, the routine obtains predicted building information and combined image data for multiple target images, such as from block 545 or blocks 530 and 535. As discussed in greater detail elsewhere herein, some or all of the subsequent blocks 557-571 may in some situations be performed by a combination of the bundle adjustment optimizer component of the DBAMIGM system and the diffusion transformer machine learning model of the DBAMIGM system, such as corresponding to situations discussed with respect to FIGS. 2F-2I and elsewhere herein, and such as by using information generated in block 545 or blocks 530 and 535.

In particular, the routine in block 557 then determines whether to perform bundle adjustment optimization operations as a layer within the diffusion transformer machine learning model (e.g., as discussed with respect to the examples of FIGS. 2G-2I and elsewhere herein), such as based in part or in whole on a current example of the DBAMIGM system in use, and if so proceeds to perform blocks 559-561 to use the bundle adjustment optimization as a layer within the diffusion transformer machine learning model, and if not proceeds to perform blocks 563-571 to use the diffusion transformer machine learning model functionality and bundle adjustment optimization independently (e.g., in parallel)-it will be appreciated that other versions of the routine may perform only one of blocks 559-561 or blocks 563-571 to correspond to only one of the respective situations.

If it is determined in block 557 to perform bundle adjustment optimization operations as a layer within the diffusion transformer machine learning model, the routine continues to block 559 to perform Bundle Adjustment Analyzer (BAA) processing to reproject room shapes into images and determine delta computations between projected boundaries and visual boundaries, including to perform several operations as follows: (A) model the visible walls and optionally other structural elements in the images as 2D or 3D structural elements (if not already done in the obtained information and data), including to perform scene initialization to combine wall portions of the same wall together and to add initial estimated wall distances between opposing faces or surfaces of the same wall; (B) optionally determine and remove outlier information from use in the subsequent bundle adjustment optimization operations, with the outliers based on amount of error in image-wall information, and the determination of outliers including determining and analyzing constraint cycles each having one or more links that each includes at least two images and at least one wall portion visible in those images; and (C) select one or more of multiple defined loss functions, and use the defined loss functions and the information remaining after the optional removal of outlier information as part of bundle adjustment optimization operations to combine information from the multiple target images to adjust wall positions and/or shapes, and optionally wall thicknesses, as part of generating and/or adjusting wall connections to produce a building floor plan, including to generate global inter-image poses and to combine structural layouts as well as optionally generating additional related mapping information, as well as to produce resulting delta computation data for use as input to the diffusion transformer machine learning model-additional details related to such processing are included elsewhere herein, including with respect to the bundle adjustment optimization operations discussed with respect to FIG. 2J. After block 559, the routine continues to block 561 to encode delta computation data from the bundle adjustment optimization operations performed in block 559 together with image-based wall depth estimation data, to encode image data, to encode room polygon shapes and door locations and image camera pose data, to encode time data, and to supply the various encoded data as input to the diffusion transformer machine learning model to obtain adjusted door locations and room polygon shapes and image camera poses, and to use resulting data generate building floor plan with adjusted room shapes placed relative to each other. Additional details related to such processing of blocks 559-561 are included elsewhere herein, including with respect to the DBAMIGM system examples discussed with respect to FIGS. 2G-2I.

If it is determined in block 557 to not perform bundle adjustment optimization as a layer within the diffusion transformer machine learning model and to instead use the diffusion transformer machine learning model functionality and bundle adjustment optimization independently (e.g., in parallel), the routine continues instead to block 563 to perform Bundle Adjustment Analyzer (BAA) processing to reproject room shapes into images and determine delta computations between projected boundaries and visual boundaries in a manner similar to that discussed with respect to block 559, including to perform several operations as follows: (A) model the visible walls and optionally other structural elements in the images as 2D or 3D structural elements (if not already done in the obtained information and data), including to perform scene initialization to combine wall portions of the same wall together and to add initial estimated wall distances between opposing faces or surfaces of the same wall; (B) optionally determine and remove outlier information from use in the subsequent bundle adjustment optimization operations, with the outliers based on amount of error in image-wall information, and the determination of outliers including determining and analyzing constraint cycles each having one or more links that each includes at least two images and at least one wall portion visible in those images; and (C) select one or more of multiple defined loss functions, and use the defined loss functions and the information remaining after the optional removal of outlier information as part of bundle adjustment optimization operations to combine information from the multiple target images to adjust wall positions and/or shapes, and optionally wall thicknesses, as part of generating and/or adjusting wall connections to produce a building floor plan, including to generate global inter-image poses and to combine structural layouts as well as optionally generating additional related mapping information-additional details related to such processing are included elsewhere herein, including with respect to the bundle adjustment optimization operations discussed with respect to FIG. 2J. After block 563 (or in parallel with block 563), the routine in block 565 encodes image-based wall depth estimation data, image data, initial room polygon shapes and door locations and image camera pose data, and time data, and supplies the encoded data as input to the diffusion transformer machine learning model to obtain adjusted door locations and room polygon shapes and image camera poses. After blocks 563 and 565, the routine in block 567 combines and compares the adjusted door locations and room polygon shapes and image camera poses from the bundle adjustment optimization operations of block 563 and the diffusion transformer machine learning model operations of block 565, including to determine differences between adjusted wall position/shape data and image camera pose data from blocks 563 and 565, and to combine the adjusted wall position/shape data and image camera pose data to generate aggregate adjusted wall position/shape data and image camera pose data. The routine then continues to block 571 to select the current aggregate adjusted wall position/shape data and image camera pose data from block 576 as final adjusted wall position/shape data and image camera pose data, and to use that final data to generate a building floor plan with adjusted wall positions/shapes placed relative to each other. Additional details related to such processing of blocks 563-571 are included elsewhere herein, including with respect to the DBAMIGM system example(s) discussed with respect to FIG. 2F.

If it is instead determined in block 550 not to use the determined types of building information from block 545 or blocks 530-535 as part of generating a floor plan for the building, the routine continues to block 574 to determine whether to use the determined types of building information from block 545 or blocks 530-535 as part of identifying one or more matching images (if any) for one or more indicated target images, such as based on the instructions or other information received in block 505. If so, the routine continues to block 576 to, with respect to the one or more indicated target images (e.g., as indicated in block 505 or identified in block 576 via one or more current user interactions), use information from analysis of pairs of images that each includes one of the indicated target images and another of the target images from block 545 or blocks 530-535 to determine other of the target images (if any) that match the indicated target image(s) (e.g., that have an indicated amount of visual overlap with the indicated target image(s) and/or that satisfy other specified matching criteria, as discussed in greater detail elsewhere herein), and displays or otherwise provides determined other target images (e.g., provides them to routine 700 of FIG. 7 for display, such as in response to a corresponding request from the routine 700 received in block 505 that indicates the one or more target images and optionally some or all of the other target images to analyze and optionally some or all of the matching criteria). If it is instead determined in block 574 not to use the determined types of building information from block 545 or blocks 530-535 as part of identifying one or more matching images (if any) for one or more indicated target images, the routine continues to block 578 to determine whether to use the determined types of building information from block 545 or blocks 530-535 as part of determining and providing feedback corresponding to one or more indicated target images, such as based on the instructions or other information received in block 505. If not, the routine continues to block 590, and otherwise continues to block 580 to, with respect to the one or more indicated target images (e.g., as indicated in block 505 or identified in block 580 via one or more current user interactions), use information from analysis of visual data of images that each includes one of the indicated target images to determine the feedback to provide (e.g., based on an indicated amount of visual overlap with the indicated target image(s) and/or that correspond to other specified feedback criteria, as discussed in greater detail elsewhere herein), and displays or otherwise provides the determined feedback (e.g., provides them to routine 700 of FIG. 7 for display, such as in response to a corresponding request from the routine 700 received in block 505 that indicates the one or more target images and optionally some or all of the other target images to analyze and optionally some or all of the feedback criteria).

After blocks 561 or 571 or 576 or 580, the routine continues to block 588 to store the generated mapping information and/or other generated or determined information, and to optionally further use some or all of the determined and generated information, such as to provide the generated 2D floor plan and/or 3D computer model floor plan and/or other generated or determined information for display on one or more client devices and/or to one or more other devices for use in automating navigation of those devices and/or associated vehicles or other entities, to provide and use information about determined room layouts/shapes and/or a linked set of panorama images and/or about additional information determined about contents of rooms and/or passages between rooms, etc.

In block 590, the routine continues instead to perform one or more other indicated operations as appropriate. Such other operations may include, for example, receiving and responding to requests for previously generated floor plans and/or previously determined room layouts/shapes and/or other generated information (e.g., requests for such information for display on one or more client devices, requests for such information to provide it to one or more other devices for use in automated navigation, etc.), obtaining and storing information about buildings for use in later operations (e.g., information about dimensions, numbers or types of rooms, total square footage, adjacent or nearby other buildings, adjacent or nearby vegetation, exterior images, etc.), obtaining and storing information about users for use in later operations, receiving and storing training data for use in training the diffusion model, performing training operations for the diffusion model, etc.

After blocks 588 or 590, the routine continues to block 595 to determine whether to continue, such as until an explicit indication to terminate is received, or instead only if an explicit indication to continue is received. If it is determined to continue, the routine returns to block 505 to wait for and receive additional instructions or information, and otherwise continues to block 599 and ends.

While not illustrated with respect to the automated operations shown in the example of FIGS. 5A-5D, in some situations human users may further assist in facilitating some of the operations of the DBAMIGM system, such as for operator users and/or end users to provide input of one or more types that is further used in subsequent automated operations.

FIG. 6 illustrates an example flow diagram for a DBAMIGM Building Data Input Encoder (BDIE) system routine 600. The routine may be performed by, for example, execution of the BDIE system 145 of FIGS. 1 and 3, the BDIE system discussed with respect to FIGS. 2E through 2Y, and/or a BDIE system as described elsewhere herein, such as to provide a computer-implemented method to, for a group of images captured for a building, perform an initial analysis of the visual data of those images to determine initial rough estimates of building wall position data and building image camera poses, such as by using a trained transformer machine learning model, and such as for use as input to the diffusion model and/or bundle adjustment optimizer model of the DBAMIGM system. In the example of FIG. 6, the determined information for a building (e.g., a house) may in some situations include an initial 2D floor plan and/or 3D computer model floor plan with 2D or 3D polygonal room shapes, respectively, but in other situations, other types of mapping information may be generated and used in other manners, including for other types of structures and defined areas, as discussed elsewhere herein.

The illustrated example of the routine 600 begins at block 605, where instructions or other information is received. The routine continues to block 610 to determine whether the instructions or other information indicate to train a transformer model for use in analyzing visual data of images of a building to determine initial rough estimates of building wall position data and building image camera poses, and if so proceeds to perform blocks 615-630, and otherwise continues to block 640. In block 615, the routine obtains training data to use (e.g., training building images and optionally associated output data such as camera poses, 2D point maps of walls, global wall identifiers and associated per-wall pixel columns, bounding boxes or other locations of structural elements such as doorways and/or windows and/or non-doorway openings, etc.). In block 620, the routine then uses at least some of the training data to perform a first training phase to train the transformer machine learning model to predict, from multiple images of a building (e.g., panorama images), per-image data that includes per-image camera poses and per-image 2D point maps of at least visible walls and per-image associations of pixel columns with visible walls, such as by encoding image column data with added camera and column IDs and by performing self-attention processing for each of a first M iterations. In block 625, the routine then uses at least some of the training data to perform a second training phase to further train the transformer machine learning model to predict, from multiple images of a building (e.g., panorama images), global cross-image data that includes at least global visible wall positions in a single common coordinate system (e.g., as part of polygonal room shapes of a building floor plan) and global building-wide camera poses in a single coordinate system, and optionally global per-wall associations of image pixel columns with visible walls, such as for a next N iterations and by performing at least one of further self-attention processing or cross-attention processing. After block 625, the routine continues to block 630, and stores the trained transformer machine learning model for further use.

After block 630, or if it is instead determined in block 610 that the instructions or other information received in block 605 are not to train the transformer model, the routine continues to block 640 to determine if the instructions or other information received in block 605 indicate to use a trained transformer model to analyze new building images, and if not proceeds to block 690. Otherwise, the routine continues to block 645 to receive new target images for a target building (e.g., panorama images in equirectangular format and including 360° of horizontal visual coverage), and in block 650 supplies the building images to the trained transformer model to obtain determined initial rough estimates of building wall position data and building image camera poses for those images, and provide the determined initial rough data as output (e.g., to be stored and/or provided to DBAMIGM system for further analysis). In particular, in block 650, the routine obtains predicted global cross-image data that includes at least global visible wall positions in a single common coordinate system (e.g., as part of polygonal room shapes of a building floor plan) and global building-wide camera poses, and optionally global per-wall associations of image pixel columns with visible walls.

if it is instead determined in block 640 that the instructions or other information received in block 605 are not to use a trained transformer model to analyze new building images, the routine continues instead to block 690 to perform one or more other indicated operations (if any) as appropriate. Non-exclusive examples of such other indicated operations may include, for example, one or more of the following: receiving and responding to requests for previously determined information (e.g., requests for such information for display on one or more client devices, requests for such information to provide it to one or more other devices for use in automated navigation, etc.); obtaining and storing information about buildings for use in later operations (e.g., information about dimensions, numbers or types of rooms, total square footage, adjacent or nearby other buildings, adjacent or nearby vegetation, exterior images, etc.); receiving and storing training data for later use; etc.

After blocks 650 or 690, the routine continues to block 695 to determine whether to continue, such as until an explicit indication to terminate is received, or instead to continue only if an indication to do so is received. If it is determined to continue, the routine returns to block 605 to wait for and receive additional instructions or other information, and otherwise continues to block 699 and ends.

FIG. 7 illustrates an example flow diagram for a Building Information Access system routine 700. The routine may be performed by, for example, execution of a building information access client computing device 175 and its software system(s) (not shown) of FIG. 1, a client computing device 175 of FIG. 3, and/or a mapping information access viewer or presentation system as described elsewhere herein, such as to provide a computer-implemented method to receive and display generated floor plans and/or other mapping information (e.g., a 3D model floor plan, determined room structural layouts/shapes, etc.) for a defined area that optionally includes visual indications of one or more determined image acquisition locations, to obtain and display information about images matching one or more indicated target images, to obtain and display feedback corresponding to one or more indicated target images acquired during an image acquisition session (e.g., with respect to other images acquired during that acquisition session and/or for an associated building), to display additional information (e.g., images) associated with particular acquisition locations in the mapping information, etc. In the example of FIG. 7, the presented mapping information is for a building (such as an interior of a house), but in other situations, other types of mapping information may be presented for other types of buildings or environments and used in other manners, as discussed elsewhere herein.

The illustrated example of the routine begins at block 705, where instructions or information are received. At block 710, the routine determines whether the received instructions or information in block 705 are to display determined information for one or more target buildings, and if so continues to block 715 to determine whether the received instructions or information in block 705 are to select one or more target buildings using specified criteria, and if not continues to block 720 to obtain an indication of a target building to use from the user (e.g., based on a current user selection, such as from a displayed list or other user selection mechanism; based on information received in block 705; etc.). Otherwise, if it is determined in block 715 to select one or more target buildings from specified criteria, the routine continues instead to block 725, where it obtains indications of one or more search criteria to use, such as from current user selections or as indicated in the information or instructions received in block 705, and then searches stored information about buildings to determine one or more of the buildings that satisfy the search criteria. In the illustrated example, the routine then further selects a best match target building from the one or more returned buildings (e.g., the returned other building with the highest similarity or other matching rating for the specified criteria, or using another selection technique indicated in the instructions or other information received in block 705).

After blocks 720 or 725, the routine continues to block 735 to retrieve a floor plan for the target building or other generated mapping information for the building, and optionally indications of associated linked information for the building interior and/or a surrounding location external to the building, and selects an initial view of the retrieved information (e.g., a view of the floor plan, a particular room shape, etc.). In block 740, the routine then displays or otherwise presents the current view of the retrieved information, and waits in block 745 for a user selection. After a user selection in block 745, if it is determined in block 750 that the user selection corresponds to adjusting the current view for the current target building (e.g., to change one or more aspects of the current view), the routine continues to block 755 to update the current view in accordance with the user selection, and then returns to block 740 to update the displayed or otherwise presented information accordingly. The user selection and corresponding updating of the current view may include, for example, displaying or otherwise presenting a piece of associated linked information that the user selects (e.g., a particular image associated with a displayed visual indication of a determined acquisition location, such as to overlay the associated linked information over at least some of the previous display), and/or changing how the current view is displayed (e.g., zooming in or out; rotating information if appropriate; selecting a new portion of the floor plan to be displayed or otherwise presented, such as with some or all of the new portion not being previously visible, or instead with the new portion being a subset of the previously visible information; etc.). If it is instead determined in block 750 that the user selection is not to display further information for the current target building (e.g., to display information for another building, to end the current display operations, etc.), the routine continues instead to block 795, and returns to block 705 to perform operations for the user selection if the user selection involves such further operations.

If it is instead determined in block 710 that the instructions or other information received in block 705 are not to present information representing a building, the routine continues instead to block 760 to determine whether the instructions or other information received in block 705 correspond to identifying other images (if any) corresponding to one or more indicated target images, and if continues to blocks 765-770 to perform such activities. In particular, the routine in block 765 receives the indications of the one or more target images for the matching (such as from information received in block 705 or based on one or more current interactions with a user) along with one or more matching criteria (e.g., an amount of visual overlap), and in block 770 identifies one or more other images (if any) that match the indicated target image(s), such as by interacting with the DBAMIGM system to obtain the other image(s). The routine then displays or otherwise provides information in block 770 about the identified other image(s), such as to provide information about them as part of search results, to display one or more of the identified other image(s), etc. If it is instead determined in block 760 that the instructions or other information received in block 705 are not to identify other images corresponding to one or more indicated target images, the routine continues instead to block 775 to determine whether the instructions or other information received in block 705 correspond to obtaining and providing feedback during an image acquisition session with respect to one or more indicated target images (e.g., a most recently acquired image), and if so continues to block 780, and otherwise continues to block 790. In block 780, the routine obtains information about an amount of visual overlap and/or other relationship between the indicated target image(s) and other images acquired during the current image acquisition session and/or acquired for the current building, such as by interacting with the DBAMIGM system, and displays or otherwise provides feedback in block 780 about the feedback.

In block 790, the routine continues instead to perform other indicated operations as appropriate, such as any housekeeping tasks, to configure parameters to be used in various operations of the system (e.g., based at least in part on information specified by a user of the system, such as a user of a mobile device who acquires one or more building interiors, an operator user of the DBAMIGM system, etc., including for use in personalizing information display for a particular user in accordance with his/her preferences), to obtain and store other information about users of the system, to respond to requests for generated and stored information, etc.

Following blocks 770 or 780 or 790, or if it is determined in block 750 that the user selection does not correspond to the current building, the routine proceeds to block 795 to determine whether to continue, such as until an explicit indication to terminate is received, or instead only if an explicit indication to continue is received. If it is determined to continue (including if the user made a selection in block 745 related to a new building to present), the routine returns to block 705 to await additional instructions or information (or to continue directly on to block 735 if the user made a selection in block 745 related to a new building to present), and if not proceeds to step 799 and ends.

Aspects of the present disclosure are described herein with reference to flowchart illustrations and/or block diagrams of methods, apparatus (systems), and computer program products according to examples of the present disclosure. It will be appreciated that each block of the flowchart illustrations and/or block diagrams, and combinations of blocks in the flowchart illustrations and/or block diagrams, can be implemented by computer readable program instructions. It will be further appreciated that in some implementations the functionality provided by the routines discussed above may be provided in alternative ways, such as being split among more routines or consolidated into fewer routines. Similarly, in some implementations illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, or synchronous or asynchronous) and/or in a particular order, in other implementations the operations may be performed in other orders and in other manners. Any data structures discussed above may also be structured in different manners, such as by having a single data structure split into multiple data structures and/or by having multiple data structures consolidated into a single data structure. Similarly, in some implementations illustrated data structures may store more or less information than is described, such as when other illustrated data structures instead lack or include such information respectively, or when the amount or types of information that is stored is altered.

From the foregoing it will be appreciated that, although specific examples have been described herein for purposes of illustration, various modifications may be made without deviating from the spirit and scope of the invention. Accordingly, the invention is not limited except as by corresponding claims and the elements recited by those claims. In addition, while certain aspects of the invention may be presented in certain claim forms at certain times, the inventors contemplate the various aspects of the invention in any available claim form. For example, while only some aspects of the invention may be recited as being embodied in a computer-readable medium at particular times, other aspects may likewise be so embodied.

1. A non-transitory computer-readable medium having stored contents that cause one or more computing devices to perform automated operations including at least:
training, by the one or more computing devices and using a plurality of training images captured at a plurality of buildings, a transformer machine learning model to generate, from analysis of visual data of multiple additional images of an interior of an additional building, output data that includes respective estimated acquisition poses for the multiple additional images each indicating position and orientation of a camera that captures that image in a first common coordinate system for the additional building, and that further includes respective estimated positions of a plurality of walls of the building that are visible in the multiple additional images in the first common coordinate system, wherein the training of the transformer machine learning model includes using encoded data representations of visual features of pixel columns of the multiple additional images and multiple defined loss functions to learn to predict the respective estimated acquisition poses for the multiple additional images and to predict the respective estimated positions of the plurality of walls, including to, for each of the plurality of walls, group some of the pixel columns of the multiple additional images that show that wall and to predict two-dimensional (2D) data points representing a position of that wall;
obtaining, by the one or more computing devices, multiple target images acquired at a target building;
generating, by the one or more computing devices, respective estimated target acquisition poses for the multiple target images each indicating camera position and orientation during capture of that target image in a second common coordinate system for the target building, and respective estimated target positions in the second common coordinate system of multiple walls of the target building that are visible in the multiple target images, the generating including:
encoding, by the one or more computing devices and for each of at least some pixel columns of the multiple target images, a data representation of visual features of that pixel column;
generating, by the one or more computing devices and for each of the multiple walls, a token to uniquely identify that wall; and
predicting, by the one or more computing devices, and using the trained transformer machine learning model and the encoded data representation for each of the at least some pixel columns and the generated token for each of the multiple walls, the respective estimated target acquisition poses for the multiple target images, and the respective estimated target positions of the multiple walls by combining predicted 2D data points representing positions of the multiple walls relative to the multiple target images and by using the respective estimated target acquisition poses for the multiple target images; and
providing, by the one or more computing devices and based at least in part on the respective estimated target acquisition poses for the multiple target images and the respective estimated target positions of the multiple walls, at least a partial initial floor plan for the target building for use in navigation of the target building.

2. The non-transitory computer-readable medium of claim 1 wherein the training of the transformer machine learning model further includes:
encoding, by the one or more computing devices, a plurality of data representations that are each of a respective one of a plurality of pixel column groups, each pixel column group including one or more pixel columns of the multiple images, and each data representation of one of the pixel column groups being based on visual features of that one pixel column group and including a unique identifier for that one pixel column group;
performing, by the one or more computing devices and using a first group of self-attention processing operations on the plurality of data representations for the plurality of pixel column groups, a first training phase that includes a first plurality of iterations to train the transformer machine learning model to predict first data specific to each of the multiple images, the predicted first data including, for each of the pixel column groups, one or more predicted rows of the one or more pixel columns for that pixel column group that show a floor-wall boundary, and further including initial predicted estimated acquisition poses for the multiple images in local coordinate systems for the multiple images, and further including, for each of the plurality of walls, initial predicted 2D data points representing one or more positions of that wall relative to the initial predicted estimated acquisition poses for one or more images of the multiple images that show that wall, the initial predicted 2D data points being determined using, for each of at least one pixel column group showing that wall, the one or more predicted rows for that pixel column group;
generating, by the one or more computing devices, a plurality of wall tokens to each uniquely identify a respective one of the plurality of walls; and
performing, by the one or more computing devices and using the plurality of wall tokens, a second training phase that includes a second plurality of iterations to train the transformer machine learning model to predict second data from a combination of the multiple images, the predicted second data including the respective estimated acquisition poses for the multiple images in the first common coordinate system, and further including the respective estimated positions of the plurality of walls in the first common coordinate system that are based on the respective estimated acquisition poses for the multiple images and on the initial predicted 2D data points for each of the plurality of walls.

3. The non-transitory computer-readable medium of claim 2 wherein the second training phase includes performing a second group of self-attention processing operations on at least the generated plurality of wall tokens, the second training phase further grouping, for each of multiple subsets of three or more wall tokens of the plurality of wall tokens, a sequence of the three or more walls tokens of that subset to represent-a closed sequence of the three or more walls uniquely identified by those three or more wall tokens for a respective one of multiple rooms of the building and forming a polygonal room shape for that respective one room.

4. The non-transitory computer-readable medium of claim 2 wherein the second training phase includes performing a group of cross-attention processing operations on at least the respective generated tokens for the plurality of walls and on a plurality of room tokens that each uniquely identifies a respective one of multiple rooms of the building and that each includes a sequence of wall slots, the second training phase further determining, for each of the room tokens, multiple of the wall tokens to fill multiple wall slots in the sequence for that room token, the multiple wall tokens determined for each room token representing a closed sequence of wall segments to form a polygonal room shape for the room identified by that room token.

5-8. (canceled)

9. The non-transitory computer-readable medium of claim 1 wherein the automated operations further include generating, by the one or more computing devices and before the providing of the at least partial initial floor plan, the at least partial initial floor plan, including using the respective estimated target positions of the multiple walls to place the multiple walls in the at least partial initial floor plan.

10. The non-transitory computer-readable medium of claim 9 wherein placing of the multiple walls in the at least partial initial floor plan includes generating a polygonal room shape for each of multiple rooms of the building, wherein each polygonal room shape is a sequence of three or more interconnected walls of the multiple walls.

11. The non-transitory computer-readable medium of claim 9 wherein the generating of the respective estimated target acquisition poses for the multiple target images and the respective estimated target positions of the multiple walls further includes determining locations of doorways and windows in walls visible in the multiple target images, and wherein the generating of the at least partial floor plan further includes adding the determined locations of the doorways and the windows in the generated at least partial initial floor plan.

12. The non-transitory computer-readable medium of claim 1 wherein the target building has multiple rooms, wherein the respective estimated target acquisition poses for the multiple target images includes a pose of at least one target image in each of the multiple rooms, and wherein the at least partial initial floor plan is an initial version of a full floor plan for the target building.

13. The non-transitory computer-readable medium of claim 1 wherein the stored contents include software instructions that, when executed by the one or more computing devices, cause the one or more computing devices to perform further automated operations that include:
generating, by the one or more computing devices, a final floor plan for the target building, including using a combination of a diffusion model and bundle adjustment optimization operations to refine the respective estimated target positions of the multiple walls in the provided at least partial initial floor plan for the target building; and
presenting, by the one or more computing devices, the generated final floor plan for the target building.

14. The non-transitory computer-readable medium of claim 1 wherein the multiple images and the multiple target images are each a panorama image in equirectangular format and showing 360 degrees of horizontal visual data.

15. A system comprising:
one or more hardware processors of one or more computing devices; and
one or more memories with stored instructions that, when executed by at least one of the one or more hardware processors, cause at least one of the one or more computing devices to perform automated operations including at least:
obtaining multiple images acquired in an interior of a building;
generating, using a trained transformer machine learning model, respective estimated acquisition poses for the multiple images each indicating camera position and orientation during capture of that image, and respective estimated positions of multiple walls of the building that are visible in the multiple images, the generating including:
encoding, for each of at least some pixel columns of the multiple images, a data representation of visual features of that pixel column;
generating, for each of the multiple walls, a token to uniquely identify that wall; and
predicting, using self-attention processing operations of the trained transformer machine learning model and the encoded data representation for each of the at least some pixel columns and the generated token for each of the multiple walls, the respective estimated acquisition poses for the multiple images, and the respective estimated positions of the multiple walls by combining predicted two-dimensional (2D) data points representing positions of the multiple walls relative to the multiple images and by using the respective estimated acquisition poses for the multiple images; and
providing the respective estimated acquisition poses for the multiple images and the respective estimated positions of the multiple walls for use in navigation of the building.

16. The system of claim 15 wherein the automated operations further include, before the generating of the respective estimated acquisition poses for the multiple images and the respective estimated positions of multiple walls of the building, training the transformer machine learning model to generate, from analysis of visual data of multiple target images of an interior of a target building, output data that includes respective estimated target acquisition poses for the multiple target images each indicating position and orientation of a camera that captures that target image, and that further includes respective estimated target positions of a plurality of walls of the target building that are visible in the multiple target images, wherein the transformer machine learning model is trained to perform self-attention processing on encoded data representations of visual features of pixel columns of the multiple target images to predict the respective estimated target acquisition poses for the multiple target images and to, for each of the plurality of walls, group some of the pixel columns of the multiple target images that show that wall and to predict 2D data points representing a position of that wall.

17. The system of claim 15 wherein the stored instructions include software instructions that, when executed by the at least one hardware processor, cause the at least one computing device to perform further automated operations including, after the predicting of the respective estimated acquisition poses for the multiple images and the respective estimated positions of the multiple walls, generating at least a partial initial floor plan for the building using the respective estimated acquisition poses for the multiple images and the respective estimated positions of the multiple walls, wherein the generated at least partial initial floor plan shows the respective estimated positions of the multiple walls and further shows the respective estimated acquisition poses for the multiple images, and wherein the providing of the respective estimated acquisition poses for the multiple images and the respective estimated positions of the multiple walls includes providing the generated at least partial initial floor plan.

18. A computer-implemented method comprising:
training, by one or more computing devices, a transformer machine learning model to generate, from analysis of visual data of multiple panorama images of an interior of a building that are in equirectangular format, output data that includes respective estimated acquisition poses for the multiple panorama images each indicating position and orientation of a camera that captures that panorama image, and that further includes respective estimated positions of a plurality of walls of the building that are visible in the multiple panorama images, including:
encoding, by the one or more computing devices and for each of at least some pixel columns of the multiple panorama images, a data representation for that pixel column based on visual features of that pixel column and including a unique column identifier for that pixel column;
performing, by the one or more computing devices, a first training phase that includes a first plurality of iterations to train the transformer machine learning model to predict first data specific to each of the multiple panorama images, the predicted first data including the respective estimated acquisition poses for the multiple panorama images and including, for each of the plurality of walls, a group of some of the pixel columns of one or more panorama images of the multiple panorama images that show that wall and two-dimensional (2D) data points representing one or more positions of that wall relative to the respective estimated acquisition poses for the one or more panorama images, wherein the first training phase includes performing a first group of self-attention processing operations on the respective encoded data representations for the at least some pixel columns;
generating, by the one or more computing devices and for each of the plurality of walls, a token to uniquely identify that wall; and
performing, by the one or more computing devices, a second training phase that includes a second plurality of iterations to train the transformer machine learning model to predict second data from a combination of the multiple panorama images, the predicted second data including the respective estimated positions of the plurality of walls that are based on the respective estimated acquisition poses for the multiple panorama images and on the predicted 2D data points for each of the plurality of walls and on the respective generated tokens for the plurality of walls;
obtaining, by the one or more computing devices, multiple target panorama images acquired in an interior of a target building that are in equirectangular format;
generating, by the one or more computing devices, respective estimated target acquisition poses for the multiple target panorama images each indicating camera position and orientation during capture of that target panorama image, and respective estimated target positions of multiple walls of the target building that are visible in the multiple target panorama images, the generating including:
encoding, by the one or more computing devices and for each of at least some target pixel columns of the multiple target panorama images, a target data representation of visual features of that pixel column;
generating, by the one or more computing devices and for each of the multiple walls, a target token to uniquely identify that wall; and
predicting, by the one or more computing devices and using the trained transformer machine learning model and the encoded target data representation for each of the at least some target pixel columns and the target generated token for each of the multiple walls, the respective estimated target acquisition poses for the multiple target panorama images, and the respective estimated target positions of the multiple walls;
generating, by the one or more computing devices, at least a partial initial floor plan for the target building based at least in part on the respective estimated target acquisition poses for the multiple target panorama images and the respective estimated target positions of the multiple walls; and
providing, by the one or more computing devices, the at least partial initial floor plan for the target building for use in navigation of the target building.

19. The computer-implemented method of claim 18 wherein the second training phase includes performing a second group of self-attention processing operations on at least the respective generated tokens for the plurality of walls.

20. The computer-implemented method of claim 18 wherein the second training phase includes performing a group of cross-attention processing operations on at least the respective generated tokens for the plurality of walls.

21. The non-transitory computer-readable medium of claim 2 wherein the training of the transformer machine learning model to group some of the pixel columns of the multiple images that show each of the plurality of walls includes, for a quantity N of the multiple images and a quantity W of pixel column groups for each of the multiple images, generating a matrix of size (N*W) by (N*W), quantifying a degree of visual overlap between each pixel column group of each of the multiple images to each other pixel column group of each other image of the multiple images, and storing each quantified degree of visual overlap in the generated matrix.

22. The non-transitory computer-readable medium of claim 2 wherein the training of the transformer machine learning model to group some of the pixel columns of the multiple images that show each of the plurality of walls includes using blockwise self-attention operations to, for each pixel column group of each of the multiple images, quantify a degree of visual overlap between that pixel column group of that image and each other pixel column group of each other image of the multiple images.

23. The non-transitory computer-readable medium of claim 3 wherein the multiple defined loss functions include a first loss function using first differences between the one or more predicted rows for each of the pixel column groups and actual rows in the multiple images of floor-wall boundaries,
and a second loss function using second differences between the respective estimated acquisition poses for the multiple images and actual acquisition poses for the multiple images,
and a third loss function using third differences between the respective estimated positions of the plurality of walls and actual positions of the plurality of walls in the multiple images,
and a fourth loss function using fourth differences between the sequence of three or more walls for each of the plurality of room tokens and actual sequences of walls for the multiple rooms identified by the plurality of room tokens,
and a fifth loss function using fifth differences between the three or more walls for each of the plurality of room tokens and actual walls in the multiple rooms identified by the plurality of room tokens.

24. The non-transitory computer-readable medium of claim 1 wherein the multiple defined loss functions include an InfoNCE (Noise Contrastive Estimation) loss function to, as part of grouping some of the pixel columns of the multiple images that show each of the plurality of walls, increase a degree of match between pixel columns of different images that show a same portion of one of the plurality of walls relative to other degrees of match between pixel columns of different images that do not show the same portion of one of the plurality of walls.
